(19) United States
(12) Patent Application Publication
(10) Pub. No.: US 2006/0268842 A1
(43) Pub. Date: Nov. 30, 2006

(54) Receiving apparatus and transmitting apparatus

(75) Inventors: Masafumi Takahashi, Sakura-shi (JP); Toshiyuki Iwai, Ichihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/439,196

(22) Filed: May 24, 2006

(30) Foreign Application Priority Data
May 25, 2005 (JP) 2005-152909
Apr. 27, 2006 (JP) 2006-124489

(51) Int. Cl. H04L 12/66; H04L 12/56

(52) U.S. Cl. 370/352; 370/401

(57) ABSTRACT

A communication terminal of the present invention includes: (i) judgment section for whether or not a hidden identifier hidden from the user and assigned fixedly and uniquely to each communication terminal or the like is included in response data transmitted from another communication apparatus in reply to transmission of connection request data including data requesting connection with the communication apparatus; and (ii) response data generating section for generating, in later calls in cases where the hidden identifier is judged to be included in the response data, reply data including (i) the hidden identifier assigned to the communication terminal and (ii) the hidden identifier received from the communication terminal.

This Nonprovisional application claims priority under 35 U.S.C. § 119(a) on Patent Application No. 152909/2005 filed in Japan on May 25, 2005 and Patent Application No. 124489/2006 filed in Japan on Apr. 17, 2006, the entire contents of which are hereby incorporated by reference.

### FIELD OF THE INVENTION

The present invention relates to a technical field of communications. Particularly, the present invention relates to an apparatus, a system, a method, and a program, whereby a call to be made between communication apparatuses via a packet-switched network is controlled by using an identifier such as a telephone number.

### BACKGROUND OF THE INVENTION

In recent years, as accompanied with the widespread use of an always-connected Internet network, a communication service similar to a communication service using a conventional telephone network has begun to be provided via the Internet network. Further, although a communication service such as a TV telephone service has not been so common via the conventional telephone network because of quality and cost restrictions, such a communication service shows signs of becoming widespread.

The communication service using the Internet network assumes data transmission using IP (Internet Protocol). The data transmission using IP is carried out as follows. That is, a terminal (i) divides data into packets, (ii) adds, to each of the packets, an IP address indicating a target terminal, and (iii) transmits the packet. Then, in the Internet network, a transmission path via which the packet is to be transmitted is selected in accordance with the IP address. Then, the packet is supplied to the target terminal. The IP address thus used for the selection of the transmission path is determined by either (i) a line to which the terminal is connected or (ii) an Internet provider (hereinafter, simply referred to as “provider”) for providing IP connection service. Therefore, a user is not allowed to freely set the IP address. Furthermore, even when the same line and the same provider are used, the IP address often varies. Therefore, the IP address is not fixed (variable).

Therefore, the IP address is not appropriate as an identifier for specifying the user or the terminal each making a call. In view of this, various methods for connecting terminals with the use of (i) identifiers respectively assigned uniquely to users and (ii) the Internet network have been proposed and used. An example of the methods is SIP (Session Initiation Protocol).

The following explains an operation of a system using SIP, with reference to FIG. 33.

Terminal A and Terminal B have unique IP addresses serving as searching tags, and register the IP addresses in an SIP server, respectively (C1, C2). Note that the SIP server has a fixed IP address.

The following explains an operation carried out in cases where Terminal A makes a call to Terminal B.

In this case, Terminal A sends, to the SIP server, a connection request signal to which the IP address of Terminal A is added and which is addressed to an SIP address (term-b@server.example.org) assigned to Terminal B (C3). Upon receiving the signal, the SIP server (i) make access to its database, (ii) uses the SIP address of Terminal B as a searching tag so as to search for the IP address (192.168.0.100) of Terminal B, and (iii) transfers, to Terminal B, the connection request signal sent from Terminal A (C4).

Upon receiving the signal, Terminal B adds its IP address (192.168.0.100) to a response message, and then sends the response message to the SIP server (C5). The SIP server transfers the response message to Terminal A (C6). These procedures allow Terminals A and B to know each other's IP addresses.

Then, Terminal A and Terminal B transmit data (e.g., (i) stream data such as audio and/or video information or (ii) a still image) directly to each other, i.e., not via the SIP server (C7).

As such, the response message is supplied from Terminal B to Terminal A via the SIP server. This allows the SIP server to know that Terminal A and Terminal B are connected with each other.

These procedures are simplified examples. In practice, negotiation is carried out with regard to (i) a protocol for use in transmission of sound and (ii) a port number. Further, in some case, the connection request is likely to be transmitted from Terminal A to Terminal B via a plurality of SIP servers. However, these are not essential to the present invention. Therefore, the following assumes that Terminal A and Terminal B are connected to each other via a single SIP server.

On the other hand, DDNS (Dynamic Domain Name Service) has been used as a mechanism for making reference to a dynamically changing IP address in accordance with an identifier, and can be used for the same purpose as SIP.

However, there are some problems with a telephone number used in either (i) the aforementioned IP telephone network or (ii) the conventional telephone network using telephone exchanging (switching) devices. See the following main problems (1) to (4) thereof:

(1) When the user changes his/her living place to a new place, the telephone number is changed because the terminal is installed in another location. This makes it impossible to make a call to the user by using the previous telephone number.

(2) If the telephone number is known to an unwanted person, the user is likely to receive an unwanted call from the person.

(3) If the telephone number is known to general public, the user is likely to receive an unwanted call until the user changes the telephone number.

(4) Since the telephone number is a series of numerals, the user suffers from a difficulty in memorizing the telephone number, and therefore is likely to incorrectly input the telephone number.

Among Problems (1) to (4), Problem (4) is partially solved by providing an electronic telephone directory in the terminal, especially in the case of a mobile phone. For example, instead of inputting the telephone number directly into the terminal, the user stores the telephone number in the terminal in association with a name. Accordingly, the user can surely make a call to a desired target only in accordance with the name of the target, which name is found in the telephone directory.

Moreover, in order to partially solve each of Problems (2) and (3), e.g., Japanese Unexamined Patent Publication No. 119482/2001 (Tokukai 2001-119482; published on Apr. 27, 2001) (Patent Document 1) discloses an accessory ID registration subscription telephone system. The system of Patent Document 1 assigns a plurality of identifiers to a single terminal, and the terminal is allowed to make a connection with another terminal with the use of any one of the identifiers.

In the system of Patent Document 1, (i) a telephone number assigned permanently to the terminal and (ii) an accessory ID assigned temporarily to the terminal are used for the connection to another terminal. Here, the accessory ID is a digit sequence made up of the predetermined and limited number of digits. However, an accessory ID has begun to be used which is familiar to a human, i.e., which the human can remember easily. Such an accessory ID is prepared by converting a combination of numerals into character (letter) information in accordance with a predetermined rule, as is the case with a pager message or the like. Such an accessory ID is issued and managed so that an accessory ID identical to the accessory ID is not issued to other users. Therefore, the user only needs to know either the telephone number or the accessory ID so as to make contact with another person. On the other hand, even when the user did not notify a person of the user's permanent telephone number but of the user's accessory ID, the user can receive contact from the person.

In the following, the subscription telephone system will be more fully described with reference to FIG. 34.

Two identifiers are assigned to a terminal 1002: a telephone number and an accessory ID. Further, a telephone number is assigned to a terminal 1003. Voice communication between the terminal 1002 and the terminal 1003 is carried out via a subscription telephone network 1001.

First, the user connects the terminal 1002 to an ID service station 1004 with the use of a telephone number □□□-□□□□-□□□□. After the connection is established, the user of the terminal 1002 remotely operates an ID management control section 1006 by using means such as DTMF (Dual Tone Multi Frequency), so as to obtain an accessory ID ∘∘∘∘∘∘∘∘. At the same time, the ID management control section 1006 registers, in a database 1007, a correlation between the accessory ID ∘∘∘∘∘∘∘∘ and the telephone number ΔΔΔ-ΔΔΔ-ΔΔΔΔ of the terminal 1002.

Moreover, when a user who knows the accessory ID ∘∘∘∘∘∘∘∘ of the terminal 1002 enters, into the terminal 1003, a number obtained by adding a prefix number •••• to the accessory ID, a switch 1011 recognizes the prefix number •••• and notifies the accessory ID ∘∘∘∘∘∘∘∘ to the ID service station 1004. Here, the prefix number •••• is a specific number for use in making a call with the use of the accessory ID.

Then, the ID service station 1004 make reference to the database 1007 so as to convert the accessory ID ∘∘∘∘∘∘∘∘ into the telephone number ΔΔΔ-ΔΔΔ-ΔΔΔΔ of the terminal 1002, and sends the telephone number to the switch 1011. Then, based on the telephone number, the switch 1011 connects, to the terminal 1002, a call from the terminal 1003.

As such, even when the telephone number is unknown, the subscription telephone system makes it possible to confirm the sending end and the receiving end. That is, the subscription telephone system is designed to protect privacy for both the sending end and the receiving end.

However, Patent Document 1, which discloses the subscription telephone system, discloses or indicates nothing about means by which the user of the terminal 1002 notifies the original telephone number ΔΔΔ-ΔΔΔ-ΔΔΔΔ to the user of the terminal 1003 who has made a connection to the terminal 1002 by using the accessory ID.

For this reason, in cases where the user of the terminal 1002 would like to permanently accept the connection with the user of the terminal 1003 even after the user of the terminal 1002 changes the accessory ID ∘∘∘∘∘∘∘∘, the user of the terminal 1002 needs to orally notify the telephone number ΔΔΔ-ΔΔΔ-ΔΔΔΔ to the user of the terminal 1003, and the user of the terminal 1003 needs to write down the telephone number. (That is, Problem (4) occurs.) Further, this causes such a problem that there is no way of preventing the user who knows the telephone number from telling the telephone number to others. (That is, Problem (2) occurs.) In addition, the user needs to consciously differentiate between the telephone number and the accessory ID. This raises such a problem that the use of the telephone number and the accessory ID is bothersome. The necessity of differentiating between the telephone number and the accessory ID is evident from the fact that the special prefix number is used in Patent Document 1 so as to differentiate between the telephone number and the accessory ID.

### SUMMARY OF THE INVENTION

The present invention has been made in view of the foregoing problems. It is an object of the present invention to provide a receiving apparatus, a transmitting apparatus, and the like, each of which makes it possible to (i) communicate with another communication apparatus with which the communication apparatus has previously communicated and whose telephone number has been changed and (ii) improve an effect of protecting privacy of communications between users.

In order to solve the problems, a receiving apparatus according to the present invention is a receiving apparatus for receiving data from a communication apparatus connected to the receiving apparatus via a communication path, the receiving apparatus, including: an address storage section for storing a table in which each of specifying information of a plurality of communication apparatuses, each of hidden identifiers of the communication apparatuses, and each of connection permission information of the communication apparatuses are correlated with one another, which specifying information is for use in specifying the communication apparatuses respectively, and which hidden identifiers are uniquely and fixedly assigned to the communication apparatuses respectively and are hidden from a user, and each of which connection permission information indicates whether or not connection for making a reply to each of the communication apparatuses is permitted; extracting means for (i) receiving, from one of the communication apparatuses, connection request data including data requesting the connection, and (ii) extracting a hidden identifier of the one of the communication apparatuses from the connection request data; searching means for searching, by using the extracted hidden identifier, the table stored in the address storage section; and permission judging means for (i) reading out, in cases where the extracted hidden identifier is found in the table as a result of the search, connection permission information that is so stored in the table as to be correlated with the extracted hidden identifier, and (ii) judging, in accordance with the connection permission information, whether or not the connection with the one of the communication apparatuses is permitted.

According to the above structure, the address storage section stores the table in which the specifying information, the hidden identifier, and the connection permission information are correlated with one another. Here, the specifying information refers to any information by which the communication apparatus can be specified. Examples of the specifying information include (i) a name of an owner of the communication apparatus, (ii) a known identifier of the communication apparatus, and the like. Note that the wording “known identifier” refers to an identifier for specifying each of an individual communication apparatus and an individual receiving apparatus. Examples of the known identifier include a telephone number and an IP address. The known identifier is known to the user.

Meanwhile, the hidden identifier is an identifier uniquely and fixedly assigned to the communication apparatus, and is stored in the communication apparatus, and is known to no user. Because there is no user who knows the hidden identifier, the hidden identifier is never changed by any user. The hidden identifier is extracted by the extracting means, e.g., in the following manner. That is, the extracting means executes a program which judges that the hidden identifier is extracted when each of the communication apparatus and the receiving apparatus detects specifying data generated in accordance with a certain rule and provided in the data of the hidden identifier.

Upon receiving the connection request data from one of the communication apparatuses, the extracting means extracts the hidden identifier of the communication apparatus from the connection request data. Here, the wording “connection request data” refers to data which the communication apparatus uses to request that the receiving apparatus should be connected with the communication apparatus. By using the extracted hidden identifier, the searching means searches the table stored in the address storage section. Note that the receiving apparatus may have at least a receiving function, and may have both the receiving function and, e.g., a transmitting function.

In accordance with the result of the search, the permission judging means reads out the connection permission information corresponding to the extracted hidden identifier, and judges in accordance with the readout connection permission information whether or not the connection is permitted. Note that the connection permission information is information such as a flag in which whether or not connection with each communication apparatus is permitted is set and stored. Instead of the connection permission information, such conditional information may be used that is obtained by checking the specifying information (e.g., a below-described terminal fingerprint or certificate identifier) which is assigned fixedly to the communication apparatus for the sake of checking whether or not the communication apparatus is a correctly registered legitimated communication apparatus for the receiving apparatus.

As such, the hidden identifier is correlated with the connection permission information. This makes it possible for the permission judging means to judge in accordance with the connection permission information whether or not the connection is permitted with the communication apparatus having transmitted the connection request data including the hidden identifier thereof. Therefore, the hidden identifier, and the connection permission information correlated with the hidden identifier are kept as they are, even after the user of the communication apparatus changes the known identifier of the communication apparatus. This makes it possible for the receiving apparatus to communicate with the communication apparatus whose hidden identifier is correlated with the connection permission, even when the known identifier of the communication apparatus is changed. Further, it is possible for the receiving apparatus to reject the communication with a communication apparatus whose hidden identifier is correlated with connection prohibition, irrespective of a change of the known identifier of the communication apparatus.

This makes it possible that: the user of the receiving apparatus communicates with only a person whom the user of the receiving apparatus permits, with the use of the hidden identifier which is hidden from the respective users of the communication apparatus and the receiving apparatus. Further, the hidden identifier is unchangeable, so that communication with a specific person can be carried out with the use of the hidden identifier irrespective of the known identifier.

In order to solve the problems, a receiving apparatus according to the present invention is a receiving apparatus for receiving data from a communication apparatus connected to the receiving apparatus via a communication path, the receiving apparatus, including: an address storage section for storing a table in which each of specifying information of a plurality of communication apparatuses, each of hidden identifiers of the communication apparatuses are correlated with each other, which specifying information is for use in specifying the communication apparatuses respectively, and which hidden identifiers are uniquely and fixedly assigned to the communication apparatuses respectively and are hidden from a user; extracting means for (i) receiving, from one of the communication apparatuses, connection request data including data requesting the connection, and (ii) extracting a hidden identifier of the one of the communication apparatuses from the connection request data; searching means for searching, by using the hidden identifier extracted by the extracting means, the table stored in the address storage section; and writing control means for writing, in cases where a hidden identifier identical to the extracted hidden identifier is not found in the table as a result of the search, the extracted hidden identifier and specifying information of the one of the communication apparatuses in the table such that the extracted hidden identifier and the specifying information are correlated with each other.

According to the above structure, when receiving the connection request data from one of the communication apparatuses, the extracting means extracts the hidden identifier of the communication apparatus from the data. When the extracting means extracts the hidden identifier, the searching means searches, by using the hidden identifier, the table stored in the address storage section.

When the search clarifies that no hidden identifier identical to the extracted hidden identifier is stored in the address storage section, it is or it is assumed that the communication apparatus having the hidden identifier requests an appropriate connection for the first time. Therefore, the writing control means writes, in the table stored in the address storage section, the extracted hidden identifier and the specifying information of the communication apparatus such that the extracted hidden identifier and the specifying information are correlated with each other. Thus, the communication apparatus is registered.

According to the above structure, the hidden identifier of the communication apparatus is automatically extracted from the connection request data, and is registered in the table. Accordingly, the hidden identifier can be exchanged without user's notice.

Note that the wording “known identifier” refers to an identifier for specifying each of an individual communication apparatus and an individual receiving apparatus. Examples of the known identifier include a telephone number and an IP address. The known identifier is known to the user. Further, the specifying information may be any information for specifying the communication apparatus, so that the specifying information may be the known identifier, a name of an owner of the communication apparatus, or the like.

In order to solve the problems, a transmitting apparatus according to the present invention is a transmitting apparatus for transmitting data to a communication apparatus connected to the transmitting apparatus via a communication path, the transmitting apparatus, including: judging means for judging whether or not response data sent from the communication apparatus in response to transmission of connection request data including data requesting connection with the communication apparatus includes a hidden identifier, which is uniquely and fixedly assigned to the communication apparatus and which is hidden from the user; and data generating means for generating, in later calls to the communication apparatus in cases where it is judged that the response data includes the hidden identifier, either connection request data or reply data, each of which includes (i) a hidden identifier assigned to the transmitting apparatus and (ii) the hidden identifier received from the communication apparatus.

According to the above structure, the judging means judges whether or not the response data sent from the communication apparatus in response to the transmission of the connection request data includes the hidden identifier. Here, the wording “response data” refers to data including information indicating a response to the connection response data. In cases where it is judged that the response data include the hidden identifier, the connection with the communication apparatus is permitted. Therefore, in the later calls, the data generating means generates the reply data including (i) the hidden identifier of the transmitting apparatus, and (ii) the hidden identifier given from the communication apparatus (i.e., the hidden identifier uniquely assigned to the communication apparatus). Note that the transmitting apparatus may have at least a transmitting function, or may have the transmitting function and, e.g., a receiving function.

With this, when the response data includes the hidden identifier, the user of the transmitting apparatus can communicate with a specific person with whom the user of the transmitting apparatus exchanged the hidden identifiers, irrespective of the respective known identifiers of the transmitting apparatus and the receiving apparatus.

In order to solve the problems, a receiving apparatus according to the present invention is a receiving apparatus, which is assigned a hidden identifier that is hidden from a user and that is able to be used as an address for receiving a request for connection with the receiving apparatus, and which is connected to a communication path that allows the receiving apparatus to be specified in accordance with either (i) a known identifier that is known to the user and that is able to be used as an address for receiving the request for the connection with the receiving apparatus or (ii) the hidden identifier, and which receives data from communication apparatuses connected to the communication path, the receiving apparatus, including: extracting means for extracting, from connection request data sent from one of the communication apparatuses and requesting the connection with the receiving apparatus, address information including (i) one of the known identifier of the receiving apparatus and the hidden identifier of the receiving apparatus, or (ii) both the known identifier and the hidden identifier; permission judging means for judging, in accordance with the extracted address information, whether or not the connection with the communication apparatus having sent the connection request data is permitted; and reply data generating means for generating the reply data representing connection permission, in cases where the connection is permitted.

According to the above structure, the receiving apparatus according to the present invention can receive data from the other communication apparatuses connected to the communication path. The receiving apparatus connected to the communication path is discriminated uniquely by way of the hidden identifier. Further, in cases where the known identifier is assigned to the receiving apparatus, the receiving apparatus connected thereto is also discriminated uniquely by way of the known identifier. Therefore, the communication apparatus connected to the communication path can transmit data to the receiving apparatus with the known identifier or the hidden identifier of the receiving apparatus set as the address of the receiving apparatus. In other words, the receiving apparatus can receive the connection request data, which is addressed to the known identifier or the hidden identifier of the receiving apparatus, and which is sent from the communication apparatus. Note that the known identifier is an identifier known to the user, such as a telephone number. In contrast, the hidden identifier is an identifier which is stored in each of the receiving apparatus and the communication apparatus and which is hidden from the user.

When receiving the connection request data from the communication apparatus, the extracting means extracts, from the connection request data, the address information including either the known identifier or the hidden identifier. In accordance with the extracted address information, the permission judging means judges whether or not data communication is to be carried out with the communication apparatus having sent the connection request data, i.e., the permission judging means judges whether or not the connection is permitted.

For example, the permission judging means judges whether or not the connection is permitted, in cases where the hidden identifier is included as the address information. Alternatively, in cases where the known identifier is included as the address information, the permission for the connection is given when the call is made for the first time with the use of the known identifier. Alternatively, in cases where the known identifier is included as the address information, the permission for the connection can be set to be given to a call using the known identifier. Alternatively, in cases where the known identifier is included as the address information, the permission judging means always judges so as to reject the connection. Further, in cases where the connection request data includes either the known identifier of the communication apparatus or the hidden identifier thereof, the judgment on the connection permission is carried out in accordance with information indicating whether or not the connection with the communication apparatus is permitted, which information is correlated with either the known identifier or the hidden identifier of the communication apparatus. That is, the judgment on the permission for the connection is not particularly limited.

Further, in cases where the permission judging means judges so as to permit the connection, the reply data generating means generates the reply data indicating that the connection with the communication apparatus is permitted. Thereafter, the reply data thus generated is transmitted to the communication apparatus, with the result that the communication connection is established between the receiving apparatus and the communication apparatus. Then, the data communication is carried out.

On this account, the receiving apparatus according to the present invention can restrict, in accordance with the address information, the connection with other communication apparatuses connected to the communication path. For example, it is possible to realize a structure by which the receiving apparatus communicates with only a communication apparatus which has acquired the hidden identifier of the receiving apparatus in advance, among the communication apparatuses connected to the communication path.

A transmitting apparatus according to the present invention is connected to a communication path that allows a receiving apparatus to be specified in accordance with either (i) a known identifier that is known to a user and that is able to be used as an address for receiving the request for the connection with the receiving apparatus or (ii) a hidden identifier that is hidden from the user and that is able to be used as the address for receiving the request for the connection with the receiving apparatus, and transmits data to receiving apparatuses connected to the communication path, the transmitting apparatus, including: an address storage section for storing (i) each specifying information known to the user such that the hidden identifiers are distinguished from one another and (ii) each of hidden identifiers of the receiving apparatuses such that the specifying information and the hidden identifier are correlated with each other; and data generating means for generating connection request data including the hidden identifier specified by the specifying information.

According to the above structure, the transmitting apparatus according to the present invention may be such a transmitting apparatus that can transmit the data to the receiving apparatus connected to the communication path, and that is not assigned the hidden identifier. In the communication path, the receiving apparatus connected to the communication path is uniquely discriminated by way of either the known identifier or the hidden identifier. Therefore, the receiving apparatus connected to the communication path can receive the data, which is addressed to either the known identifier of the receiving apparatus or the hidden identifier thereof, and which is sent from the transmitting apparatus via the communication path. In other words, the transmitting apparatus can transmit the data to the receiving apparatus with either the known identifier of the receiving apparatus or the hidden identifier thereof set as the address of the receiving apparatus.

Further, according to the above structure, the address storage section stores the specifying information which allows the user of the transmitting apparatus to specify each of the plurality of receiving apparatuses connected to the communication path. The specifying information is information known to the user, and the user can freely make reference to the specifying information stored in the address storage section. A specific example of the specifying information includes (i) a name or nickname of the user of the receiving apparatus, or (ii) the known identifier assigned to the receiving apparatus. Further, the specifying information and the hidden identifier assigned to the receiving apparatus specified in accordance with the specifying information are so stored in the address storage section as to be correlated with each other. Note that the user cannot freely make reference to the hidden identifier stored in the address storage section.

For transmitting data to a receiving apparatus connected to the communication path, the user of the transmitting apparatus specifies the target receiving apparatus in accordance with the specifying information. Further, the data generating means generates the connection request data addressed to the hidden identifier correlated with the specifying information in the address storage section. In other words, the connection request data thus generated includes, as the address information, the hidden identifier corresponding to the specifying information specified by the user.

With this, in order to transmit the data to the receiving apparatus connected to the communication path, the user specifies the specifying information of the receiving apparatus so that the connection request data addressed to the hidden identifier of the target receiving apparatus is generated in the transmitting apparatus according to the present invention. That is, the hidden identifier is kept hidden from the user, but the transmitting apparatus transmits, to the receiving apparatus connected to the communication path and having permitted to give the hidden identifier thereof to the transmitting apparatus, the connection request data addressed to the hidden identifier of the receiving apparatus.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 shows Embodiment 1 of the present invention, and is a block diagram showing a functional arrangement of a control section of a communication terminal.

FIG. 2 is a diagram showing a structure of a known identifier used in an embodiment of the present invention.

FIG. 3 is a diagram showing a relationship between (i) a first digit (category number) of a data string serving as the known identifier used in the embodiment of the present invention and (ii) an assignment target.

FIG. 4 is a diagram showing general descriptions of various identifiers used in the embodiment of the present invention.

FIG. 5 shows the embodiment of the present invention, and is a block diagram showing the entire arrangement of a communication system.

FIG. 6 is a block diagram showing an arrangement of important parts of the communication terminal according to the present invention.

FIG. 7 is a diagram showing an arrangement of one example of an input/output device in which a display section and an input section are unified.

FIG. 8 is a sequence diagram showing the order of communication processes in the communication system according to Embodiment 1 of the present invention.

FIG. 9 is a diagram showing one example of setup information supplied from a setup server of the present invention to a user's communication terminal.

FIG. 10 is a diagram showing one example of a display on the display section at the time of initializing the communication terminal.

FIG. 11 is a diagram showing one example of the setup information which is downloaded by the communication terminal from the setup server.

FIG. 12(a) is a diagram showing one example of a message sent from the communication terminal to the server when registering in the server the known identifier and address identifier of the communication terminal.

FIG. 12(b) is a diagram showing one example of a message sent from the communication terminal to the server when registering in the server the hidden identifier and address identifier of the communication terminal.

FIG. 13(a) is a diagram showing one example of a calling message which is generated by a transmitting terminal and contains a hidden identifier of the transmitting terminal and a known identifier of a receiving terminal.

FIG. 13(b) is a diagram showing one example of an acceptance response message which is generated by the receiving terminal and contains a hidden identifier of the receiving terminal and a known identifier of the transmitting terminal.

FIG. 13(c) is a diagram showing one example of a call rejection response message which is generated by the receiving terminal and does not contain the hidden identifier of the receiving terminal.

FIG. 14 is a diagram showing one example of a structure of a table stored in a telephone directory storage section.

FIG. 15(a) is a diagram showing one example of a calling message which is generated by the transmitting terminal for the receiving terminal presenting its hidden identifier to the transmitting terminal and contains the hidden identifier of the receiving terminal and the hidden identifier of the transmitting terminal.

FIG. 15(b) is a diagram showing one example of an acceptance response message which is generated by the receiving terminal in response to the calling message of FIG. 15(a).

FIG. 16 is a flow chart showing a call-making process according to Embodiment 1 of the present invention.

FIG. 17 is a flow chart showing a call-receiving process according to Embodiment 1 of the present invention.

FIG. 18 is a sequence diagram showing the order of communication processes in a communication system according to Embodiment 2 of the present invention.

FIG. 19 is a diagram showing one example of a message for requesting a user to confirm whether or not the transmitting terminal transmits its hidden identifier to the receiving terminal.

FIG. 20 is a diagram showing one example of a structure of a table, according to Embodiment 2, stored in the telephone directory storage section.

FIG. 21(a) is a diagram showing one example of a calling message which is generated by the transmitting terminal and contains a terminal fingerprint of the transmitting terminal and the known identifier of the receiving terminal.

FIG. 21(b) is a diagram showing one example of an acceptance response message which is generated by the receiving terminal and contains a terminal fingerprint of the receiving terminal and the known identifier of the transmitting terminal.

FIG. 22 is a sequence diagram showing the order of communication processes in a communication system according to Embodiment 3 of the present invention.

FIG. 23(a) is a diagram showing one example of a calling message which is generated by the transmitting terminal and contains the terminal fingerprint and certificate identifier of the transmitting terminal and the known identifier of the receiving terminal.

FIG. 23(b) is a diagram showing one example of an acceptance response message which is generated by the receiving terminal and contains the terminal fingerprint and certificate identifier of the receiving terminal and the known identifier of the transmitting terminal.

FIG. 24 is a diagram showing one example of a structure of a table, according to Embodiment 3, stored in the telephone directory storage section.

FIG. 25(a) is a diagram showing one example of a calling message which is generated by the transmitting terminal for the receiving terminal presenting its hidden identifier to the transmitting terminal and contains (i) the hidden identifier of the receiving terminal, (ii) the hidden identifier of the transmitting terminal, and (iii) a certificate identifier generated by the transmitting terminal exclusively for the receiving terminal.

FIG. 25(b) is a diagram showing one example of an acceptance response message which is generated by the receiving terminal in response to the calling message of FIG. 25(a).

FIG. 26 is a flow chart showing a call-making process according to Embodiment 3 of the present invention.

FIG. 27 is a flow chart showing a call-receiving process according to Embodiment 3 of the present invention.

FIG. 28 is a block diagram showing the entire arrangement of a communication system according to Embodiment 4 of the present invention.

FIG. 29(a) is a diagram showing a structure of a known identifier used by a communication terminal according to Embodiment 4 of the present invention.

FIG. 29(b) is a diagram showing a structure of a hidden identifier used by the communication terminal.

FIG. 30 is a sequence diagram showing the order of communication processes in a communication system according to Embodiment 4 of the present invention.

FIG. 31 is a diagram showing one example of setup information which is downloaded by the communication terminal from a setup server according to Embodiment 4 of the present invention.

FIG. 32(a) is a diagram showing one example of a calling message, according to Embodiment 4, which is generated by combining a hidden identifier and a certificate identifier and is generated when communication is carried out for the first time.

FIG. 32(b) is a diagram showing one example of a connection permission response generated in response to the calling message of FIG. 32(a).

FIG. 32(c) is a diagram showing one example of an identifier exchange message.

FIG. 32(d) is a diagram showing one example of an identifier exchange response generated in response to the identifier exchange message of FIG. 32(c).

FIG. 32(e) is a diagram showing one example of a calling message generated when communication is carried out for the second time.

FIG. 32(f) is a diagram showing an example of a connection permission response generated in response to the calling message of FIG. 32(e).

FIG. 33 is a block diagram showing the entire arrangement of a conventional communication system using an SIP server.

FIG. 34 is a block diagram showing the entire arrangement of a conventional telephone system.

FIG. 35 is a diagram showing the entire arrangement of a system according to Embodiment 5 of the present invention.

FIG. 36 is a diagram showing an arrangement of a calling communication terminal according to Embodiment 5 of the present invention.

FIG. 37 is a diagram showing an arrangement of a called communication terminal according to Embodiment 5 of the present invention.

FIG. 38 is a diagram showing a case where the called communication terminal according to Embodiment 5 of the present invention is divided into two terminals that are one terminal having a function as a server which transmits requested image data and another terminal which gives various instructions to the above-described one terminal via a network.

FIG. 39 is a sequence diagram showing one example of communication processes in a communication system according to Embodiment 5 of the present invention.

FIG. 40 is a flow chart showing an incoming call waiting process according to Embodiment 5 of the present invention.

FIG. 41 is a sequence diagram showing one example of communication processes in the communication system according to Embodiment 5 of the present invention.

### DESCRIPTION OF THE EMBODIMENTS

Each of a receiving apparatus and a transmitting apparatus according to the present invention is applicable to, e.g., (i) a communication apparatus for communicating with another communication apparatus, and (ii) a communication system. Examples of the communication apparatus include an IP telephone, a mobile phone, and a mail transmitting/receiving device.

### Embodiment 1

The present embodiment uses a plurality of identifiers (a known identifier, a hidden identifier, a terminal fingerprint, a certificate identifier, and an address identifier). Each of the identifiers will be explained first.

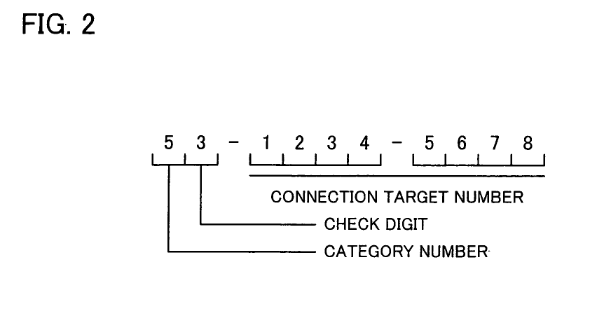

The known identifier is an identifier which corresponds to a telephone number used in the conventional telephone system, and is used in connecting a communication terminal to another communication terminal to which no connection has previously been made. For user's convenience, the known identifier may be any type of identifier as long as no problem occurs. However, in the present embodiment, a ten-digit number is used as the known identifier as shown in FIG. 2. Hyphens inserted between digits may be omitted. In the following, the digits of the known identifier are respectively referred to as a first digit, a second digit, and so on, in the order from the left.

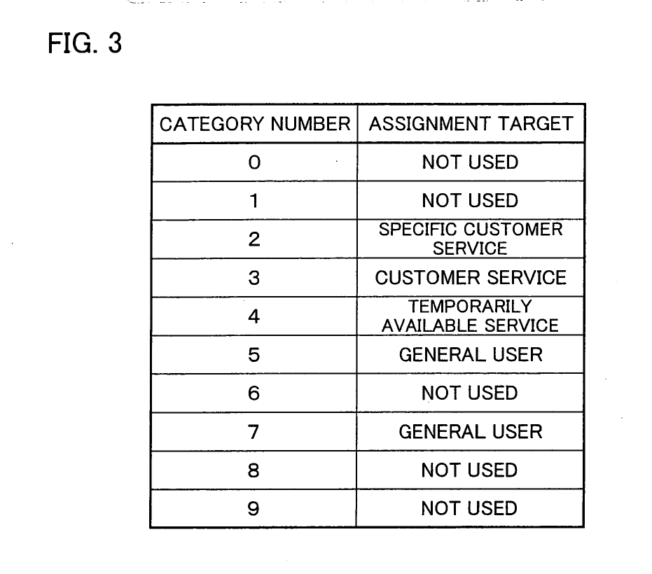

The first digit is a category number indicating a purpose of use of the known identifier, and is correlated with an assignment target shown in, e.g., FIG. 3. Here, the assignment target indicates (i) the purpose of the use of the known identifier, (ii) usage thereof, or the like. Specifically, the assignment target indicates (i) a type of user to whom the known identifier is assigned, or (ii) a type of service to be given to the user.

For example, as shown in FIG. 3, Category Number 2 is correlated with an assignment target “specific customer service”, and indicates that the known identifier is, e.g., a known identifier which a bank notifies to a user who already has an account with the bank. Further, Category Number 3 is correlated with an assignment target “customer service”, and indicates that the known identifier is, e.g., a known identifier which is printed on a pamphlet or the like and which is disclosed to an unspecified number of people. Category Number 4 is correlated with an assignment target “temporarily available service”, and indicates that the known identifier is, e.g., a known identifier which is valid during a specific period of time and which is used, for example, to accept orders for concert tickets. Category Numbers 2, 3, and 4 are used for “business purposes”. On the other hand, each of Category Numbers 5 and 7 is correlated with an assignment target “general user”, and indicates that the known identifier is a known identifier assigned for a general user.

Further, the second digit serves as a check digit for use in judging, in accordance with below-described Formula (1), whether or not the first digit and the third through tenth digits are correct. This prevents the user from making an inputting error when making a call. The third through tenth digits are made up of eight arbitrary numerals, and are assigned to each communication terminal so that the digits do not coincide with those assigned to another communication terminal. Further, the known identifier can be changed any time at the user's request, and is basically not reused.

The check digit is found in accordance with, e.g. the following Formula (1):
[(n₁+n₃+n₅+n₇+n₉)×3+(n₄+n₆+n₈+n₁₀)] mod10 (1)

Note that notation “nₐ” indicates a numeral in the a-th digit.

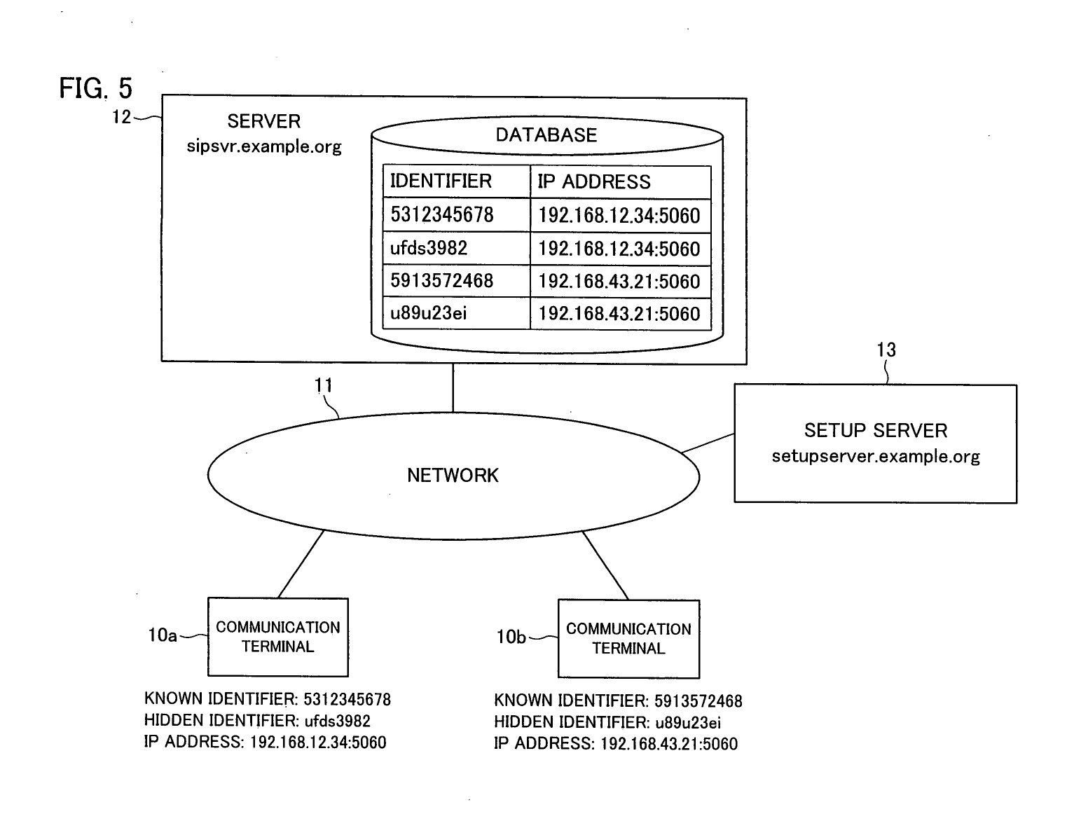

For example, consider a case where Category Number “5” is assigned to a communication terminal 10a shown in FIG. 5 and a connection target number thereof is “1234-5678”. In this case, as shown in Formula (2) below, the check digit is found to be “3” in accordance with Formula (1), and the known identifier is therefore “53-1234-5678”.
[(5+1+3+5+7)×3+(2+4+6+8)]mod10=3 (2)

When the value found by substituting the inputted numerals in Formula (1) coincides with the check digit, i.e., the second digit as such, it is judged that no inputting error was made.

The first digit of the known identifier serves as the category number, and is most likely to be firstly noticed by the user. Therefore, by simply looking at the first digit, the user understands for what purpose the known identifier was issued. Further, since the second digit serves as the check digit, the third through tenth digits can be freely assigned. This makes it possible to assign an easy-to-remember number to each of the “business purpose” known identifiers respectively indicated by, e.g., Category Numbers 2, 3, and 4.

Further, in the present embodiment, the ten-digit number is used as the known identifier regardless of the categories. However, the present invention is not limited to this. That is, a short and easy-to-remember number may be assigned as the number of the “business purpose” identifier.

Next, the hidden identifier is an identifier which is unseeable for any user, and which is assigned uniquely to each communication terminal so as not to be identical to the one assigned to another communication terminal. Since the hidden identifier is not seen by any user, the hidden identifier may be any type of identifier as long as the hidden identifier can be processed in a communication system. However, the hidden identifier used here is an eight-digit alphanumeric string (e.g., “ufds3982” assigned to the communication terminal 10a shown in FIG. 5). Here, as is the case with the digits of the known identifier, the digits of the hidden identifier are respectively referred to as a first digit, a second digit, and so on, in the order from the left.

The first digit of the hidden identifier is preferably a non-numeric character so that the hidden identifier is distinguishable from the known identifier. The description here assumes that the first digit is always “u”. That is, the alphanumeric string whose first digit is “u” is the hidden identifier. The rest seven digits are made up of arbitrary numerals and alphabets which may be written in capitals and in small letter. As such, the communication system of the present invention sets, as a communication protocol, the rules by which the identifiers and the types of identifier are distinguished.

The hidden identifier basically serves as an identifier for specifying a user. Therefore, once the hidden identifier is assigned to a communication terminal, the hidden identifier is fixed to and is stored in the communication terminal. Upon the user's request, a plurality of hidden identifiers may be assigned to a single communication terminal. However, even in such a case, the hidden identifiers are assigned additionally, and the already-assigned hidden identifier is not deleted. Further, such a communication service may be provided that the hidden identifier is transferred from the older communication terminal to the newer communication terminal.

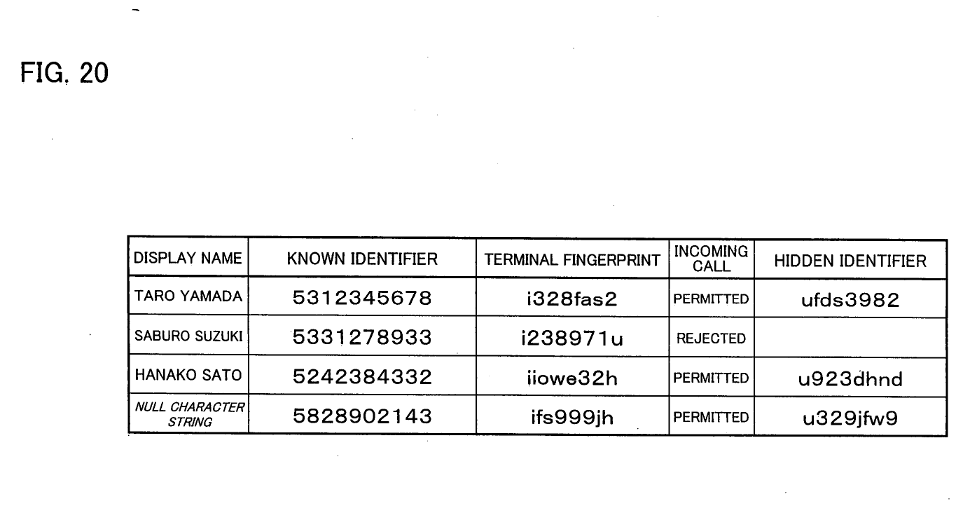

Next, the terminal fingerprint, which corresponds to a “first identifier” in claims, is an identifier which is unseeable for any user as is the case with the hidden identifier. The terminal fingerprint is the same as the hidden identifier, except that the first digit of the terminal fingerprint is different from that of the hidden identifier. Specifically, the first digit of the terminal fingerprint is, e.g., “i” as shown in, e.g., the terminal fingerprint “i328fas2” of FIG. 20. Further, the terminal fingerprint is generated such that: one terminal fingerprint is correlated with one hidden identifier, and the correlation between the terminal fingerprint and the hidden identifier is fixed. An example of how the terminal fingerprint is used will be described in Embodiment 2.

The hidden identifier and the terminal fingerprint are given to each user by an administrator of the communications.

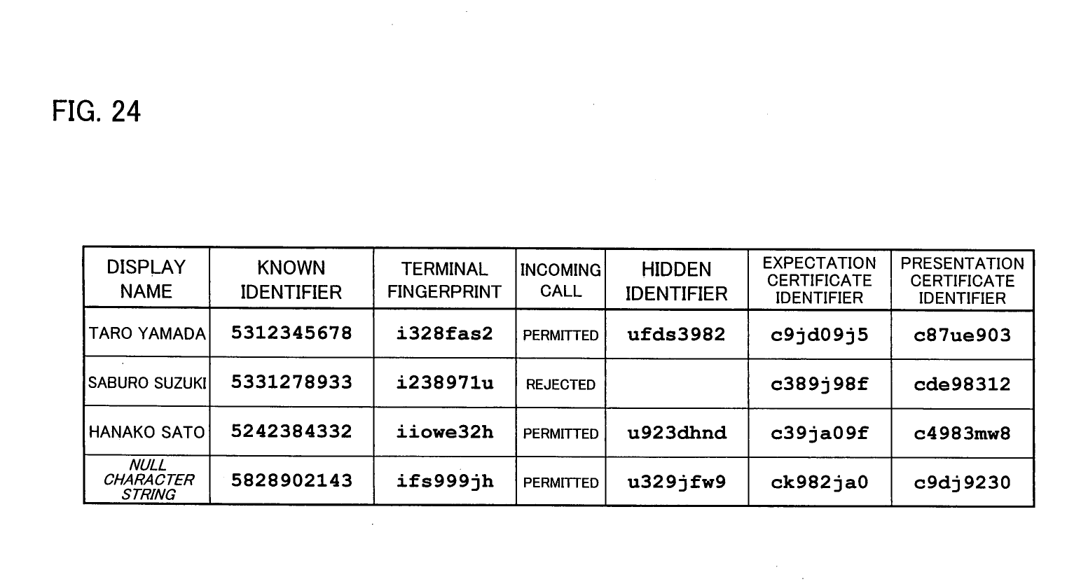

Further, the below-mentioned certificate identifier, which corresponds to a “second identifier” in claims, is generated by the user's communication terminal. The certificate identifier is an identifier for use in checking whether or not the user's communication terminal has previously communicated with a target communication terminal, and is not seen by the user. The certificate identifier is so generated by the user's communication terminal as to be correlated with a terminal fingerprint of the target communication terminal, and as to be exclusively used for the target communication terminal. The certificate identifier is sent to the target communication terminal. For example, the certificate identifier is an eight-digit alphanumeric string whose first digit is “c” as shown in the certificate identifier “c9jd09j5” of FIG. 24. The certificate identifier does not need to be unique to the terminal fingerprint of the target communication terminal, but needs to be generated so as not to be inferred easily. The certificate identifier is easily generated with the use of a random number. Further, because one terminal fingerprint and one hidden identifier are correlated with each other as such, there is no difference between (i) the generation of the certificate identifier corresponding to the terminal fingerprint of the target communication terminal, and (ii) generation of the certificate identifier corresponding to a hidden identifier of the target communication terminal. This will be fully described in Embodiment 3.

The following explains the address identifier. A communication terminal of the present invention is supposed to be connected to and is used in a packet-switched network such as the Internet. Required in the packet-switched network is information for determining a route (path) via which a packet is transmitted from a data source to a target. Here, such information is referred to as “address identifier”. In the case of the Internet, the address identifier corresponds to an IP address (and a port number) such as “192.168.12.34:5060” assigned to the communication terminal 10a of FIG. 5. The following explanation assumes that the address identifier is the IP address.

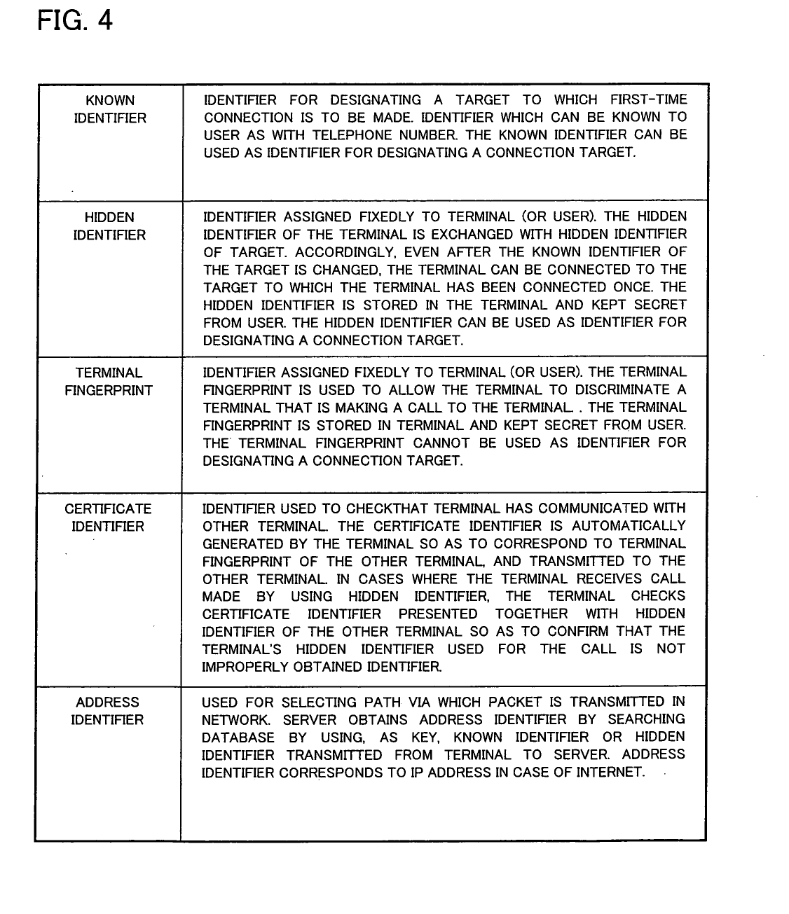

FIG. 4 is a table giving respective explanations for the various identifiers.

The following explains transmission and storage of the identifiers. When making or receiving a call, the known identifier, the hidden identifier, and the terminal fingerprint are sent and received. It is preferable that each of the known identifier, the hidden identifier, and the terminal fingerprint be encrypted. In the field of the Internet, IPsec (IP Security Protocol) or the like is adopted as an encryption rule. Further, the hidden identifier and the terminal fingerprint are preferably encrypted also when stored, for example, in a nonvolatile memory provided in the communication terminal. Moreover, it is preferable to store the hidden identifier and the terminal fingerprint such that the hidden identifier and the terminal fingerprint are not revealed to the user. The encrypted identifiers may be deciphered with the use of a decoding device or the like under appropriately managed conditions, upon, e.g., repairing the communication terminal.

A communication system according to the present embodiment will be described with reference to FIG. 5.

The communication system includes a communication terminal 10a, a communication terminal 10b, a network 11, a server (SIP server) 12, and a setup server 13. The network 11 is a network via which communication data is transmitted in accordance with IP. A specific example of the network 11 is the Internet. The server 12 relays a packet in response to an inquiry sent from each of the communication terminals 10a and 10b. The setup server 13 is a server which provides setup information (described later) of each of the communication terminals 10a and 10b.

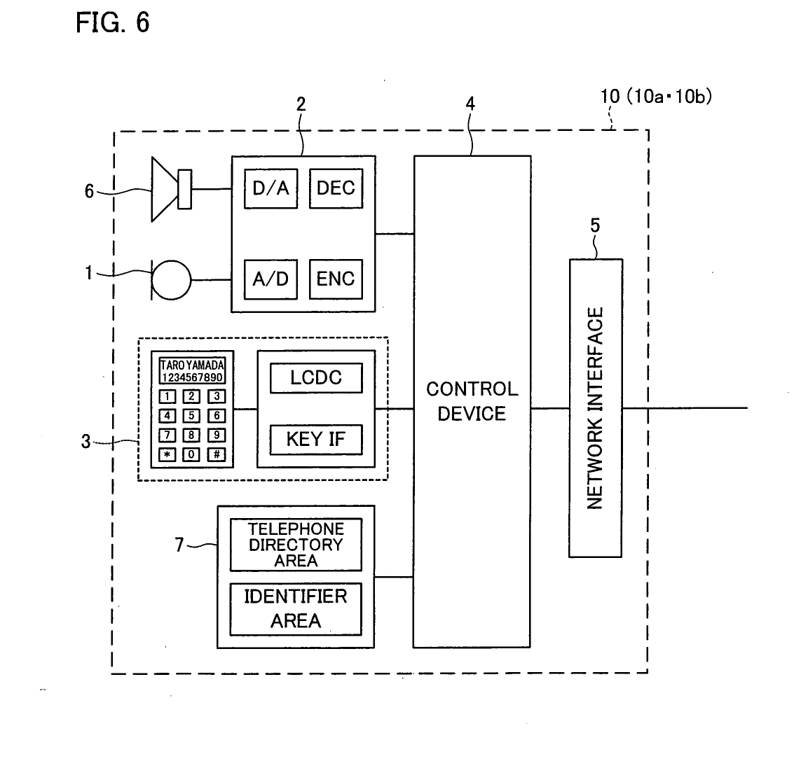

In the following, an arrangement of each of the communication terminals 10a and 10b will be schematically described with reference to FIG. 6. As shown in FIG. 6, each of the communication terminals 10a and 10b includes a microphone 1, an audio interface 2, an input/output device (input and output apparatus) 3, a control device 4, a network interface 5, a speaker 6, and a telephone directory storage section (address storage section) 7.

The microphone 1 converts a sound (sound wave) such as a voice into an analog electric signal (hereinafter referred to as “audio signal”), and sends the audio signal to the audio interface 2.

Upon receiving the audio signal, the audio interface 2 (i) converts the audio signal into digital data, (ii) encodes the digital data, and (iii) sends the encoded digital data to the control device 4.

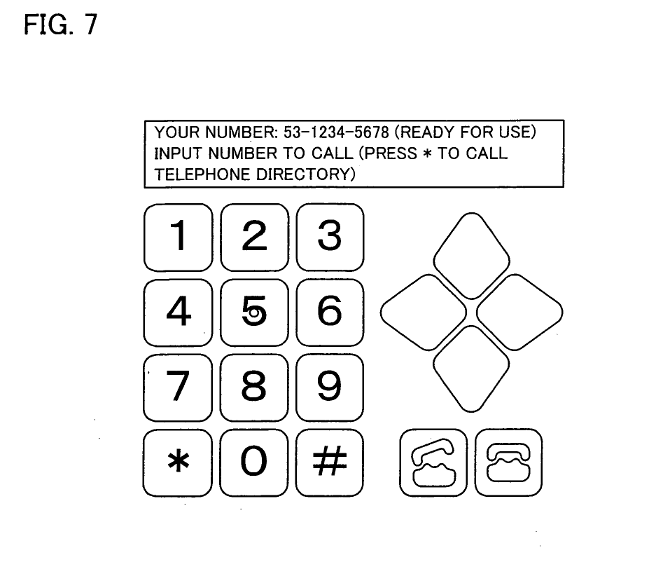

Further, the input/output device 3 is a device for receiving, from the user, an input for carrying out an operation such as a call-making operation or a call-receiving operation. The input/output device 3 converts the received input into a signal, and sends the signal to the control device 4. As shown in FIG. 7, the input/output device 3 may be a screen-equipped keyboard, for example.

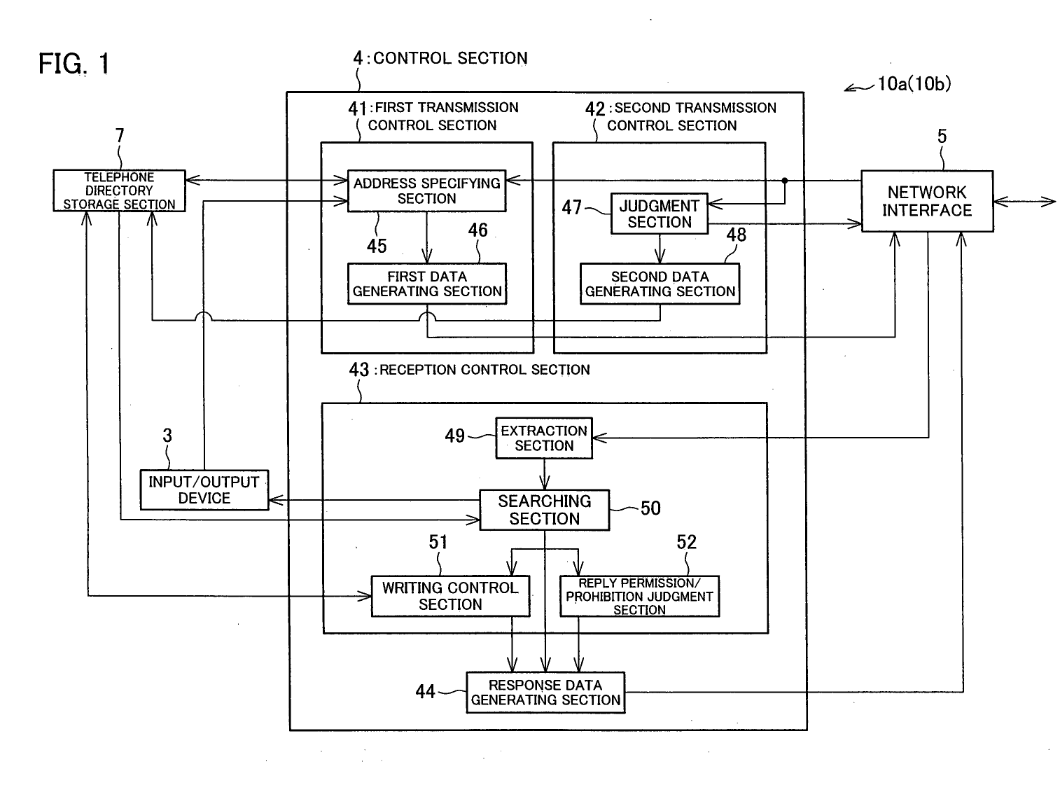

The control device 4 converts the received data into a packet whose format is appropriate for the network, and then sends the packet to the network interface 5. Further, as shown in FIG. 1, the control device 4 includes a first transmission control section 41, a second transmission control section 42, a reception control section 43, and a response data generating section 44, each of which will be fully described later.

Upon receiving the packet, the network interface 5 sends the packet to the other communication terminal. Thereafter, the network interface 5 receives a packet from the other communication terminal, and then sends the packet to the control device 4. The control device 4 analyzes the packet. Then, the control device 4 sends, to the audio interface 2, data obtained through the analysis.

Upon receiving the data obtained through the analysis, the audio interface 2 converts the data into an analog signal by decoding the data, and then sends the analog signal to the speaker 6. Upon receiving the analog signal, the speaker 6 converts the analog signal into a sound or the like and outputs the sound.

The telephone directory storage section 7 stores a table in which (i) specifying information (user names, known identifiers, and the like) for specifying a plurality of communication terminals, (ii) hidden identifiers, and (iii) connection permission/prohibition information (connection permission information) are correlated with one another. Here, the telephone directory storage section 7 is not limited to a fixed nonvolatile memory provided in the communication terminal, but may be a detachable module such as a card-type nonvolatile memory. Accordingly, any communication terminal to which the user inserts the module detached from the user's communication terminal can operate as the user's communication terminal does, when the communication terminal is activated.

The communication terminal may include both (i) the fixed nonvolatile memory and (ii) an insertion part into which the modular nonvolatile memory is inserted. In this case, when the modular nonvolatile memory is inserted in the insertion part, the modular nonvolatile memory is used in preference to the fixed nonvolatile memory.

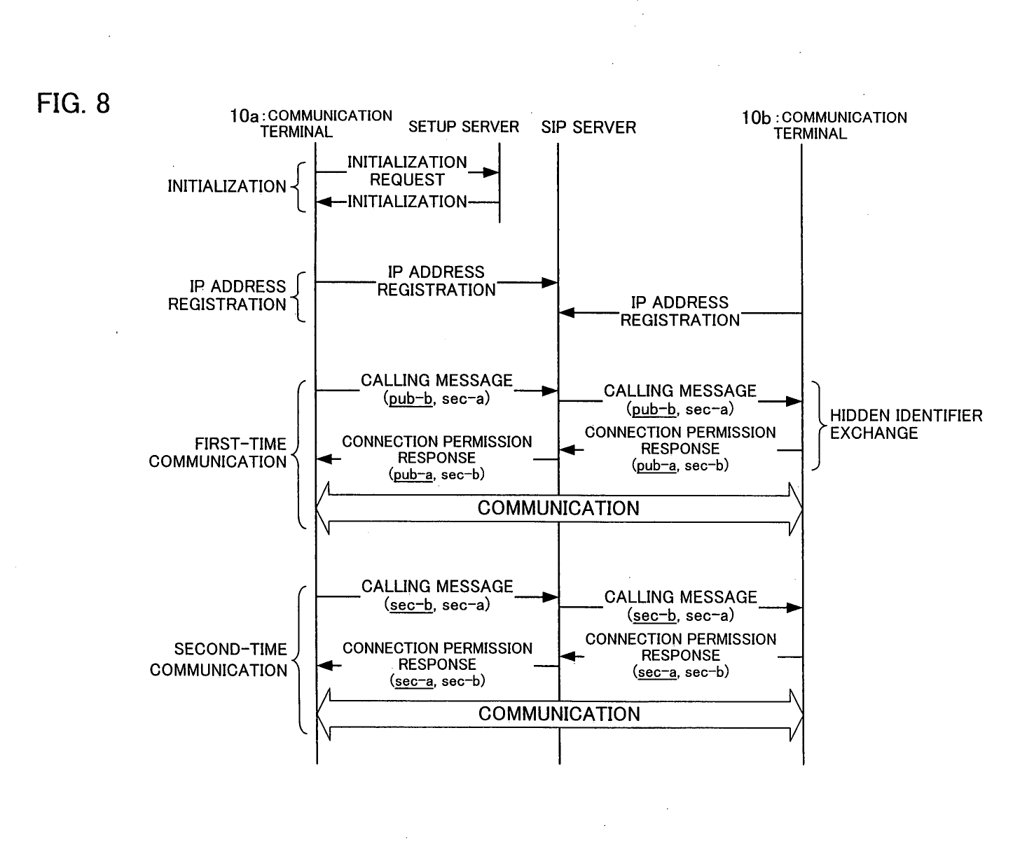

The following schematically explains an operation of each of the communication terminals 10a and 10b according to the present embodiment, with reference to FIG. 8. Note that, explained here is an operation carried out when the communication terminal 10a, which serves as a transmitting apparatus, makes a call to the communication terminal 10b, which serves as a receiving apparatus. The same operation is carried out in cases where the communication terminal 10b makes a call to the communication terminal 10a; therefore, such a case will not be explained. Further, the symbol “pub-a” described in FIG. 8 is a known identifier of the communication terminal 10a, and the symbol “pub-b” is a known identifier of the communication terminal 10b. Moreover, the symbol “sec-a” is a hidden identifier of the communication terminal 10a, and the symbol “sec-b” is a hidden identifier of the communication terminal 10b. Furthermore, each of the identifiers underlined in FIG. 8 indicates a destination (target address) of a message.

The communication terminal 10a makes access to the setup server 13 so as to be initialized as described later. Then, the communication terminal 10a registers its address identifier (IP address) in the server 12 so that the server 12 can relay a packet to the communication terminal 10a.

Moreover, when the communication terminal 10a makes a call to the communication terminal 10b for the first time, the communication terminal 10a sends, to the server 12, a calling message (pub-b, sec-a) which is addressed to the known identifier of the communication terminal 10b and which contains the hidden identifier of the communication terminal 10a. In accordance with the known identifier of the communication terminal 10b, the server 12 transfers the calling message (pub-b, sec-a) to the communication terminal 10b. Thereafter, the communication terminal 10b sends, to the server 12, a connection permission response (pub-a, sec-b) which is addressed to the known identifier of the communication terminal 10a and which contains the hidden identifier of the communication terminal 10b. In accordance with the known identifier of the communication terminal 10a, the server 12 transfers the connection permission response (pub-a, sec-b) to the communication terminal 10a. In this way, the communication terminal 10a and the communication terminal 10b can exchange their hidden identifiers with each other. Further, since the hidden identifiers are assigned uniquely to the communication terminals respectively, a call rejection setting can be carried out in accordance with the hidden identifiers.

When the communication terminal 10a makes a call for the second or later time to the communication terminal 10b after exchanging the hidden identifiers with the communication terminal 10b, no known identifiers are used but the hidden identifiers are used unlike the call made for the first time. The hidden identifiers are supplied in the same manner as described above.

The following separately explains (i) an operation for initializing each of the communication terminals, (ii) an operation for registering the communication terminal, (iii) an operation that the communication terminal makes a call to a communication terminal with which the communication terminal communicates for the first time, and (iv) an operation that the communication terminal makes a call to a communication terminal with which the communication terminal has previously communicated.

First, the operation for initializing the communication terminal 10a will be fully described.

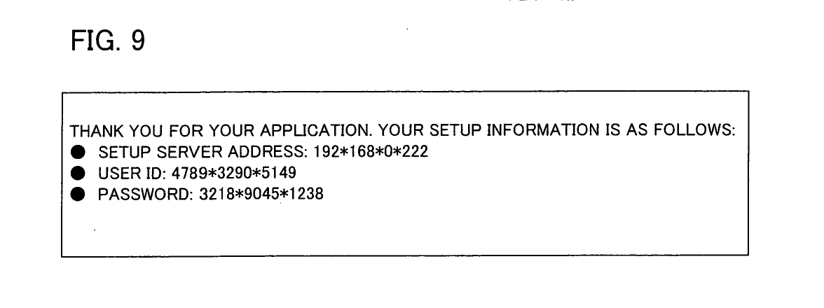

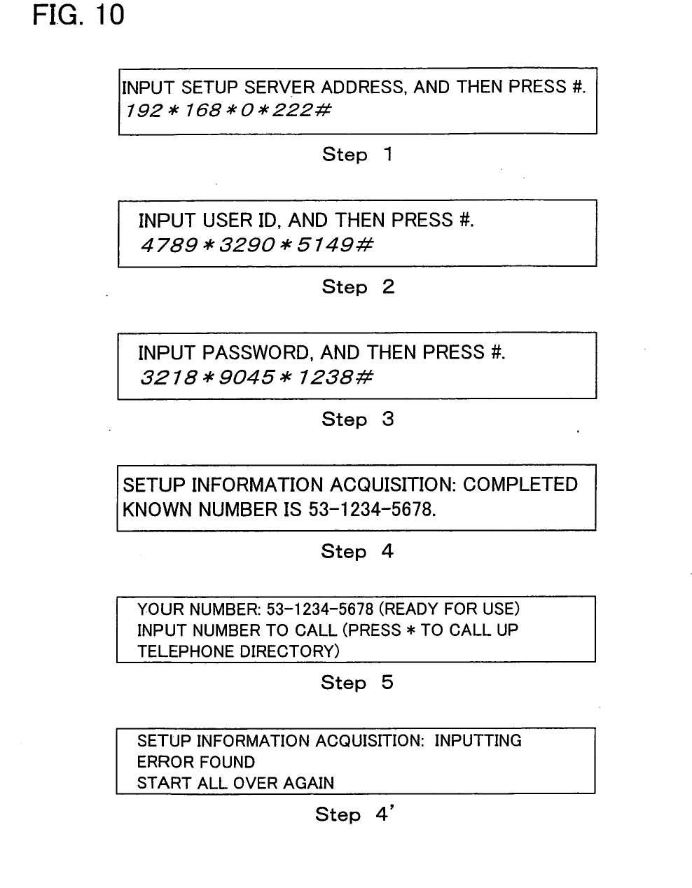

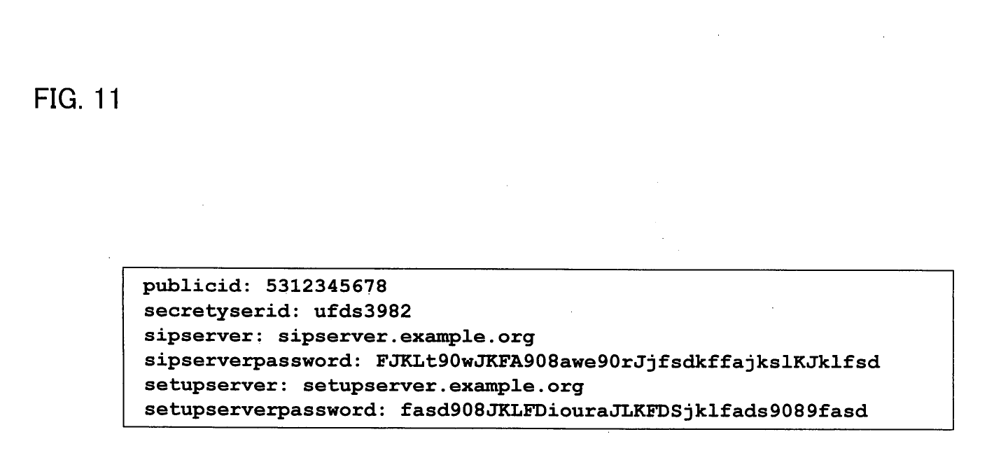

As shown in FIG. 9, a service provider managing the server 12 and the setup server 13 provides a user by, e.g., mail with (i) an address identifier (IP address) of the setup server 13, (ii) a user ID, and (iii) a password, each of which is necessary for initialization of the communication terminal 10a. Then, as shown in FIG. 10, the user uses the input/output device 3 so as to enter the address identifier of the setup server 13, the user ID, and the password into the communication terminal 10a (Steps 1 through 4). Then, the communication terminal 10a transmits the user ID and the password to the setup server 13. Then, from the setup server 13, the communication terminal 10a downloads initialization setup information concerning the user, i.e., a known identifier (publicid), a hidden identifier (secretyserid), a setup server address (setupserver), a setup server password (setupserverpassword), a server address (sipserver), and a server password (sipserverpassword). Here, italic character strings shown in FIG. 10 are character strings entered by the user. FIG. 11 shows an example of the setup information acquired by the communication terminal 10a on this occasion.

When the initialization is finished by carrying out the aforementioned steps, the screen indicates that the communication terminal is waiting for the user to enter the number of the communication terminal with which the communication is to be carried out, as shown in FIG. 10 (Step 5). The setup server address is identical to the address identifier (IP address) except that the periods (.) in the address identifier (IP address) are respectively replaced with asterisks (*) for user's convenience. In cases where an error is made in the inputting, the screen displays indication shown in, e.g., Step 4′ of FIG. 10. After a few seconds, the sequence automatically goes back to Step 1. This is the end of the initialization.

Here, the setup information given to the communication terminal 10a and concerning the SIP server address and the setup server address may have a name that can be converted into an IP address (address identifier) by using a DNS. With this, the IP address (address identifier), registered in the server, of the communication terminal 10a can be changed later as required.

Next, the operation for registering the communication terminal 10a will be described.

The communication terminal 10a registers its address identifier in the server 12 either (i) when the communication terminal 10a is activated, or (ii) when the address identifier assigned to the communication terminal 10a is changed. Also, the communication terminal 10a can regularly update the address identifier assigned to the communication terminal 10a, and can register the updated address identifier in the server 12. In addition to the address identifier thus registered, the known identifier and the hidden identifier are registered in the server 12.

Further, a general server managing only a correlation between one identifier and one address identifier can be used for this system. In this case, (i) a combination of the known identifier and the address identifier, and (ii) a combination of the hidden identifier and the address identifier may be registered separately.

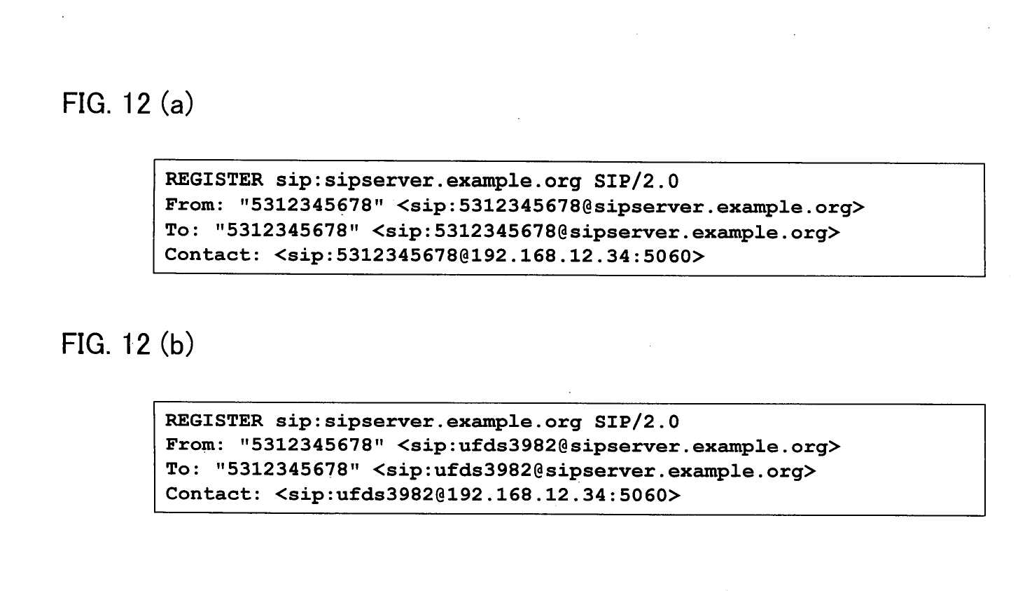

FIG. 12(a) shows an example of a main portion taken from an SIP message sent from the communication terminal 10a to the server 12 upon the registration of the combination of (i) the known identifier (5312345678) of the communication terminal 10a and (ii) the address identifier (192.168.12.34:5060) containing the port number. FIG. 12(b) shows an example of a main portion taken from an SIP message sent from the communication terminal 10a to the server 12 upon the registration of the combination of (a) the hidden identifier (ufds3982) of the communication terminal 10a and (b) the address identifier (192.168.12.34:5060) containing the port number.

Once the registration process is done, a message (packet) can be sent from the communication terminal 10b to the communication terminal 10a, e.g., as follows. That is, the communication terminal 10b designates either the known identifier or the hidden identifier of the communication terminal 10a, and sends the message (packet) to the server 12. The message thus received by the server 12 is transferred to the communication terminal 10a. In order to check validity of such a request or message generated by each of the communication terminals 10a and 10b, authentication is carried out with the use of, e.g., the server password. The authentication makes use of a commonly used technique, so that explanation thereof is omitted. For security reasons, for example, the communication between (i) each of the servers 12 and 13 and (ii) the communication terminal 10a, the communication between (a) each of the servers 12 and 13 and (b) the communication terminal 10b, and the communication between the communication terminal 10a and the communication terminal 10b are encrypted. As is the case with the authentication, the encryption makes use of a commonly used technique, so that explanation thereof is omitted.

With reference to FIG. 8, the following explains the operation carried out when the communication terminal 10a makes a call to a communication terminal with which the communication terminal 10a communicates for the first time. Exemplified here is a case where the communication terminal 10a makes a call to the communication terminal 10b.

A point of the process in this case is as follows. That is, the communication terminal 10a transmits, to the communication terminal 10b, connection request data containing data for requesting a connection. Upon receiving the connection request data, the communication terminal 10b sends response data to the communication terminal 10a. The communication terminal 10a judges whether or not the response data thus received contains the hidden identifier of the communication terminal 10b. In cases where it is judged that the response data contains the hidden identifier, the communication terminal 10a will generate, in the next or later call to the communication terminal 10b, connection request data including the respective hidden identifiers of the sending end and the receiving end, i.e., of the communication terminals 10a and 10b. The process will be specifically described below.

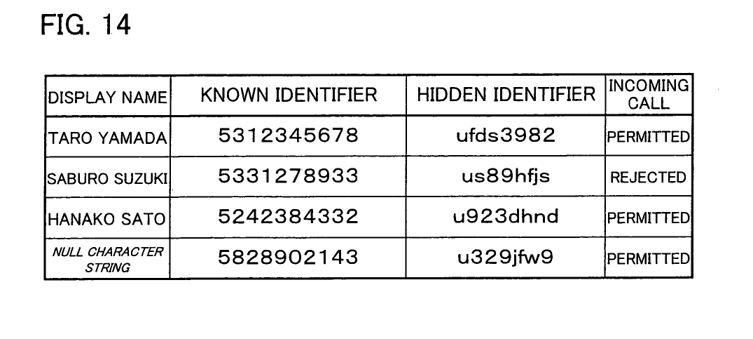

First, the communication terminal 10a (used by a user “Taro Yamada” shown in FIG. 5 and FIG. 14) requests a connection by sending, to the server 12, a connection request message (connection request data) addressed to the known identifier “pub-b” (“5913572468” shown in FIG. 5) of the communication terminal 10b.

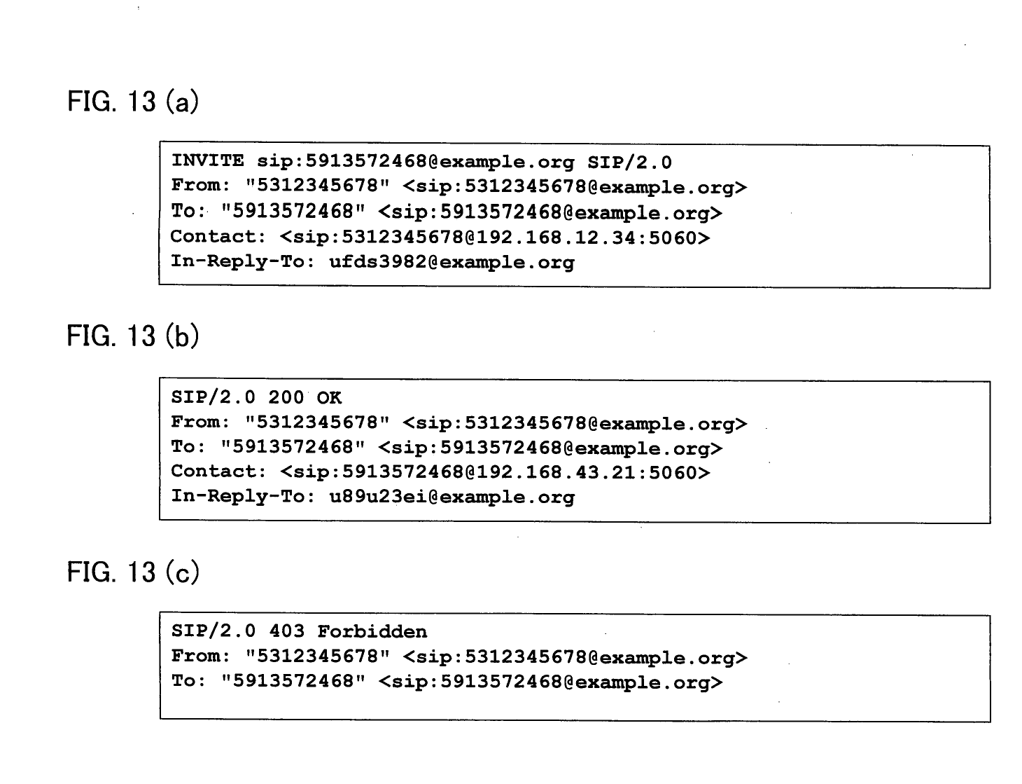

As shown in FIG. 13(a), the connection request message contains (i) a message (INVITE) for requesting a connection, and (ii) the hidden identifier (ufds3982) of the sending end (In-Reply-To).

FIG. 13(a) shows an example of the connection request message. In this example, the known identifier (5312345678) of the communication terminal 10a is set as information (From) for specifying the sending end, and the known identifier (5913572468) of the communication terminal 10b is set as information (To) for specifying a destination. Moreover, the hidden identifier (ufds3982) of the communication terminal 10a is set as an identifier (In-Reply-To) by which the communication terminal 10b or the server 12 recognizes that the communication terminal 10a is the one that is making a call. Further, the connection request message contains the address identifier (192.168.12.34:5060) of the communication terminal 10a (Contact).

In reference to the destination (target address), the server 12 transfers the connection request message to the communication terminal 10b. The communication terminal 10b makes reference to a table (see FIG. 14) stored in the telephone directory storage section 7 of the communication terminal 10b. In cases where no call rejection is set for the hidden identifier of the communication terminal 10a, the communication terminal 10b sends, to the communication terminal 10a, a response message (hereinafter referred to as “acceptance response message”) indicating that the communication terminal 10b accepts the call. On the other hand, in cases where the call rejection is set therefor, the communication terminal 10b sends, to the communication terminal 10a, a response message (hereinafter referred to as “call rejection response message”) indicating that the communication terminal 10b rejects the call. FIG. 13(b) shows an example of the acceptance response message, and FIG. 13(c) shows an example of the call rejection response message.

As shown in FIG. 13(b), the acceptance response message has a first row in which an “OK” message indicating that the call is accepted is set. The information (From) for specifying the sending end, and the information (To) for specifying the target address (destination) are the same as those contained in the connection request message. Further, the acceptance response message sent from the communication terminal 10b contains the hidden identifier “u89u23ei” of the communication terminal 10b. Therefore, when the communication terminal 10b accepts the call from the communication terminal 10a, the communication terminals 11a and 10b exchange their hidden identifiers with each other. That is, the communication terminal 10a receives the hidden identifier of the communication terminal 10b, and the communication terminal 10b receives the hidden identifier of the communication terminal 10a. The above process makes it possible that the communication terminals 10a and 10b exchange their hidden identifiers with each other in their first-time communication.

On the other hand, as shown in FIG. 13(c), the call rejection response message has a first row in which a “Forbidden” message indicating that the call is rejected is set. The call rejection response message does not contain the hidden identifier of the communication terminal 10b. Therefore, in the case where the communication terminal 10b rejects the call from the communication terminal 10a, the communication terminal 10a is not allowed to acquire the hidden identifier of the communication terminal 10b.

FIG. 14 shows a structure of the table stored in the telephone directory storage section 7. Assume that the telephone directory storage section 7 storing the table shown in FIG. 14 is provided in the communication terminal 10b. The first column of the table represents a name (specifying information) that specifies a sending end (communication terminal) from which a call is received, and that is supposed to be displayed on the input/output device 3 when the communication terminal 10b receives the call therefrom. The second column represents the known identifier used when making the first-time call. The third column represents the hidden identifier. The fourth column represents a set value (connection permission/prohibition information such as a flag) indicating whether or not the call is to be accepted. When receiving an acceptance response message containing the known identifier and hidden identifier of the communication terminal 10a, the communication terminal 10b registers the known identifier and hidden identifier of the communication terminal 10a in the table shown in FIG. 14. The user of the communication terminal 10b can freely set the connection permission/prohibition information so as to determine whether or not the connection is permitted.

With reference to FIG. 8, the following explains the operation carried out when the communication terminal 10a makes a call to a communication terminal with which the communication terminal 10a has previously communicated. Exemplified here is a case where the communication terminal 10a makes a call to the communication terminal 10b.

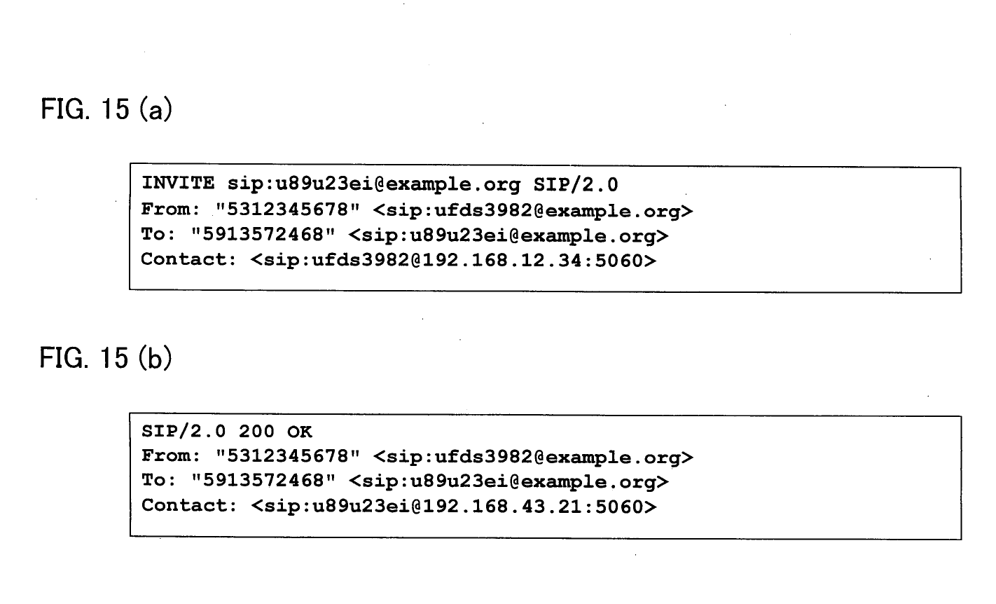

The communication terminal 10a sends, to the server 12, a connection request message addressed to the hidden identifier (“u89u23ei”; abbreviated as “sec-b” in FIG. 8) of the communication terminal 10b. As shown in FIG. 15(a), the connection request message contains (i) the message (INVITE) for requesting connection, and (ii) the hidden identifier (“ufds3982”; abbreviated as “sec-a” in FIG. 8) of the sending end.

In reference to the hidden identifier (u89u23ei) of the destination (target address), the server 12 transfers the connection request message to the communication terminal 10b. Here, the communication terminal 10b makes reference to the table stored in the telephone directory storage section 7 of the communication terminal 10b. In cases where the communication terminal 10b confirms that the hidden identifier of the communication terminal 10a is registered in the table and that the call is not set to be rejected, the communication terminal 10b sends, to the server 12, the acceptance response message which is shown for example in FIG. 15(b) and which contains the hidden identifier (u89u23ei) of the communication terminal 10b.

Thus, the sending end does not use the changeable known identifier of the receiving end when communicating with the receiving end for the second time. Instead, the sending end uses the respective hidden identifiers of the sending end and the receiving end. The hidden identifiers are unknown to anyone, and are assigned fixedly to the communication terminals, respectively. Therefore, even when the known identifier of the receiving end is changed, the sending end can communicate with the receiving end as long as the receiving end is not set to reject the call from the sending end.

The following separately explains (i) a case where each of the communication terminals 10a and 10b (hereinafter referred to as “communication terminals 10” for convenience) carries out a call-making process; and (ii) a case where each of the communication terminals 10 carries out a call-receiving process.

FIG. 1 illustrates a functional structure of the control section 4 provided in the communication terminal 10. The first transmission control section 41 provided in the control section 4 includes an address specifying section 45 and a first data generating section 46. The second transmission control section 42 provided therein includes a judgment section (judging section) 47 and a second data generating section 48. The reception control section 43 includes an extraction section (extracting section) 49, a searching section 50, a writing control section 51, and a reply permission/prohibition judgment section (reply permission judging section) 52. Furthermore, the control section 4 includes a response data generating section 44.

Each of the response data generating section 44, the address specifying section 45, the first data generating section 46, the judgment section 47, the second data generating section 48, the extraction section 49, the searching section 50, the writing control section 51, and the reply permission/prohibition judgment section 52 is a functional block. The functional block is realized by causing a CPU to (i) execute a program stored in a storage device and (ii) control a peripheral circuit (not shown) such as an input/output circuit.

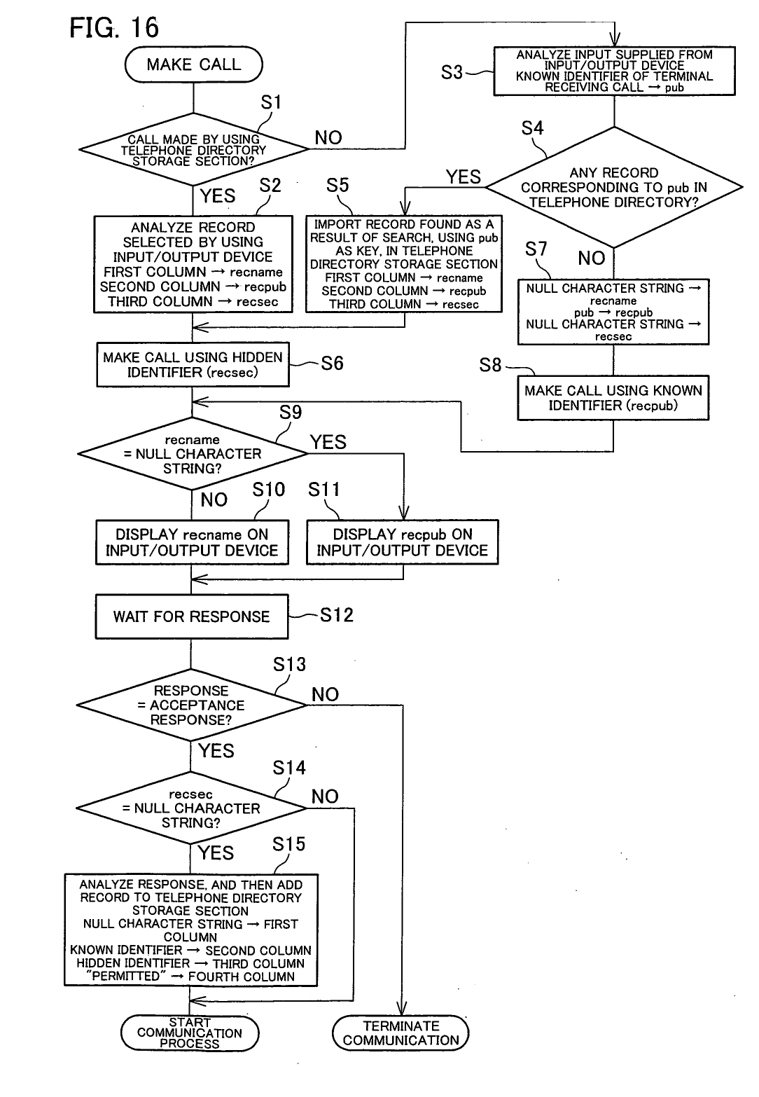

The following explains how the communication terminal 10 of the present embodiment operates when making a call, with reference to a flowchart shown in FIG. 16.

First, there are the following methods (1) and (2) by which the user can make a call: (1) the user makes reference to the telephone directory storage section 7, and then selects a record registered therein; and (2) the user inputs a known identifier directly. In Step 1 (hereinafter, the wording “Step” is abbreviated as “S”), either of the methods (1) and (2) is chosen. When the method (1) is chosen, the sequence goes to S2. When the method (2) is chosen, the sequence goes to S3.

The following separately explains (i) processes S2 and later, and (ii) processes S3 and later.

In S2, the input/output device 3 displays a list of communication destinations among which the user can select a communication destination. In response to the user's selection, the input/output device 3 sends, to the address specifying section 45, a signal indicating the user's selection (hereinafter, the signal is referred to as “selection signal”). Upon receiving the selection signal, the address specifying section 45 makes reference to the telephone directory storage section 7 so as to import and analyze the display name (first column; recname), the known identifier (second column; recpub), and the hidden identifier (third column; recsec) of the communication destination selected by the user. Then, the telephone directory storage section 7 sends the display name, the known identifier, and the hidden identifier to the first data generating section 46. Thereafter, the sequence goes to S6.

On the other hand, in S3, the user uses the input/output device 3 so as to input a telephone number (known identifier) of a desired destination. In response to the input, the input/output device 3 sends the input to the address specifying section 45. The address specifying section 45 uses the known identifier as a key in order to search the telephone directory storage section 7 for a record corresponding to the known identifier, and then the address specifying section 45 judges whether or not the telephone directory storage section 7 stores the corresponding record (S4). In cases where the corresponding record is stored therein, the sequence goes to S5. In cases where no corresponding record is stored therein, the sequence goes to S7.

The following separately explains (i) processes S5 and later, and (ii) processes S7 and later.

In S5, the address specifying section 45 imports the corresponding record from the telephone directory storage section 7, and reads out the display name (recname), the known identifier (recpub), and the hidden identifier (recsec) respectively from the first, second, and third columns of the record. Then, the address specifying section 45 sends the display name, the known identifier, and the hidden identifier to the first data generating section 46. Thereafter, the sequence goes to S6.

Then, the first data generating section 46 generates a message (see FIG. 15(a)) containing the hidden identifier (recsec) of the communication destination, then a call is made with the use of the hidden identifier (recsec) of the destination (S6). Thereafter, the sequence goes to S9.

In S7, which is carried out in cases where the telephone directory storage section 7 stores no record containing the known identifier, the address specifying section 45 sets a null character string in the first column (recname), sets the inputted known identifier in the second column (recpub), and sets a null character string in the third column (recsec). Then, the address specifying section 45 sends the display name, the known identifier, and the hidden identifier to the first data generating section 46. Then, the first data generating section 46 generates a message which is shown in FIG. 13(a) and which contains the known identifier (recpub) of the communication destination, and sends the message to the network interface 5, and a call is made with the use of the known identifier (recpub) of the destination (S8). That is, in cases where the hidden identifier of the communication destination is not stored in the table of the telephone directory storage section 7, the call is made with the use of the known identifier of the communication destination. Thereafter, the sequence goes to S9.

In S9, the address specifying section 45 judges whether or not the display name (recname) is represented by a null character string (S9). In cases where the display name (recname) is not represented by a null character string, the sequence goes to S10. In S10, the address specifying section 45 causes the input/output device 3 to display the character string. This distinctly indicates to whom the call is being made.

On the other hand, in cases where the display name (recname) is represented by a null character string, the sequence goes to S11. In S11, the address specifying section 45 causes the input/output device 3 to display the known identifier (recpub) of the communication destination, instead of the display name of the communication destination.

Thereafter, the communication terminal 10 waits until the communication terminal 10 receives an acceptance response packet or a call rejection response packet from the communication destination (S12).

In S13, when receiving either of the above packets via the network interface 5, the extraction section 49 judges whether or not the packet is the acceptance response packet. When the packet is the acceptance response packet, the extraction section 49 extracts the hidden identifier of the communication destination from the acceptance response packet. On the other hand, in cases where the extraction section 49 receives the call rejection response packet, the communication process is terminated.

In S14, which is carried out in cases where the acceptance response packet is received, the searching section 50 searches the table of the telephone directory storage section 7 by using, as a key, the hidden identifier extracted by the extraction section 49. Then, the searching section 50 judges whether or not the third column (recsec) of the table is represented by a null character string. In cases where the hidden identifier (recsec) is represented by a null character string, the sequence goes to S15. On the other hand, in cases where the hidden identifier (recsec) is not represented by a null character string but is already registered, the call-making operation is finished and the communication process is started.

In S15, the communication terminal having sent the acceptance response packet including the hidden identifier is an appropriate one but is not registered in the telephone directory storage section 7, so that the registration process is carried out. That is, the writing control section 51 (i) records, onto the second column of the table, the communication destination's known identifier extracted by the extraction section 49, (ii) records the hidden identifier onto the third column, and (iii) records, onto the fourth column, information indicating that the communication destination is permitted to send the acceptance response packet. Note that a null character string is automatically entered as a display name in the first column, or the first column is automatically skipped. Thereafter, the call-making operation is finished, and the communication process is started.

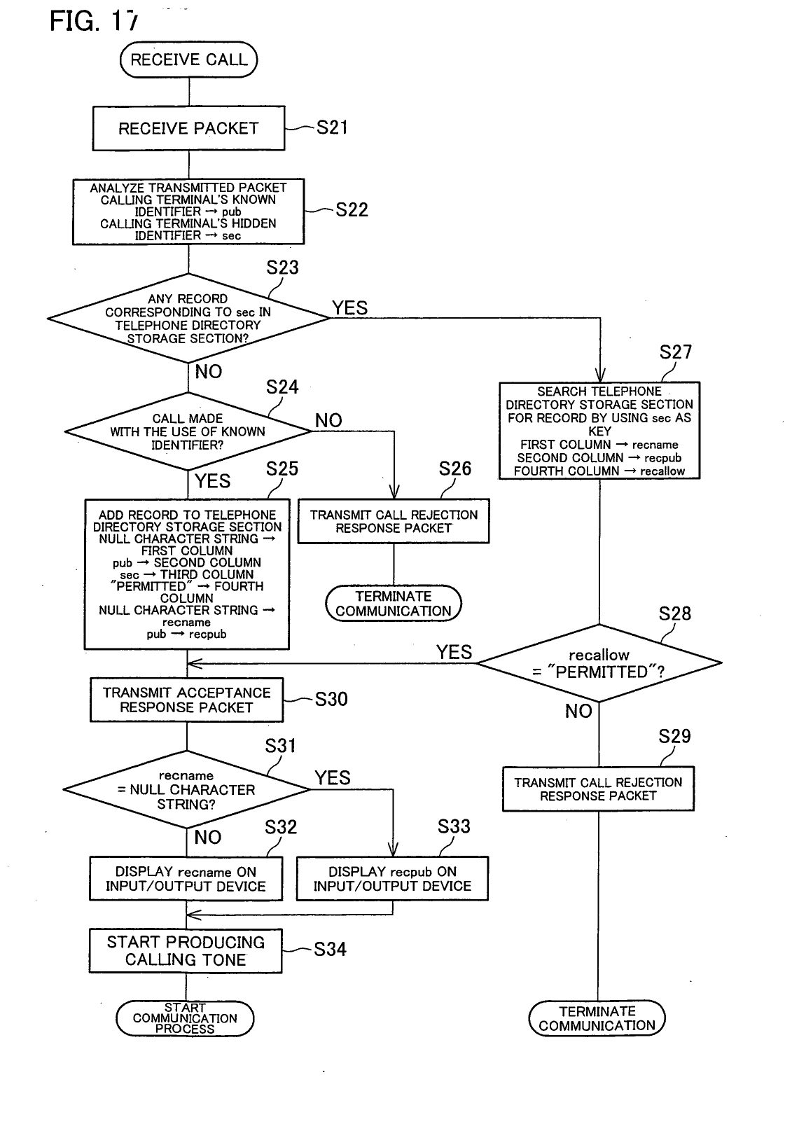

The following explains how the communication terminal 10 of the present embodiment operates when receiving a call, with reference to a flowchart shown in FIG. 17.

First, when the network interface 5 receives a packet, the network interface 5 sends the packet to the extraction section 49 (S21).

Then, the extraction section 49 analyzes the packet. When the extraction section 49 judges that the packet is a calling-making packet, the extraction section 49 extracts a known identifier and a hidden identifier from the calling-making packet. Then, the extraction section 49 sets the known identifier and the hidden identifier as variables “pub” and “sec” of a call-receiving program, respectively (S22).

Thereafter, the extraction section 49 sends the variables “pub” and “sec” to the searching section 50, and the searching section 50 searches for a record corresponding to the variable “sec”, in reference to the table of the telephone directory storage section 7 (S23). In cases where no corresponding record is found, the sequence goes to S24. In case where the corresponding record is found, the sequence goes to S27.

The following separately explains (i) processes S24 and later, and (ii) processes S27 and later.

In S24, the extraction section 49 judges whether or not the packet has been sent in accordance with the known identifier, i.e., whether or not the known identifier has been extracted from the call-making packet thus received.

In cases where the extraction section 49 judges that the packet has been sent in accordance with the known identifier, the sequence goes to S25. In S25, the variable “pub” and the variable “sec” are sent to the writing control section 51. Then, the writing control section 51 adds each of the variables pub and sec, as a record, to the table of the telephone directory storage section 7. Specifically, the writing control section 51 sets (i) a null character string in the first column of the table, (ii) the variable “pub” in the second column thereof, (iii) the variable “sec” in the third column thereof, and (iv) “PERMITTED” in the fourth column thereof. Moreover, the writing control section 51 sets the null character string and the variable “pub” in variables “recname” and “recpub”, respectively. Then, the writing control section 51 sends, to the response data generating section 44, a signal indicating “PERMITTED”. Thereafter, the sequence goes to S30.

On the other hand, in cases where the searching section 50 judges in S24 that the packet has been sent not in accordance with the known identifier but in accordance with, e.g., the hidden identifier of the communication terminal 10, the sequence goes to S26. However, this is unusual because no record corresponding to the hidden identifier of the sending end is registered in the telephone directory storage section 7 but the packet has been sent in accordance with the hidden identifier of the communication terminal 10. Therefore, in S26, the reply permission/prohibition judgment section 52 sends, to the response data generating section 44, a signal indicating that the call is rejected. Upon receiving the signal, the response data generating section 44 generates a call rejection response packet, and sends the call rejection response packet to the network interface 5. The network interface 5 sends the call rejection response packet to the sending end. As a result, the communication process is terminated.

On the other hand, in S27, the telephone directory storage section 7 stores a record corresponding to the hidden identifier of the sending end, so that the searching section 50 searches for (i) the information (variable “recname”) corresponding the first column of the table, (ii) the information (variable “recpub”) corresponding to the second column, and (iii) the information (variable “recallow”) corresponding to the fourth column. Thereafter, the searching section 50 sends the variable “recallow” to the reply permission/prohibition judgment section 52. Upon receiving the variable “recallow”, the reply permission/prohibition judgment section 52 judges whether or not the information set as the variable “recallow” indicates “PERMITTED” (S28). In cases where the information does not indicate “PERMITTED”, i.e., in cases where the information indicates “REJECTED”, the reply permission/prohibition judgment section 52 sends, to the response data generating section 44, a signal indicating “REJECTED”. Then, the sequence goes to S29. In S29, upon receiving the signal indicating “REJECTED”, the response data generating section 44 generates the call rejection response packet, and sends the call rejection response packet to the network interface 5. Thus, the communication process is terminated. On the other hand, in cases where the information indicates “PERMITTED”, the reply permission/prohibition judgment section 52 sends, to the response data generating section 44, a signal indicating “PERMITTED”. Then, the sequence goes to S30.

In S30, upon receiving the signal indicating “PERMITTED”, the response data generating section 44 generates an acceptance response packet, and sends the acceptance response packet to the network interface 5. The network interface 5 sends the acceptance response packet to the sending end.

Thereafter, the searching section 50 judges whether or not the variable “recname” is represented by the null character string (S31). In cases where the variable “recname” is not represented by the null character string, the sequence goes to S32. In S32, the searching section 50 causes the input/output device 3 to display the character string. On the other hand, in cases where the variable “recname” is represented by the null character string, the sequence goes to S33. In S33, the searching section 50 causes the input/output device 3 to display the known identifier of the sending end, which known identifier is set as the variable “recpub”. The processes S31 through S33 are processes for displaying the display name when the display name is registered in the telephone directory storage section 7; and for displaying, when the display name is not registered therein, the known identifier registered in the telephone directory storage section 7. With such processes, even in cases where the sending end makes a call for the second or later time with the use of a known identifier changed from the known identifier used when the call was made for the first time, the known identifier used when the call was made for the first time is displayed. This prevents the user of the receiving end from being confused.

Thereafter, when the sending end starts the communication process, the response data generating section 44 instructs a reproduction control section (not shown) to reproduce a calling tone (S34). Then, the reproduction control section uses the audio interface 2 so as to cause the speaker 6 to reproduce the calling tone. Then, the call-receiving operation is finished. When the user of the communication terminal 10 answers to the call, the communication process is started.

Instead of the above process, such a mode may be adopted that an incoming call using the known identifier of the receiving end is rejected, as follows. Initially, the communication terminal is so set as to receive an incoming call using the known identifier thereof. Then, the communication terminal is caused to be connected with another communication terminal to be allowed to communicate with the communication terminal. Then, each of the communication terminals thus connected with each other registers the hidden identifier of the other communication terminal. Thereafter, the mode is switched to the mode in which the incoming call using the known identifier is rejected, with the result that the communication terminal operates as a communication terminal which can only communicate with the communication terminal having exchanged the hidden identifiers with each other. This mode can be realized by carrying out setting such that the sequence always goes to “NO” in S24 shown in FIG. 17. For example, by arranging the communication terminal such that only a parent is allowed to switch to the mode in which a call using the known identifier is made or received, his/her child can be prevented from making a call to or receiving a call from an unwanted person.

Further, various user interfaces are required for maintenance of a data structure of the table of the telephone directory storage section 7 shown in FIG. 14. For the user interfaces, interfaces designed particularly for mobile phones can be used as long as the hidden identifier needs to be managed so as not to be seen by the user.

A user's nickname may be presented at the same time as the hidden identifier is presented, and the nickname is stored as the display name in the telephone directory storage section of the communication terminal with which the user communicates. With this, the telephone directory can be managed easily.

Further, in cases where a plurality of hidden identifiers are assigned to one communication terminal, the user may be allowed to choose, among the hidden identifiers, a hidden identifier which the user sends in transmitting a calling message or in responding to the calling message. This is useful when the communication terminal is shared by a plurality of users.

With the arrangement described above, even in cases where one of the communication terminals has changed its known identifier corresponding to a telephone number, the communication terminal can continuously receive calls from the communication terminal with which the communication terminal has previously communicated with the use of the permanent hidden identifier. This makes it possible to solve the foregoing Problem (1): when the telephone number of a user is changed, it is impossible to make a call to the user. Further, the hidden identifier is used for the setting of the rejection (call rejection) of a call from an unwanted person, so that the call from the unwanted person can be kept rejected even when the unwanted person changes his/her known identifier. This makes it possible to solve the foregoing Problem (2): when the telephone number is revealed to an unwanted person, the unwanted person is likely to make a call to the user. Furthermore, the change of the known identifier causes little inconvenience, so that the known identifier can be changed easily. This allows the foregoing Problem (3) to be minor: in cases where the telephone number is revealed to an unspecific number of people, the user is likely to receive an unwanted call until the user changes the telephone number. Further, the system employs the electronic telephone directory. This makes it possible to solve the foregoing Problem (4): since the telephone number is a series of numerals, the user has a difficulty in memorizing the telephone number, and therefore is likely to incorrectly input the telephone number. Furthermore, the input check using the check digit contributes to solving the Problem (4).

Thus, the present invention provides a system for solving the problems in the conventional telephone network. Further, the server 12 does not need to be a special one, so that a conventional SIP server can be used as the server 12. This makes it possible to reduce the cost of introducing the system.

In principle, there is no need to keep the hidden identifier of the communication terminal secret from the user of the communication terminal. However, the user has no chance of utilizing the hidden identifier. Further, the user possibly leak the hidden identifier, accidentally. Therefore, as with the present embodiment, it is preferable that the hidden identifier be kept secret from the user.

### Embodiment 2

According to the arrangement described above in Embodiment 1, one of the communication terminals notifies its hidden identifier to the other communication terminal to which the communication terminal has once been connected, so that the other communication terminal can make a connection to the communication terminal even when the communication terminal has changed its known identifier later.

However, according to the arrangement of Embodiment 1, the hidden identifier of the communication terminal is notified to the other communication terminal at the moment that the connection is made. Therefore, the unchangeable hidden identifier is sent to an unwanted person in some cases. It is possible to set up the call rejection with respect to unwanted people. However, such a setting is not reasonable.

Such an unwanted person makes connection to the user when, e.g., the known identifier is incorrectly inputted. Since the known identifier used in the present invention contains the check digit, the incorrect input is checked before making a call. However, such an error cannot be prevented completely. Further, the check digit is not essential for implementation of the present invention. Further, the hidden identifier is sent to the unwanted person by a device, which is constructed by maliciously modifying a proper communication terminal for the purpose of finding connectable known identifiers by making calls with the use of known identifiers automatically found. Moreover, the hidden identifier is sent to the unwanted person in cases where the user does not change his/her known identifier immediately because the user has not noticed that the user's known identifier is revealed to the unspecified number of people.

As such, the hidden identifier is inevitably sent to the unwanted person because the hidden identifiers are exchanged when the connection is made. This cannot be prevented even if the communication terminal is arranged such the hidden identifier is not easily extracted.

Required for the purpose of surely rejecting a call from the unwanted person is identification information which is similar to the hidden identifier and which is assigned fixedly to the communication terminal or the user. In light of this, the present embodiment explains a communication terminal, which has (i) the unchangeable hidden identifier for making a connection and (ii) a fixed identifier for identifying the communication terminal. Hereinafter, the fixed identifier for identifying the communication terminal is referred to as “terminal fingerprint (first identifier)”. As is the case with the hidden identifier, the terminal fingerprint is an identifier which is assigned uniquely and fixedly to each communication terminal by the setup server 13 and which is unknown to any user.

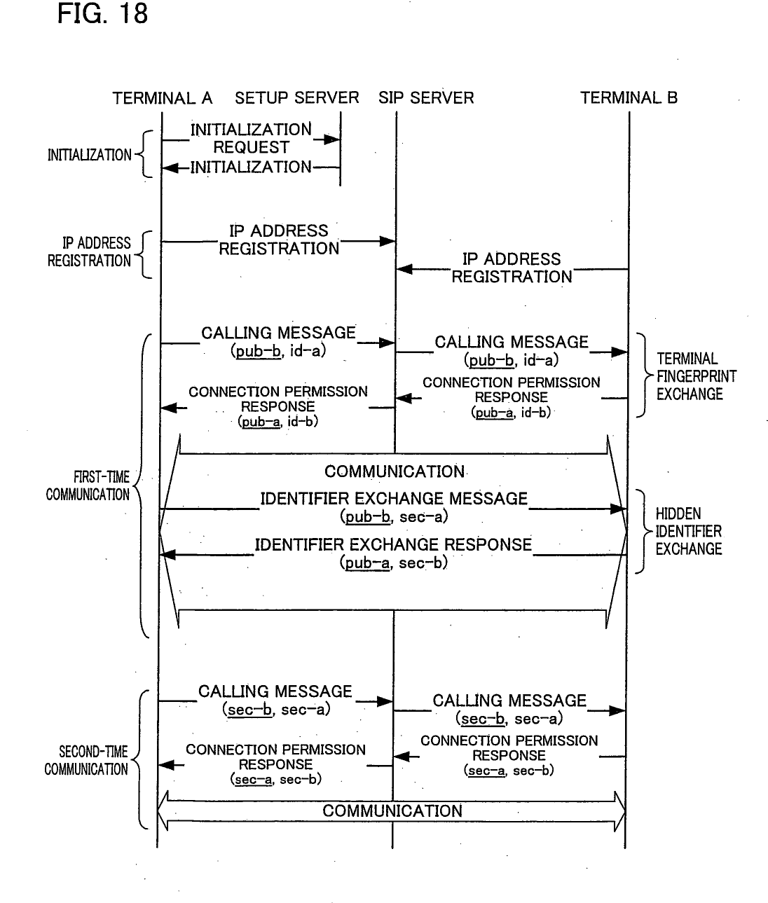

As shown in FIG. 18, the communication terminal according to the present embodiment operates in the same manner as the communication terminal according to Embodiment 1, except for the operation for making a call to a communication terminal with which the communication terminal communicates for the first time. Therefore, the following explains only the operation of making a call to the communication terminal for the first time. Note that notations “id-a” and “id-b” represent terminal fingerprints of the communication terminals 10a and 10b, respectively.

When starting communication, the communication terminal according to the present embodiment operates to exchange a terminal fingerprint with that of the other communication terminal, instead of exchanging the hidden identifiers with each other. Each of the terminal fingerprints is the same as each of the hidden identifiers in that the terminal fingerprint and the hidden identifier are both assigned fixedly to the user. However, the terminal fingerprint cannot be used to make a call.

The communication terminal according to the present embodiment is arranged in the same manner as the communication terminal 10 according to Embodiment 1 is. However, a table stored in the telephone directory storage section 7 of the communication terminal according to the present embodiment is different from the table stored in the telephone directory storage section 7 of the communication terminal according to Embodiment 1, and therefore will be fully described later.

The following explains how the communication terminal according to the present embodiment operates to make a call to the communication terminal with which the communication terminal communicates for the first time.

The known identifier is used for the communication with the communication terminal with which the communication terminal communicates for the first time. That is, as is the case with Embodiment 1, the communication terminal 10a sends, to the server 12, a calling message (pub-b, id-a) whose target address is the known identifier of the communication terminal 10b and which contains the terminal fingerprint of the communication terminal 10a. In accordance with the target address, the server 12 transfers the calling message to the communication terminal 10b. In response to the calling message, the communication terminal 10b sends, to the server 12, a response message (pub-a, id-b) whose target address is the known identifier of the communication terminal 10a and which contains the terminal fingerprint of the communication terminal 10b. In accordance with the target address, the server 12 transfers the response message to the communication terminal 10a. In this way, the communication terminals 10a and 10b exchange their terminal fingerprints with each other. Further, the terminal fingerprints are assigned uniquely to the communication terminals, respectively. Therefore, a communication terminal having received a terminal fingerprint of another communication terminal can reject a call in accordance with the terminal fingerprint. Further, the terminal fingerprint cannot be used for making a call. Therefore, even when the terminal fingerprint is transmitted to the unwanted person, the user never receives calls repeatedly from the unwanted person.

After the communication terminals have started to communicate with each other, the two communication terminals are caused by some trigger to exchange the hidden identifiers with each other. Examples of the trigger include such a condition that the communication has continued for a certain period. In case of an incorrect connection or a malicious call, the user is likely to terminate the communication immediately. Therefore, the trigger is not applicable in this case.

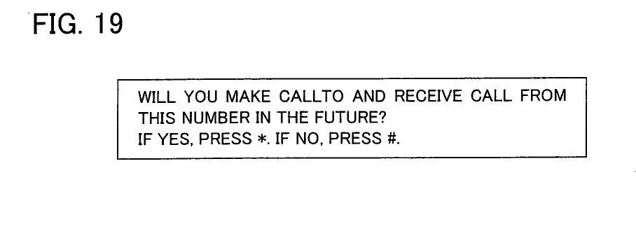

Here, the “certain period” refers to a period of time that is sufficient for the user to judge who calls to the user, and for the user to determine whether or not the user disconnect the communication. Normally, it is preferable that the period be set at approximately 30 seconds. Of course, the user may be allowed to change the length of time. Alternatively, the trigger may be a button operation of the user. Specifically, before sending and receiving the message containing the hidden identifier, a warning display and/or a warning sound are given by the input/output device 3 and/or a reproducing section (not shown), and a confirmation message shown in, e.g., FIG. 19 is displayed. In accordance with the display of the confirmation message, the user makes the decision by way of the button operation. It is preferable to arrange the communication terminal such that: certain timeout duration for the button operation is set at, e.g., approximately 40 seconds, and when no button operation is carried out within the timeout duration, it is judged that the connection is not permitted.

In some cases, it is preferable to adopt processes of exchanging the hidden identifiers of the communication terminals 10a and 10b after confirming that the communication terminals 10a and 10b would exchange packets with each other. This makes it possible to be free from such an unfairness that the communication terminal 10a sends the hidden identifier of the communication terminal 10a but the communication terminal 10b does not send the hidden identifier of the communication terminal 10b. Specifically, it is effective to use a protocol for step-by-step secret exchanging.

FIG. 20 shows a structure of the table stored in the telephone directory storage section 7 of the communication terminal according to the present embodiment. Compare FIG. 20 with FIG. 14. In FIG. 20, the third column of the table shown in FIG. 14 deals with a field for storing a terminal fingerprint, and a field for storing a hidden identifier is added in the fifth column.

The following explains a flow of a call-making process carried out by the communication terminal according to the present embodiment, with reference to FIG. 16.

The processes in S1, S3, and S4 in the present embodiment are the same as those in Embodiment 1, respectively. Carried out in S2 of the present embodiment are (i) the process of S2 of Embodiment 1 and (ii) a process of searching the fifth column of the table so as to analyze the hidden identifier recsec2. Carried out in S5 of the present embodiment are (i) the process of S5 of Embodiment 1 and (ii) a process of searching the fifth column of the table so as to analyze the hidden identifier recsec2. Note that the “recsec” of the third column represents the terminal fingerprint. Carried out in the process of S6 of the present embodiment is a “process of making a call using the hidden identifier (recsec2)”, instead of the process of S6 of Embodiment 1, i.e., instead of the “process of making a call using the hidden identifier (recsec)”.

The processes in S7 and S9 through S14 in the present embodiment are the same as those in Embodiment 1, respectively. In S8, the calling message containing the terminal fingerprint of the calling communication terminal is generated.

In S15, a process of recording the terminal finger print onto the third column of the table is carried out instead of the process of S15 of Embodiment 1, i.e., instead of the process of recording the hidden identifier onto the third column of the table. In addition to the process, a process of setting a null character string in the fifth column of the table is carried out.

In the following, a flow of a call-receiving process carried out by the communication terminal according to the present embodiment will be described with reference to FIG. 17.

The processes in S21, S23, and S24 of the present embodiment are the same as those in Embodiment 1, respectively.

In S22, the terminal fingerprint is set in the variable sec, instead of the “hidden identifier” set therein in Embodiment 1.

Carried out in S25 are (i) the process of S25 of Embodiment 1, and (ii) a process of setting a null character string in the fifth column of the table. Note that the hidden identifier is finally set in the fifth column of the table after exchanging the packets (see FIG. 18) containing the hidden identifiers.

The processes in S26 through S34 are the same as those in Embodiment 1.

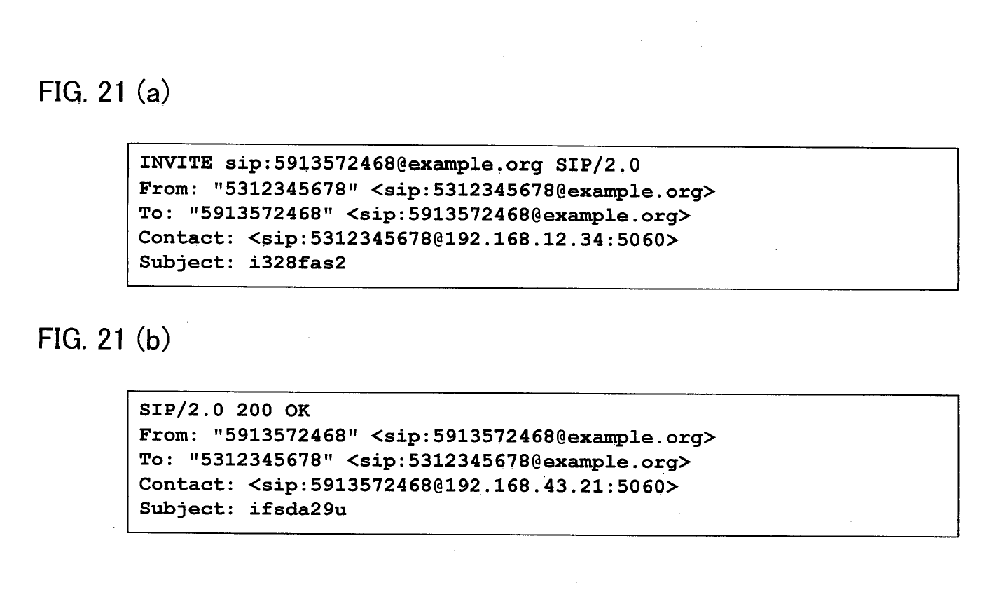

FIG. 21(a) shows an example of a message contained in the packet used in the connection using the known identifier. FIG. 21(b) shows an example of a message contained in the packet to be sent in response to the packet used in the connection using the known identifier. FIG. 21(a) is a diagram showing an example of the calling message which is generated by the communication terminal of the sending end, and which contains (i) the terminal fingerprint of the communication terminal of the sending end and (ii) the known identifier of the communication terminal of the receiving end. FIG. 21(b) is a diagram showing an example of the response message which is generated by the communication terminal of the receiving end and which contains (i) the terminal fingerprint of the communication terminal of the receiving end and (ii) the known identifier of the transmitting communication terminal. Compare FIGS. 21(a) and 21(b) with FIGS. 13(a) and 13(b). In FIGS. 21(a) and 21(b), “Subject” indicating the terminal fingerprint is provided instead of “In-Reply-To” (see FIGS. 13(a) and 13(b)) indicating the hidden identifier. Further, when the packets respectively containing the hidden identifiers are exchanged, a connection request message and a response message similar to those shown in FIGS. 13(a) and 13(b) are used.

Further, in order to prevent leakage of the hidden identifiers, whether or not the hidden identifier exchange is to be carried out may be determined in accordance with the category number of the known identifier of the receiving end communication terminal with which the communication terminal of the sending end communicate. The determination is carried out when the communication is carried out for the first time. For example, no hidden identifier exchange is carried out when the communication terminal communicates with communication terminals having known identifiers each of whose category number is, e.g., 3 or 4 corresponding to the service available for the unspecified people.

As described above, the present embodiment makes it possible to more effectively solve the foregoing Problem (2) as compared with Embodiment 1: when the telephone number is revealed to an unwanted person, the user may receive a call from the unwanted person.

### Embodiment 3

Basically, the present invention assumes that: the communication terminals are properly manufactured; and no improper operations are carried out. However, there may be a user who improperly alters his/her own communication terminal so as to leak, to others, a hidden identifier received by the improperly altered communication terminal. Accordingly, the present embodiment introduces a mechanism for checking which communication terminal has leaked the hidden identifier.

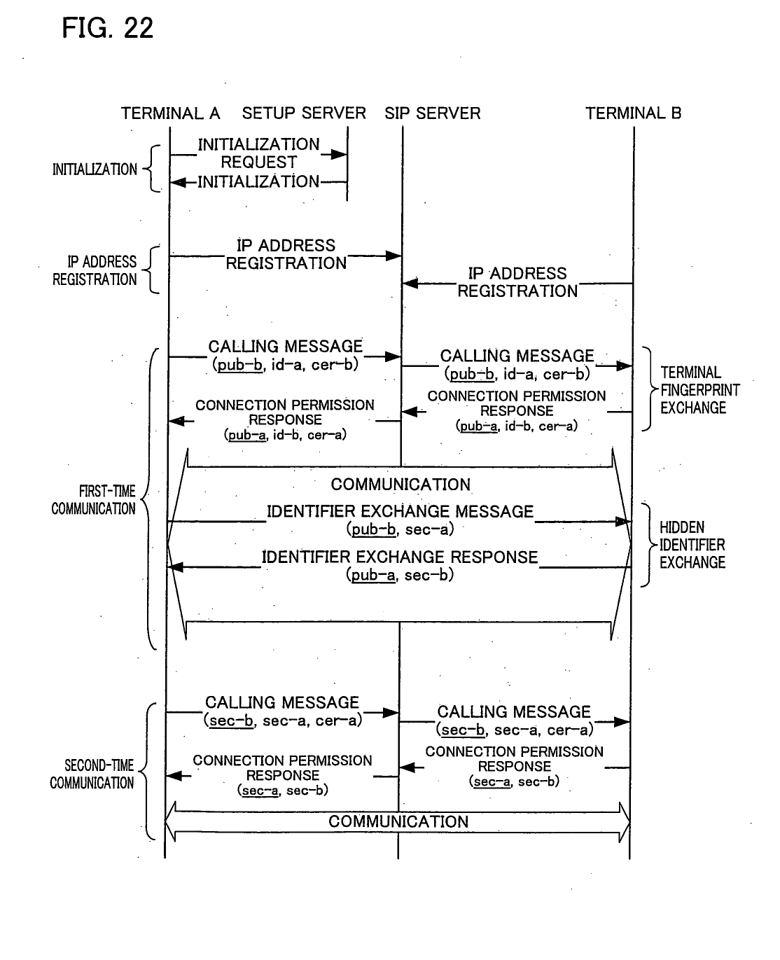

FIG. 22 is a diagram showing communication carried out in cases where such a checking mechanism is introduced. This is similar to the case of Embodiment 2 shown in FIG. 18. However, when communication is carried out for the first time by using a known identifier, Terminal A sends a calling message to which a certificate identifier (cer-b) is added, and Terminal B sends a connection permission response to which a certificate identifier (cer-a is added. The certificate identifier (cer-b) is generated by Terminal A exclusively for Terminal B, and the certificate identifier (cer-a) is generated by Terminal B exclusively for Terminal A. Terminal A (Terminal B) uses the certificate identifier (cer-b) (the certificate identifier (cer-a)) only for authenticating Terminal B (Terminal A), and does not use it for designating Terminal B (Terminal A). Therefore, different users may have the same certificate identifier. Further, when communication is carried out for a second or later time, the certificate identifier serves as a kind of password. That is, when a called communication terminal receives a call, made by using its hidden identifier, from a calling communication terminal which has the hidden identifier of the called communication terminal, the called communication terminal requests the calling communication terminal to present the certificate identifier as a kind of password.

The following explanation is made using the communication terminals 10a and 10b. When the communication terminal 10a communicates with the communication terminal 10b for the first time, the first data generating section 46 of the communication terminal 10a generates the certificate identifier (cer-b) assigned exclusively to the communication terminal 10b. The communication terminal 10b associates the certificate identifier, sent from the communication terminal 10a, with information for specifying the communication terminal 10a and the hidden identifier of the communication terminal 10a, and records the certificate identifier in the table of the telephone directory storage section 7 of the communication terminal 10b. The certificate identifier is recorded as a presentation certificate identifier to be presented when connecting with the communication terminal 10a for the second or later time by using the hidden identifier

On the other hand, when the communication terminal 10b communicates with the communication terminal 10a for the first time, the first data generating section 46 of the communication terminal 10b generates the certificate identifier (cer-a) assigned exclusively to the communication terminal 10a. With this, the communication terminals 10a and 10b can exchange with each other the certificate identifiers. Note that one certificate identifier is generated by the communication terminal 10a exclusively for the communication terminal 10b and is not used for other communication terminals, and another certificate identifier is generated by the communication terminal 10b exclusively for the communication terminal 10a and is not used for other communication terminals. This point will be fully described below.

FIG. 24 is a diagram showing a structure of the table of the telephone directory storage section 7 used in the present embodiment. For example, when the communication terminal (e.g., the communication terminal 10b shown in FIG. 5) storing the table of FIG. 24 connects for the first time with the communication terminal 10a used by Taro Yamada, the communication terminal 10b generates a certificate identifier exclusively for the communication terminal 10a, add the certificate identifier to a message, and send the message to the communication terminal 10a. Then, the communication terminal 10a used by Taro Yamada receives the certificate identifier, and stores the certificate identifier as a presentation certificate identifier (c9jd09j5) corresponding to the communication terminal 10b. Further, the communication terminal 10b records, as an expectation certificate identifier, a certificate identifier identical to the certificate identifier corresponding to the communication terminal 10a used by Taro Yamada. Therefore, when the communication terminal 10b receives a message from the communication terminal 10a in communication of the second or later time, the communication terminal 10b can expect that the message always contains the expectation certificate identifier (c9jd09j5).

Further, a presentation certificate identifier (c87ue903) generated exclusively for the communication terminal 10b by the communication terminal 10a is added to a message sent from the communication terminal 10b to the communication terminal 10a used by Taro Yamada. The presentation certificate identifier (c87ue903) is associated with the communication terminal 10a used by Taro Yamada, and is recorded in the table of the communication terminal 10b. Thus, the expectation certificate identifier (c9jd09j5) and the presentation certificate identifier (c87ue903), each of which is generated exclusively for the communication terminal 10a used by Taro Yamada and is not used for the other communication terminals, are associated with the display name, known identifier, terminal fingerprint, reply permission/prohibition information, and hidden identifier of the communication terminal 10a, and are recorded in the table.

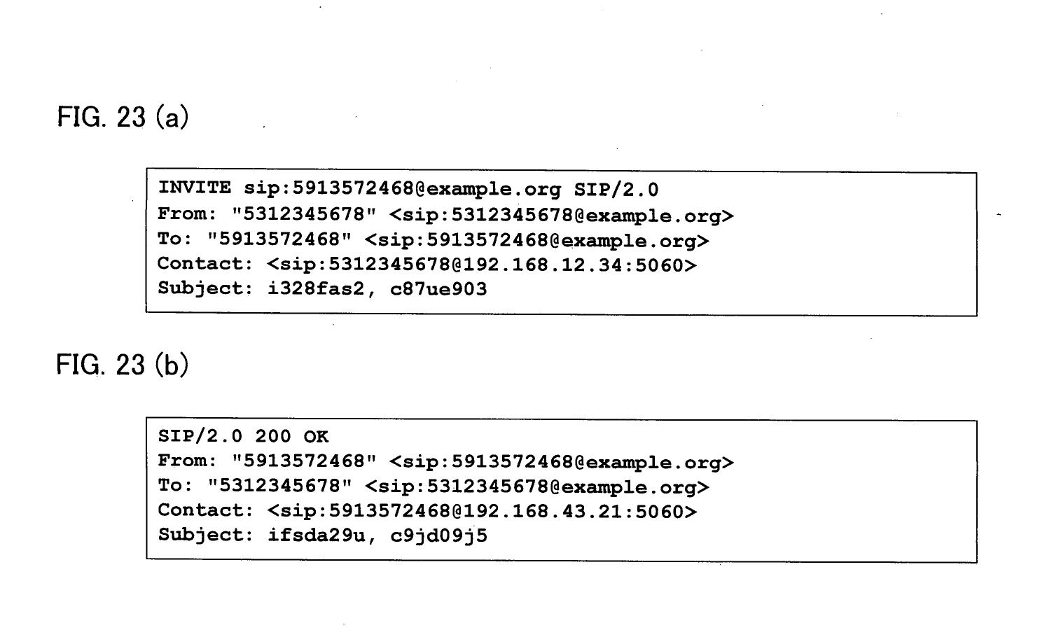

FIG. 23(a) shows a calling message using a known identifier, and FIG. 23(b) shows a response message corresponding to the calling message of FIG. 23(a). It is assumed that the calling message of FIG. 23(a) is sent from the communication terminal 10a of Taro Yamada to the communication terminal 10b. In this case, “Subject” contains (i) a terminal fingerprint (i328fas2) of the communication terminal 10a used by Taro Yamada and (ii) the certificate identifier (c87ue903) to be transmitted to the communication terminal 10b.

From a standpoint of the communication terminal 10a used by Taro Yamada, the certificate identifier (c87ue903) to be transmitted from the communication terminal 10a to the communication terminal 10b is an expectation certificate identifier which is uniquely associated with the communication terminal 10b. On the other hand, from a standpoint of the communication terminal 10b, as shown in the table of FIG. 24, the certificate identifier (c87ue903) is a presentation certificate identifier which is uniquely associated with the communication terminal 10a used by Taro Yamada.

Further, “Subject” of the response message of FIG. 23(b) contains (i) a terminal fingerprint (ifsda29u) of the communication terminal 10b and (ii) the expectation certificate identifier (c9jd09j5) which is uniquely associated with the communication terminal 10a of Taro Yamada by the communication terminal 10b.

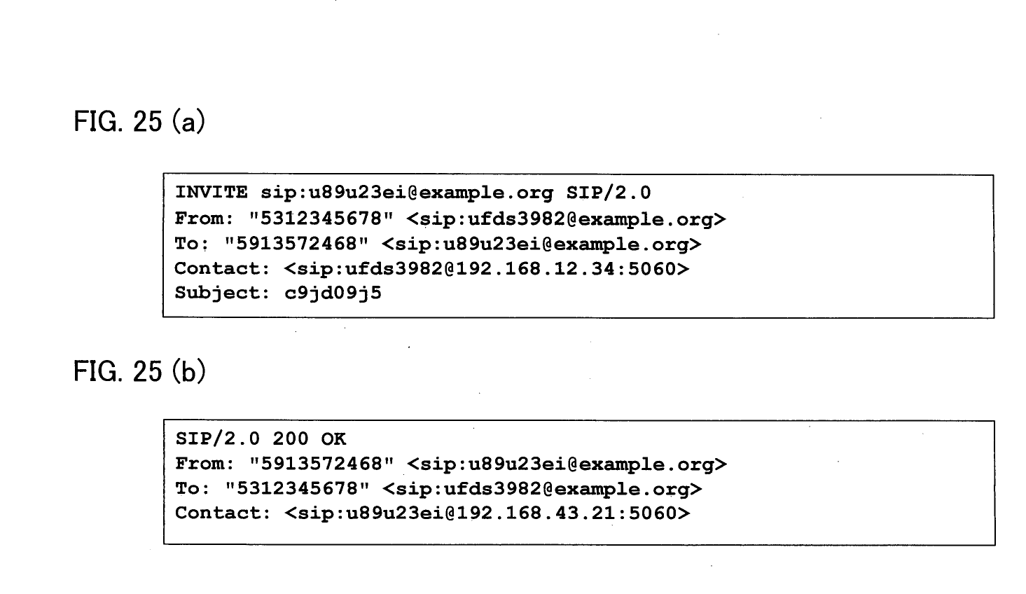

On the other hand, when the communication terminal 10a used by Taro Yamada communicates with the communication terminal 10b for the second or later time, the first data generating section 46 of the communication terminal 10a generates a message to which the certificate identifier (c9jd09j5) has been added, and the communication terminal 10a sends the message to the communication terminal 10b. Note that the certificate identifier (c9jd09j5) has previously been generated by the communication terminal 10b, and sent from the communication terminal 10b to the communication terminal 10a. That is, from a standpoint of the communication terminal 10a, the certificate identifier (c9jd09j5) is the presentation certificate identifier which is generated exclusively for the communication terminal 10a by the communication terminal 10b. In other words, from a standpoint of the communication terminal 10b, the certificate identifier (c9jd09j5) is the expectation certificate identifier. The connection permission response does not have to contain the certificate identifier. FIG. 25(a) shows a calling message using a hidden identifier, and FIG. 25(b) shows a response message corresponding to the calling message of FIG. 25(a). “Subject” of the calling message (FIG. 25(a)) transmitted by the communication terminal 10a used by Taro Yamada indicates the certificate identifier (c9jd09j5) which has previously been sent from the communication terminal 10b.

The called communication terminal judges whether or not the certificate identifier presented by the calling communication terminal corresponds to the expectation certificate identifier registered in the telephone directory of the called communication terminal, so as to judge whether or not the message from the calling communication terminal is a proper incoming message.

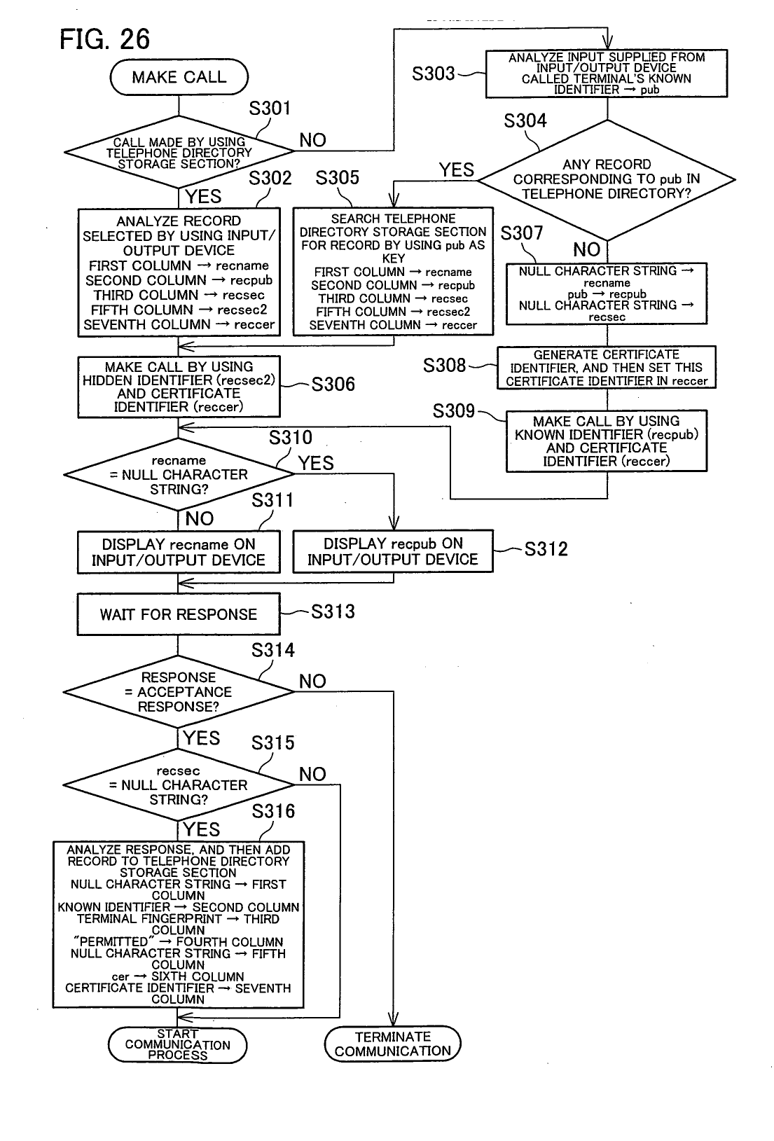

FIG. 26 is a flow chart showing a call-making process according to the present embodiment. The following explains only matters different from FIG. 16. In S302 and S305 each of which is a step carried out when the outgoing call is made for the second or later time, in order to be ready for making the outgoing call (S306) using the hidden identifier, the calling communication terminal (i) takes out from the presentation certificate identifier of the telephone directory the certificate identifier previously received from the called communication terminal, and (ii) sets the certificate identifier in the “reccer”. Meanwhile, in S308 which is a step carried out when the outgoing call is made for the first time, the first data generating section 46 of the calling communication terminal generates a certificate identifier, and the calling communication terminal makes the outgoing call containing this certificate identifier (S309). Further, when the writing control section 51 of the calling communication terminal carries out an addition to the telephone directory storage section 7, (i) the certificate identifier “cer” generated by the calling communication terminal and (ii) the certificate identifier sent from the called communication terminal are stored in the sixth and seventh columns of the table of FIG. 24, respectively.

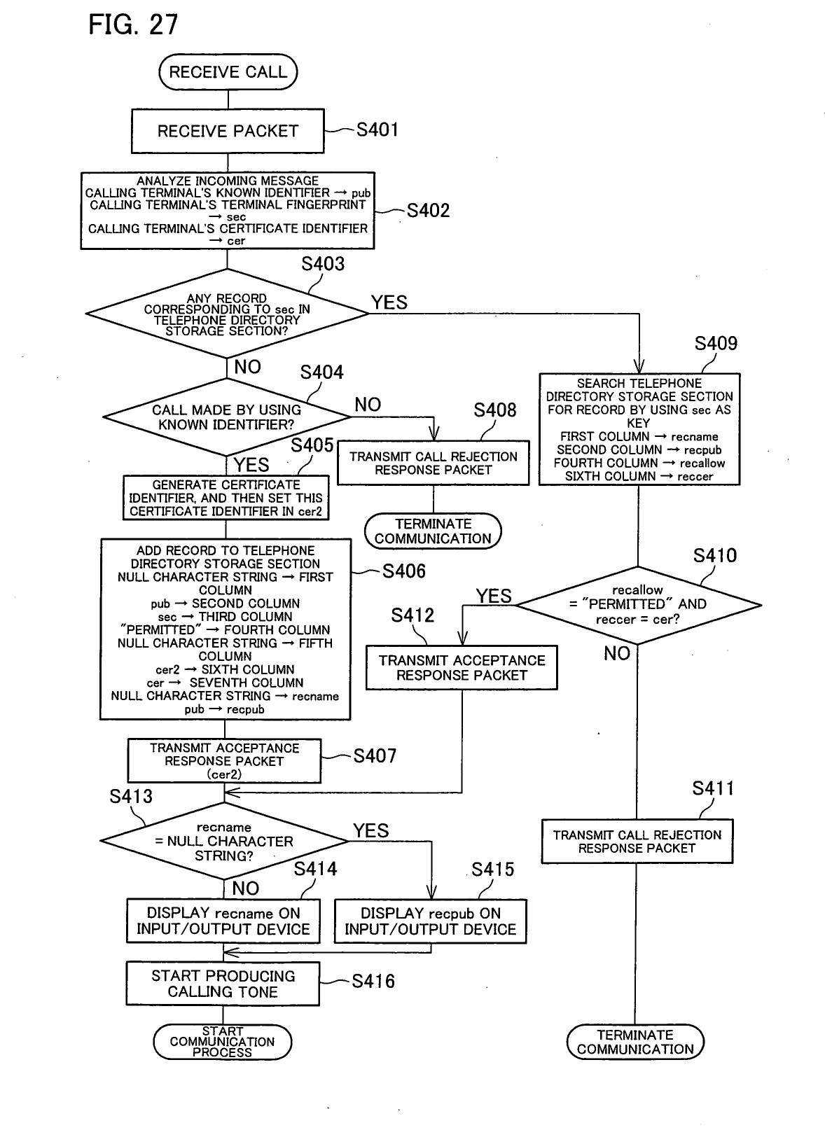

FIG. 27 is a flow chart showing a call-receiving process. First, the extraction section 49 of the called communication terminal analyzes an incoming message, and sets the certificate identifier, transmitted from the calling communication terminal, in the “cer”. When the incoming call is made by using the known identifier, the “cer” is expected to be the certificate identifier generated by the calling communication terminal. When the incoming call is made by using the hidden identifier, the “cer” is expected to be the certificate identifier which has previously been generated by the called communication terminal and has been transmitted to the calling communication terminal. In the case of the incoming call of the first time, the first data generating section 46 of the called communication terminal generates a certificate identifier and set this certificate identifier in the “cer2”, and the writing control section 51 of the called communication terminal stores, in the sixth and seventh columns of the table stored in the telephone directory storage section 7, (i) the “cer2” and (ii) the certificate identifier presented by the calling communication terminal, respectively (S406). Further, the called communication terminal sends a response containing the certificate identifier generated by the called communication terminal (S407). On the other hand, when carrying out communication for the second or later time, the searching section 50 takes out the expectation certificate identifier from the telephone directory storage section 7 (S409), and the reply permission/prohibition judgment section 52 judges whether or not the expectation certificate identifier is identical to the certificate identifier presented by the calling communication terminal (S410). The response transmitted in S412 does not contain the certificate identifier.

In the present embodiment, the hidden identifier is invalid unless the certificate identifier is presented. Therefore, no problem occurs even if the hidden identifier is leaked. Further, even if the hidden identifier and the certificate identifier corresponding to this hidden identifier are leaked, it is possible to find out, by referring to the telephone directory storage section 7, from which communication terminal the hidden identifier and the certificate identifier has been leaked. This makes it possible to work out a countermeasure for preventing such a leakage.

The present embodiment has shown the following arrangement: That is, when the communication terminal 10a communicates with the communication terminal 10b for the first time, the communication terminal 10a generates a certificate identifier and transmits the certificate identifier to the communication terminal 10b; and when the communication terminal 10a communicates with the communication terminal 10b for the second or later time, the communication terminal 10b presents the certificate identifier to the communication terminal 10a. However, the present embodiment is not limited to this. That is, the present embodiment may include the following arrangement: When the communication terminal 10a communicates with the communication terminal 10b for the first time, the communication terminal 10a generates a certificate identifier and transmits the certificate identifier to the communication terminal 10b; and when the communication terminal 10a communicates with the communication terminal 10b for the second or later time, the communication terminal 10a again presents the certificate identifier to the communication terminal 10b. However, in this case, the communication terminal 10b needs to authenticate the communication terminal 10a on the basis of the certificate identifier generated arbitrarily by the communication terminal 10a. Therefore, this arrangement is lower in security level.

### Embodiment 4

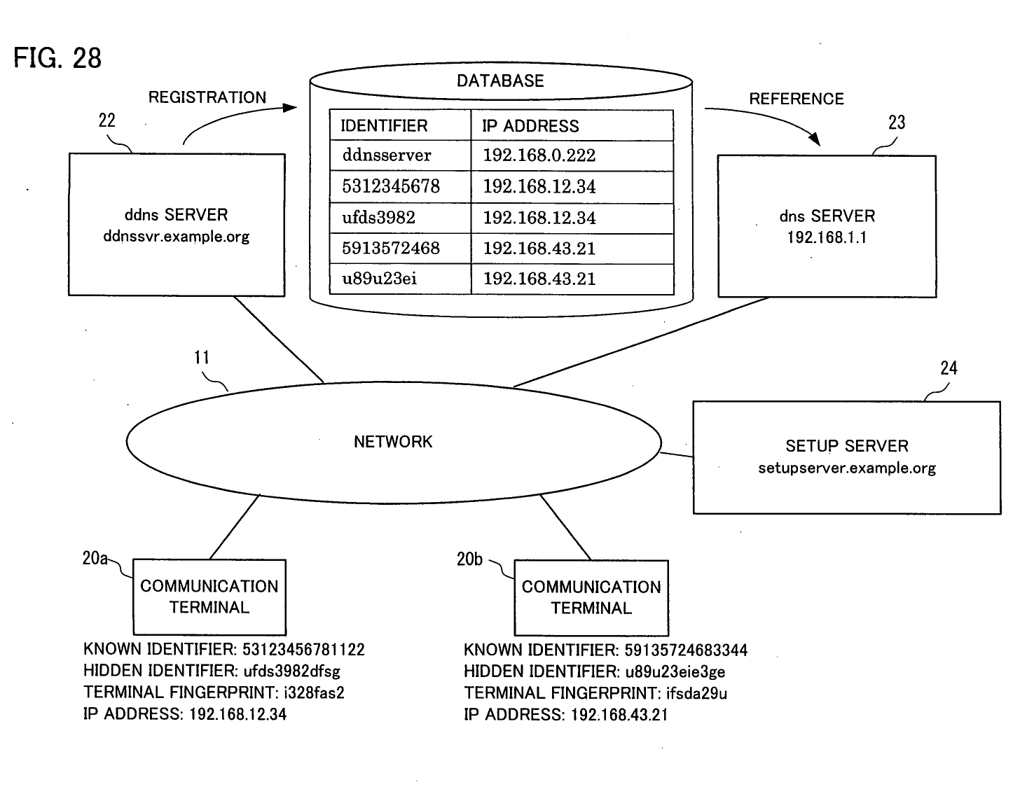

Each of Embodiments 1 to 3 adopts a system arrangement in which an SIP server relays a message. Embodiment 4 explains a method for realizing, by using DDNS, a system having the same function as the above system arrangement. The following will explain a communication system of the present embodiment in reference to FIG. 28. Note that Embodiment 4 is basically the same as Embodiment 3, so that explanations of the same operations are omitted here.

The present communication system includes a communication terminal 20a, a communication terminal 20b, a network 11, a DDNS registration server 22, a DNS server 23, and a setup server 24. Each of the communication terminals 20a and 20b has the same arrangement as the communication terminal 10 thus far described. The communication terminal associates the IP address, assigned to this communication terminal, with the known identifier or hidden identifier of this communication terminal, and registers in the DDNS server 22 the IP address and the known identifier or the hidden identifier. The information registered in the DDNS registration server 22 is sent to the DNS server 23 without delay.

With this arrangement, one communication terminal can obtain the IP address of the other communication terminal by inquiring of the DNS server 23 using the known identifier or hidden identifier of the above-described other communication terminal. Accordingly, the above-described one communication terminal can send a message to the above-described other communication terminal without using the SIP server.

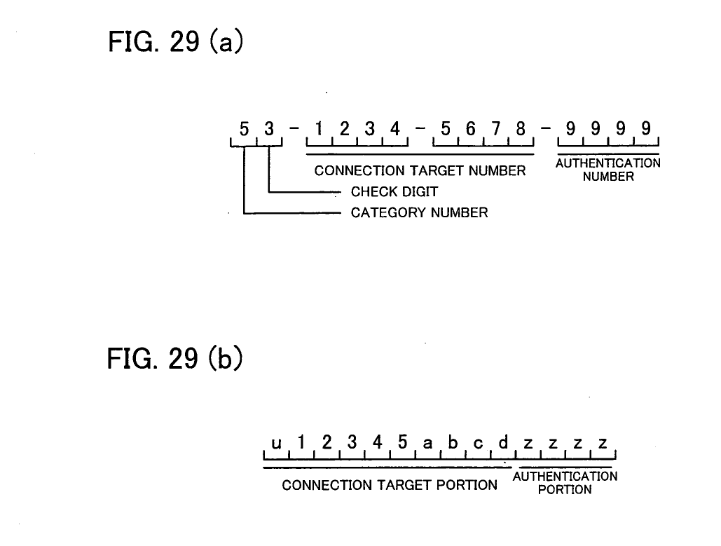

FIG. 29(a) shows a structure of the known identifier used in the present embodiment, and FIG. 29(b) shows a structure of the hidden identifier used in the present embodiment. The known identifier shown in FIG. 29(a) is obtained by adding a four-digit authentication number to the known identifier shown in FIG. 2. Note that the authentication number is not checked by the check digit. Similarly, a four-digit authentication portion is added to the hidden identifier shown in FIG. 29(b).

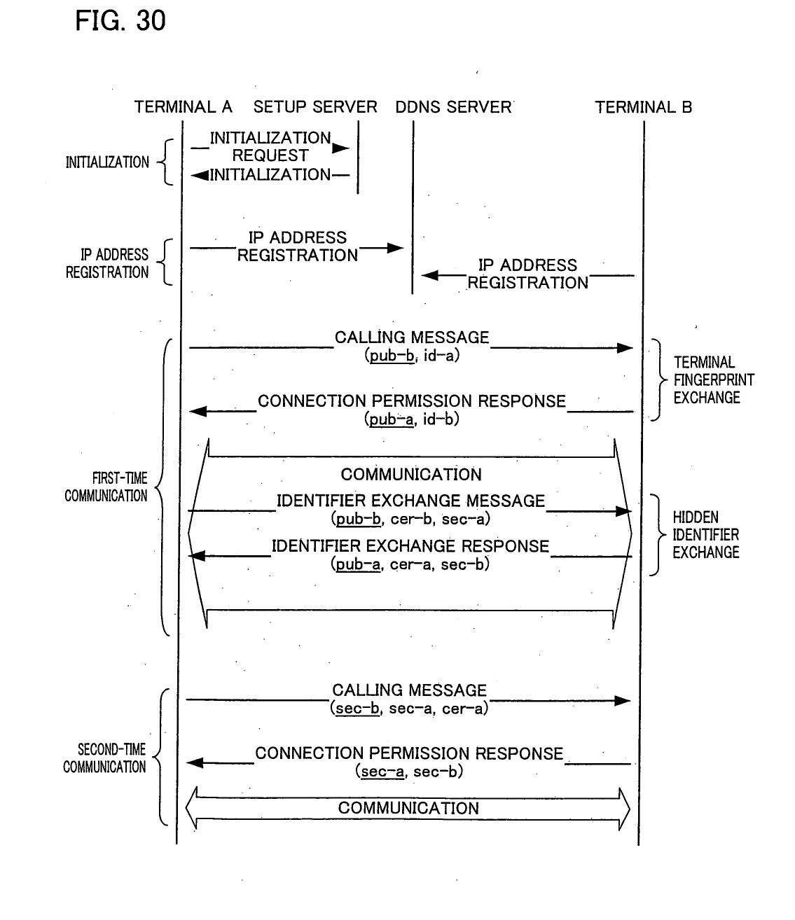

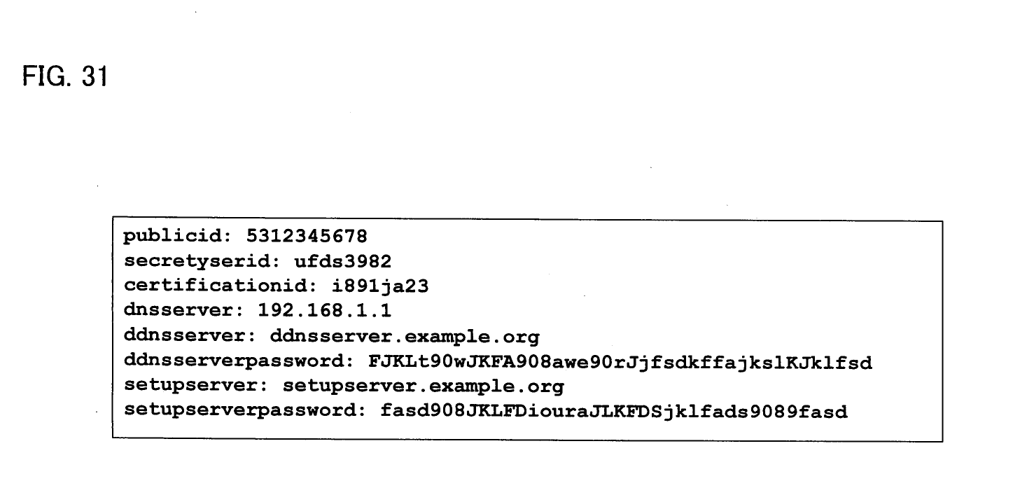

FIG. 30 is a diagram showing communication carried out in the present embodiment. The communication of the present embodiment is substantially the same as the communication shown in FIG. 22 of Embodiment 3 except that, in the present embodiment, the message is transmitted using the DNS server and without using the SIP server. At the time of initialization, information shown in FIG. 31 is transmitted from the setup server to Terminal A. This information is similar to the initialization information shown in FIG. 11. However, (i) a terminal fingerprint (certificationid) is added to the information shown in FIG. 31, and (ii) instead of the information (sipserver, sipserverpassword) about the SIP server, information about the DNS server and information about the DDNS registration server are added to the information shown in FIG. 31. The “dnsserver” designates the DNS server to which a DNS query is sent. The “ddnsserver” designates the DDNS registration server. The “ddnsserverpassword” is a password used at the time of DDNS registration.

On completion of the initialization, the communication terminal 20a registers in the DDNS registration server 22 the correspondence between the identifiers and IP address of the communication terminal 20a, and the communication terminal 20b registers in the DDNS registration server 22 the correspondence between the identifiers and IP address of the communication terminal 20b. On completion of the DDNS registration, for example, the communication terminal 20a can obtain the IP address “192.168.43.21” of the communication terminal 20b by inquiring of the DNS server 23 about “5913572468.example.org.” or “u89u23ei.example.org”. As described above, the authentication number and the authentication portion are not used for inquiring of the DNS server 23.

Further, in general, the DNS server is designed to process, at a very high speed, the inquiry sent to the DNS server. However, this feature can be abused. That is, a list of valid known identifiers can be made by inquiring of the DNS server while changing the known identifier portion and/or hidden identifier portion, e.g., while increasing “xxxxxxxxxx” of “xxxxxxxxxx.example.org.” from “0000000000” to “9999999999” by 1. As a countermeasure against such an abuse, the present embodiment introduces the authentication number shown in FIG. 29(a) and the authentication portion shown in FIG. 29(b).

The authentication number and the authentication portion are not used for inquiring of the DNS server 23. However, when one communication terminal makes a call to the other communication terminal, the calling communication terminal sends to the called communication terminal a message containing an authentication number and authentication portion of the calling communication terminal. The called communication terminal unconditionally rejects the incoming call when the authentication number and authentication portion contained in the message do not match the authentication number and authentication portion assigned to the called communication terminal by the setup server at the time of initialization. Further, in cases where the message containing the unmatched authentication number and authentication portion is repeatedly sent from the same calling communication terminal several times, e.g., in cases where such a message is sent three times every ten seconds, the called communication terminal may be set so as to reject the incoming call from this calling communication terminal thereafter. Thus, using the authentication number and the authentication portion, the called communication terminal judges, after the call is made actually, whether to permit this incoming call. Therefore, the foregoing problem can be solved by introducing the authentication number and the authentication portion.

Furthermore, a plurality of valid authentication numbers may be assigned to the communication terminal, and the communication terminal may be set so as to change the calling tone, the calling message, and the like depending on the authentication numbers. For example, the communication terminal may be configured such that (i) in the case of the authentication number “0102”, Melody A is used as the calling tone, (ii) in the case of the authentication number “1023”, Melody B is used as the calling tone, and (iii) in the case of the authentication number other than the authentication numbers “0102” and “1023”, the incoming call is rejected. Similarly, the communication terminal may be configured such that (i) in the case of the authentication number “0102”, a message for calling User A is displayed and (ii) in the case of the authentication number “1023”, a message for calling User B is displayed. Such a configuration allows family members to share a single communication terminal.

Similarly, the called communication terminal may be configured so as to unconditionally reject the incoming call when the known identifier contained in the message sent from the calling communication terminal does not match the known identifier assigned to the called communication terminal by the setup server at the time of initialization. According to this configuration, even in cases where the known identifier of the called communication terminal has been changed, the called communication terminal rejects the incoming call made by using the old known identifier. Therefore, it is unnecessary to unregister the information registered in the DNS server. This brings about such an advantage that a DDNS registration server having a registering function but not having an unregistering function can be utilized.

The information contained in the message generated when communication is carried out for the first time and the information contained in the message generated when communication is carried out for the second time are the same as those shown in FIG. 22. However, because of the arrangement of the message format, the terminal fingerprints are exchanged not by using (i) the calling message generated when communication is carried out for the first time or (ii) the response message generated in response to the calling message, but by using (a) the identifier exchange message generated when communication is carried out for the first time and (b) the response message generated in response to the identifier exchange message. In addition, since these messages shown in FIG. 30 are directly transmitted and received without using the SIP server, they are different from the messages shown in FIG. 22.

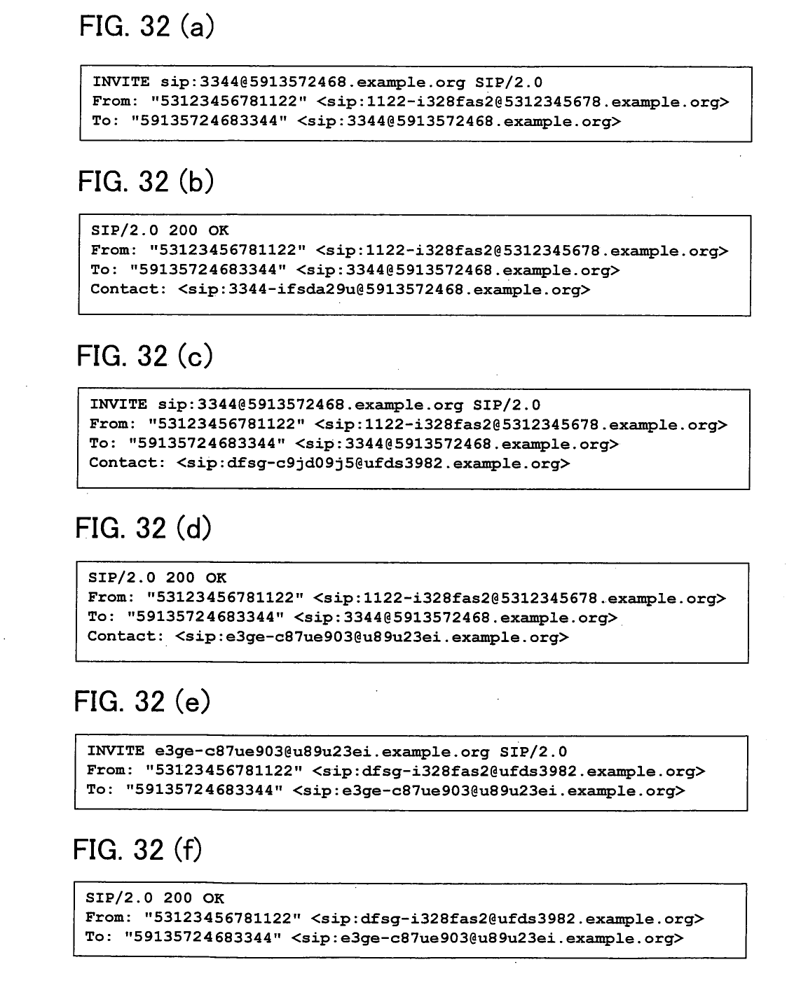

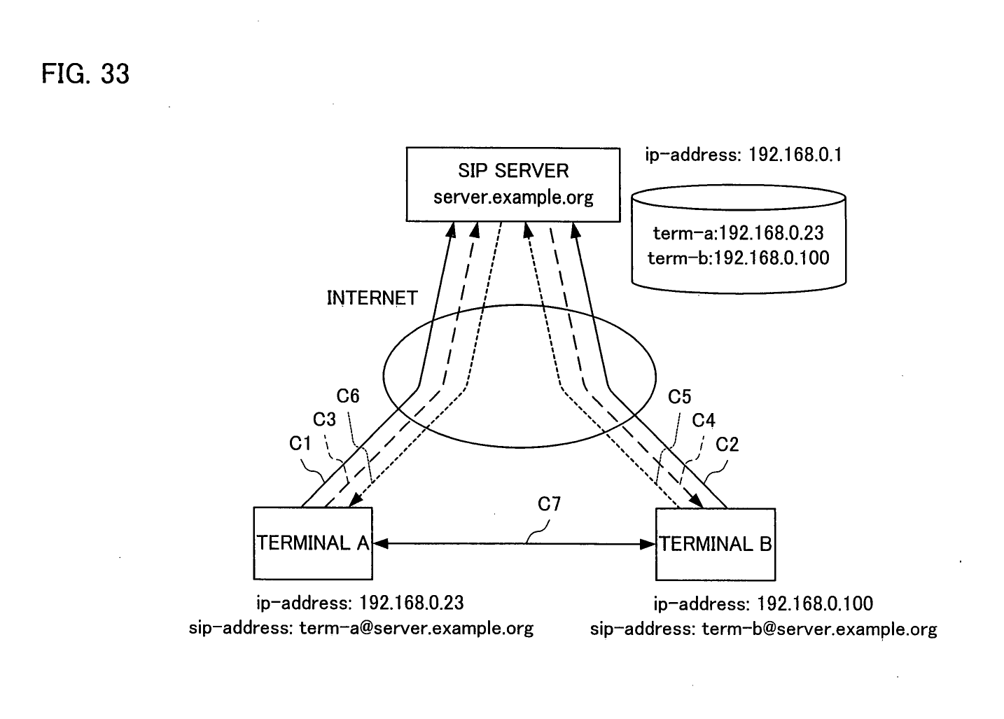

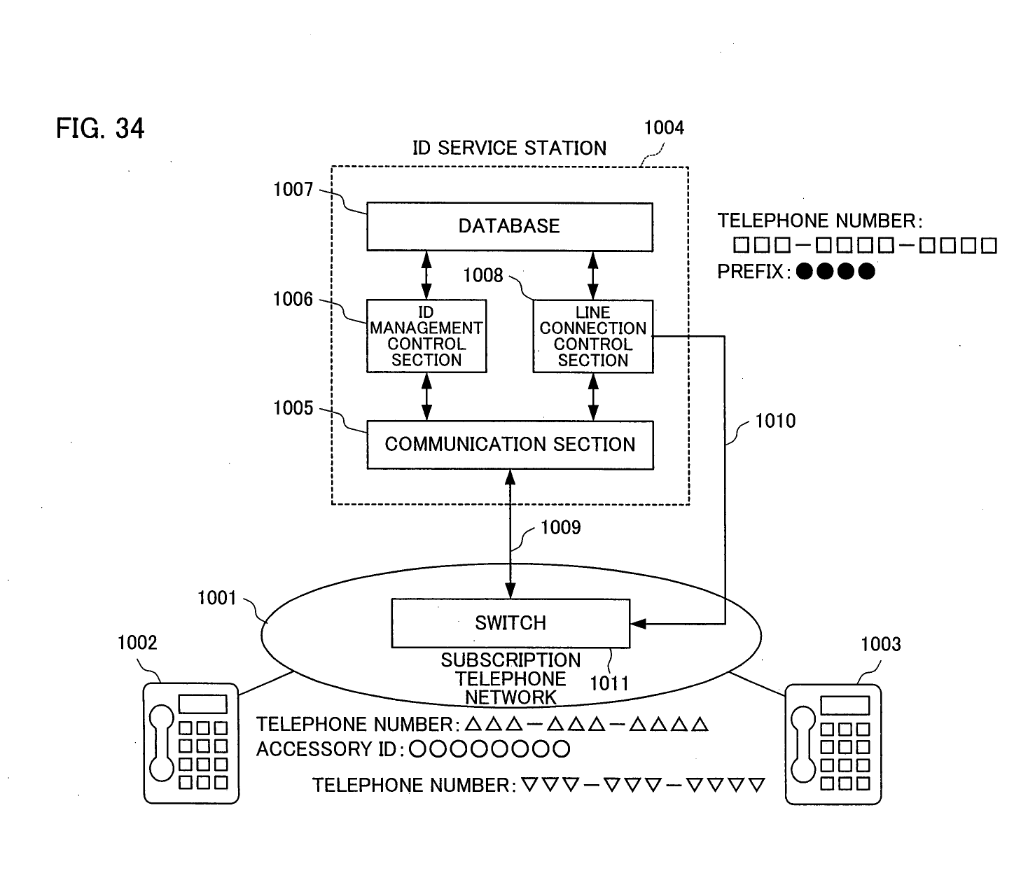

FIGS. 32(a), 32(b), 32(c), 32(d), 32(e), and 32(f) respectively show (i) a calling message generated when communication is carried out for the first time, (ii) a connection permission response, (iii) an identifier exchange message, (iv) an identifier exchange response, (v) a calling message generated when communication is carried out for the second time, and (vi) a connection permission response. The present embodiment shows an example in which “Subject” and “In-Reply-To” each of which is rarely used as a tag of an SIP message are not used. These figures clearly show that (i) each of the known identifier and the hidden identifier each of which is converted into the IP address by inquiring of the DNS server is stored after the at mark, and (ii) each of the authentication number, the authentication portion, the terminal fingerprint, and the certificate identifier is stored before the at mark and stored using a hyphen.

### Embodiment 5

Each of Embodiments 1 to 4 has explained a case where two terminals which communicate with each other have the same functions. Embodiment 5 is different from Embodiments 1 to 4, and explains an arrangement in which Terminal A has only a call-making function whereas Terminal B has only a call-receiving function. That is, Embodiment 5 explains an arrangement in which Terminal A can call Terminal B whereas Terminal B cannot call Terminal A. Note that Embodiment 5 has the same object as Embodiments 1 to Embodiment 4, that is, the object of Embodiment 5 is to solve the problems of the existing telephone number by using the combination of the known identifier and the hidden identifier.

The following will explain Embodiment 5 in detail. In Embodiment 5, matters already explained in Embodiments 1 to 4 will not be explained again.

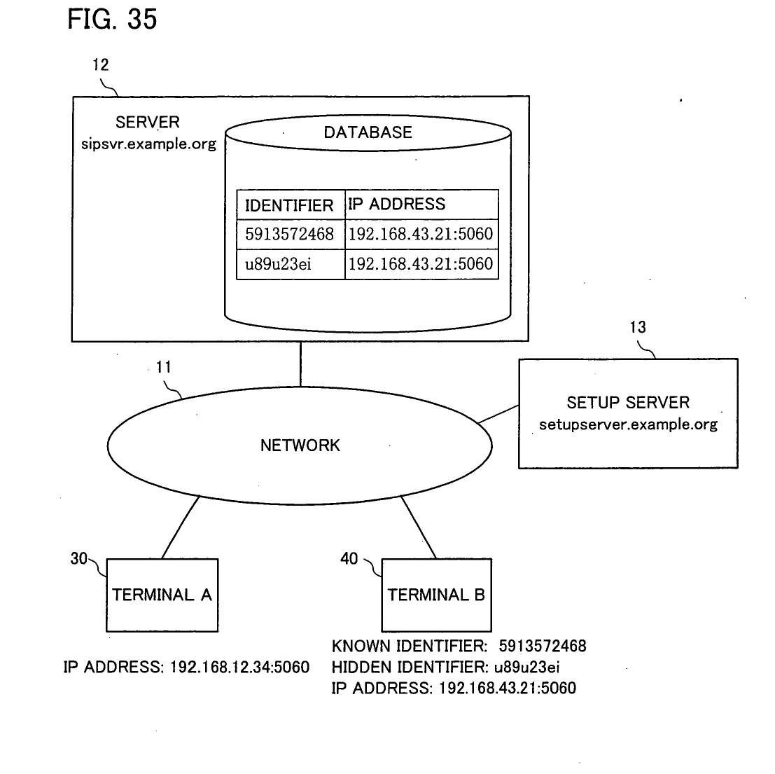

FIG. 35 is a diagram showing the entire arrangement of a system in Embodiment 5. According to the arrangement shown in FIG. 35, Terminal A does not have the call-receiving function, so that Terminal A does not have the known identifier or the hidden identifier. Only the IP address necessary for communication is assigned to Terminal A. Meanwhile, as with Terminal B explained in Embodiment 1, Terminal B here has the known identifier, the hidden identifier, and the IP address, and these pieces of information are registered in an SIP server 12. The present embodiment explains an example in which the transmission and reception of image data are carried out between Terminal A and Terminal B.

Terminal A has a function of (i) calling the other terminal, (ii) obtaining an image stored in the above-described other terminal, and (iii) displaying the image on a screen of Terminal A. Meanwhile, Terminal B has a function of (i) receiving a call from the other terminal and (ii) transmitting an image to the above-described other terminal. Terminal A needs to be operated by a user, but Terminal B does not have to be operated by a user, and may be a kind of server which automatically responds.

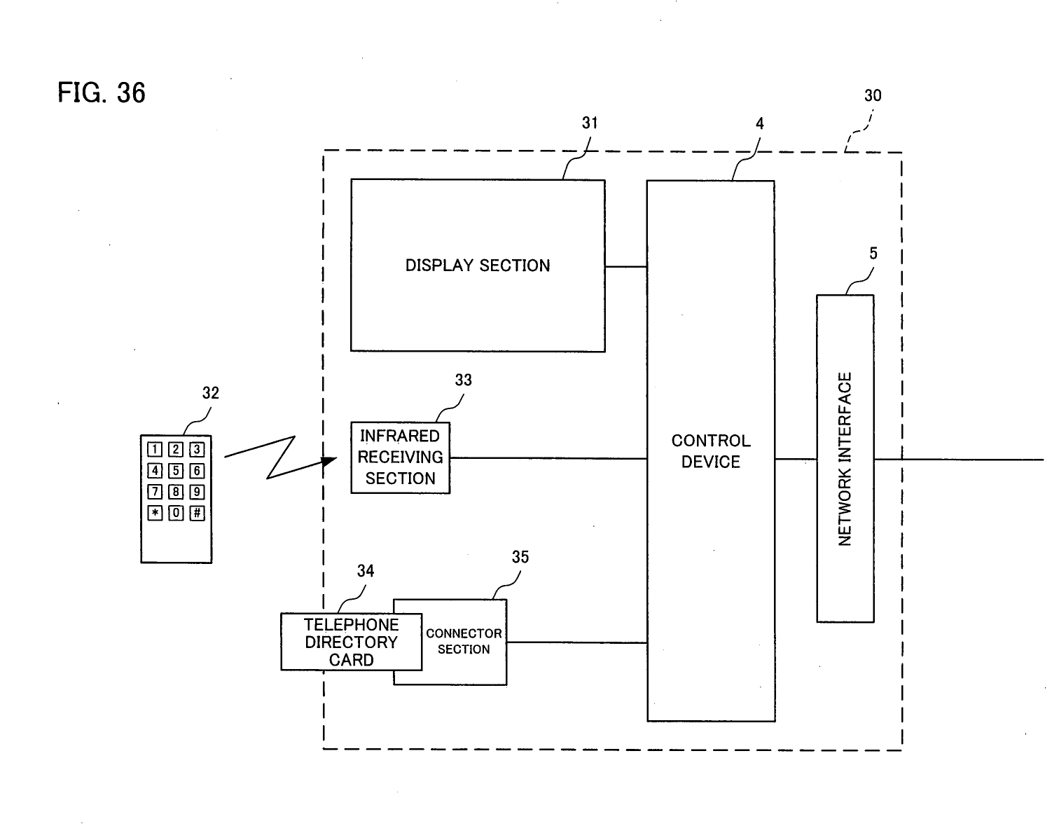

FIG. 36 is a diagram showing an arrangement of Terminal A. Terminal A includes a display section 31, and the display section 31 can display an image represented by image data obtained from the other terminal. The display section 31 may have, according to need, a function(s) other than the function of displaying images. For example, the display section 31 may have a function of decoding JPEG images. Moreover, the display section 31 also functions as the screen of the input/output device 3 shown in FIG. 6.

Moreover, the display section 31 does not have to be included in Terminal A integrally. For example, the display section 31 may be an external display device, such as a TV receiver. Further, the display section 31 may have a function of displaying an image represented by an image signal output from image generating means (not shown) (for example, a TV tuner) built into Terminal A.

An infrared remote controller 32 and an infrared receiving section 33 correspond to the keyboard of the input/output device 3 shown in FIG. 6, and accepts an input operation carried out by a user. In the present embodiment, Terminal A accepts the input operation through the infrared remote controller 32. However, the present embodiment is not limited to this. Terminal A may accept the input operation through a remote controller using a fixed line or a radio wave.

A telephone directory card 34 is a detachable version of the telephone directory storage section 7 shown in FIG. 6, and is attached to Terminal A via a connector section 35.

Note that Terminal A may be configured by integrating the display section 31, the infrared receiving section 33, the connector section 35, etc. into a TV receiver.

As described in Embodiment 1, it is preferable that communication between terminals via a network be carried out by encrypting data. Therefore, the network interface 5 may have a function of encrypting data by, for example, IPsec (Security Architecture for Internet Protocol) or SSL (Secure Socket Layer) which are widely used in the Internet. With this encryption function, it is possible to prevent users from viewing communication packets and finding various identifiers.

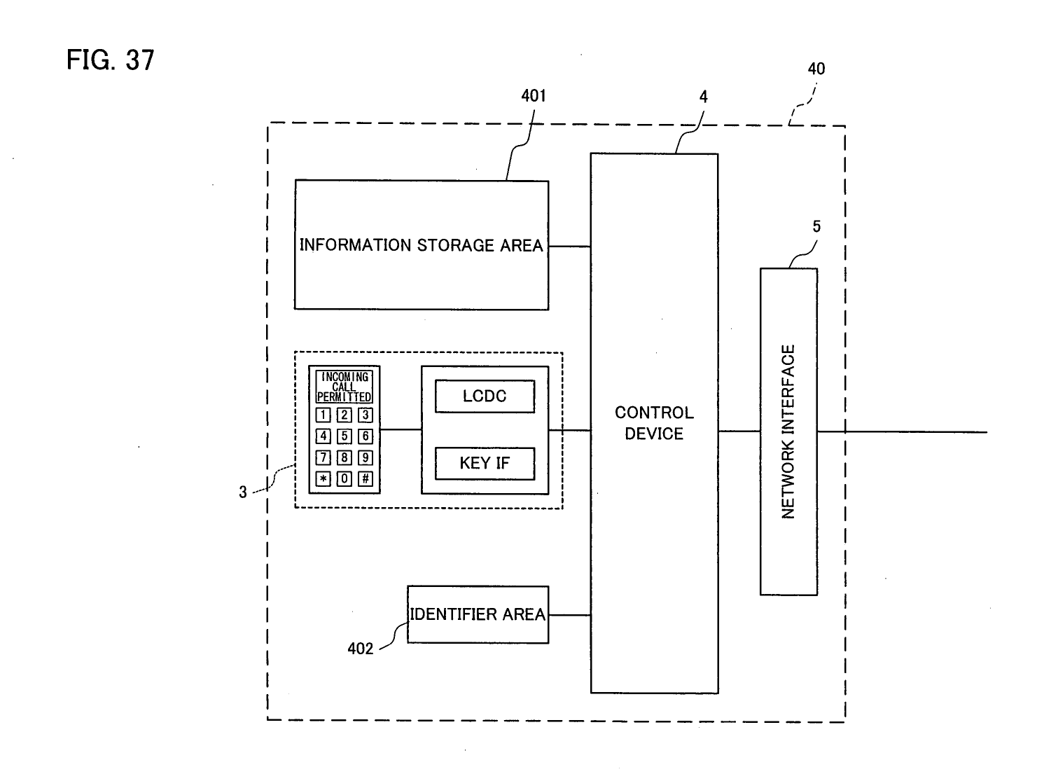

FIG. 37 is a diagram showing an arrangement of Terminal B described above. Terminal B includes an information storage area 401. The information storage area 401 is an area for storing image data. The information storage area 401 stores image data transferred from an image pickup apparatus, such as a digital camera. Moreover, the image data stored in the information storage area 401 is transmitted to the other terminal. The information storage area 401 may be a detachable one, such as a flash memory card, or may be a hard disk drive included fixedly in Terminal B. Moreover, an identifier area 402 is an area for storing the known identifier and hidden identifier of Terminal B.

As described above, Terminal B may be a server which automatically transmits image data requested by the other terminal. In such a case, the image data needs to be uploaded to Terminal B in advance. Therefore, it is preferable that the image data be transferred to the information storage area 401 of Terminal B via a network. Moreover, it is preferable that, regarding the control of an incoming call made by using the known identifier (will be described later), an instruction can be given to Terminal B via the network.

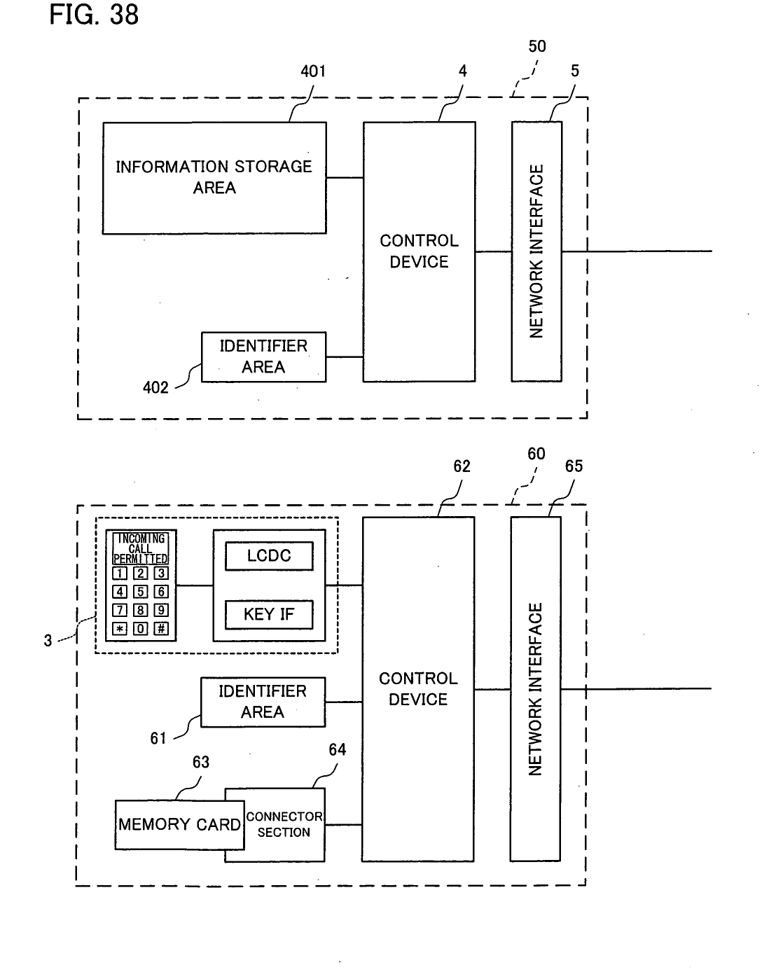

FIG. 38 is a diagram showing a case where Terminal B in FIG. 37 is divided into two terminals that are Terminal 50 having a function as a server which transmits the requested image data and Terminal 60 which gives various instructions to Terminal 50 via the network.

Terminals 50 and 60 are connected to each other via the network, so that the transmission and reception of the image data can be carried out between Terminals 50 and 60. For example, when a memory card 63 is attached to a connector section 64 of Terminal 60, the image data stored in the memory card 63 is transmitted by the control device 62 to the network via a network interface 65. Then, Terminal 50 receives the transmitted data via the network interface 5, and stores the data in the information storage area 401.

Moreover, the user can remote-control Terminal 50 by Terminal 60. That is, if the user inputs an operation to the input/output device 3 of Terminal 60 so as to control Terminal 50, the control device 62 of Terminal 60 controls, via the network, a control device 4 of Terminal 50 on the basis of the content of the input operation.

As methods of such a remote-controlling via the network, it is possible to use a commonly-used technology, such as HTTP (Hyper Text Transfer Protocol) or HTTPS (HTTP over SSL (Secure Sockets Layer)) that is HTTP adopting the encryption technology. Therefore, the detailed explanation of the remote-controlling is omitted here.

Note that the control device 4 includes extracting means, permission judging means, reply data generating means, data generating means, searching means, outgoing call permission memory means, incoming call permission memory means, registration information generating means, encrypting means, and decrypting means, all of which are recited in claims.

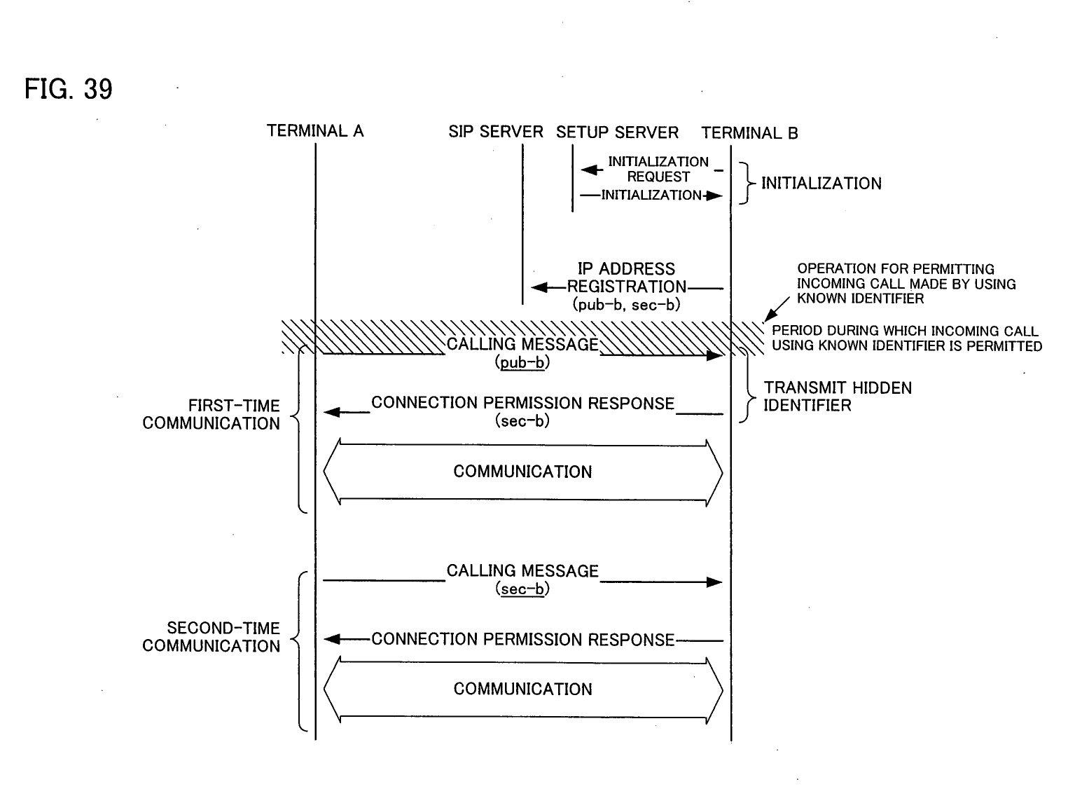

FIG. 39 is a sequence diagram showing a communication process in a communication system according to Embodiment 5. As with Terminals A and B in Embodiment 1, Terminal B is initialized, and obtains the known identifier and the hidden identifier from a setup server. FIG. 39 shows steps of communication in which Terminal B downloads the known identifier and the hidden identifier from the setup server. However, Terminal B may generate the known identifier and the hidden identifier. In this case, however, Terminal B needs to inquire of the setup server so as to confirm that the generated identifier(s) is not already used by the other terminal. Meanwhile, Terminal A does not have the known identifier or the hidden identifier, so that Terminal A does not require such an initialization step.

Next, Terminal B associates the IP address (192.168.43.21:5060 in FIG. 35) of Terminal B with the known identifier pub-b and hidden identifier sec-b of Terminal B, and registers the IP address, the known identifier pub-b, and the hidden identifier sec-b in the SIP server.

Next, Terminal B is set by a user to such a mode that the incoming call using the known identifier is permitted, so that Terminal B receives the calling message created by using the known identifier. At this time, the user operates the input/output device 3 so that Terminal B is set to the above-described mode. This setting may be carried out, for example, by just selecting the mode from a menu, or the user who is allowed to set the mode is limited by a password. This password can prevent a child from permitting an incoming call from an unwanted person. Therefore, this function can be used as a kind of parental control. Note that this step is unnecessary if the user always wants to receive an incoming call made by using the known identifier.

Next, upon transmission of the calling message from Terminal A to Terminal B, Terminal B transmits to Terminal A the connection permission response generated in response to the calling message. This connection permission response contains the hidden identifier sec-b of Terminal B. At the same time, Terminal B changes to such a state as to reject the incoming call made by using the known identifier. That is, Terminal B receives the calling message made by using the known identifier only in a shaded period shown in FIG. 39. In this period, as explained in Embodiments 2 to 4, it is possible to exchange the terminal fingerprint and/or the certificate identifier between Terminals A and B.

If Terminal A has the hidden identifier or the terminal fingerprint, it may be possible that (i) the hidden identifier or terminal fingerprint of Terminal A is encrypted, using the public key encryption, by a secret key of Terminal B, and (ii) the encrypted result is used as the certificate identifier which is generated by Terminal B for Terminal A. In this case, Terminal B does not have to record the certificate identifier generated for Terminal A, and can generate the certificate identifier anytime. Therefore, the “EXPECTATION CERTIFICATE IDENTIFIER” column in FIG. 24 can be omitted.

In subsequent communication, the image data accumulated in Terminal B is transmitted to Terminal A, and the display section 31 of Terminal A displays an image represented by the transmitted image data. The above-described HTTP, HTTPS, or the like can be used for this communication.

As with the example explained in Embodiment 1, the hidden identifier sec-b is used when carrying out communication for the second or later time. That is, Terminal B is in such a state that Terminal B does not receive an incoming call made by using the known identifier, but receives an incoming call made by using the hidden identifier. Therefore, Terminal A can start communication without any problem.

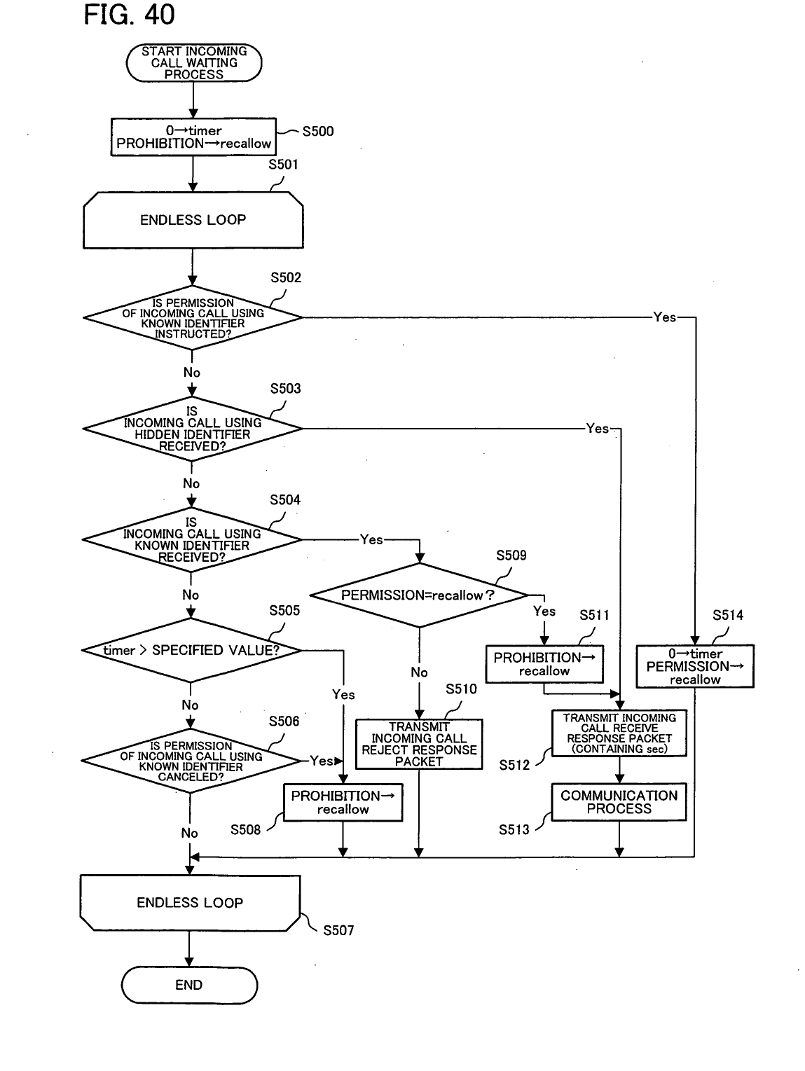

FIG. 40 is a flow chart showing a flow of an incoming call waiting process of Embodiment 5. In Embodiment 5, Terminal A has only the call-making function, and Terminal B has only the call-receiving function. Therefore, the incoming call waiting process shown in FIG. 40 is carried out by Terminal B. The following will explain a case where the incoming call waiting process shown in FIG. 40 is carried out by Terminal B (Terminal 40) shown in FIG. 37.

First, in S500, the control device 4 initializes a variable timer so that the variable timer is 0. Note that the variable timer is used for timekeeping. At the same time, the control device 4 sets a flag recallow so that the incoming call using the known identifier is not permitted. Note that the flag recallow indicates whether or not the call using the known identifier is permitted. Moreover, a software or a hardware is so configured that the value of the variable timer automatically increases at regular time intervals.

S501 and S507 constitute an endless loop.

If the control device 4 detects in S502 that the user has instructed to permit the incoming call made by using the known identifier, the process proceeds to S514. If the control device does not detect so, the process proceeds to S503.

In S514, the control device 4 sets a variable recallow to “Permit”. Note that the variable recallow indicates whether or not Terminal B is set to such a mode that the incoming call using the known identifier is permitted. This “Permit” indicates that Terminal B is set to such a mode that the incoming call using the known identifier is permitted. That is, the control device 4 stores, using the variable recallow, a setting whether or not the incoming call using the known identifier is permitted. At the same time, the control device 4 initializes the variable timer so that the variable timer is 0. The variable timer is a variable for counting a time elapsed since Terminal B is set to such a mode that the incoming call using the known identifier is permitted. Then, the process proceeds from S514 to S507.

Meanwhile, in S503, the control device 4 judges whether or not Terminal B has received the incoming call made by using the hidden identifier. If Terminal B has received the incoming call made by using the hidden identifier, the process proceeds to S512. Since Terminal B always receives the incoming call made by using the hidden identifier, the control device 4 transmits in S512 an incoming call receive response packet containing the hidden identifier sec-b of Terminal B. The present embodiment shows an example of transmitting the incoming call receive response packet containing the hidden identifier sec-b of Terminal B. However, the hidden identifier of Terminal B does not have to be contained in the incoming call receive response packet. Then, the process proceeds to S513, and the communication process is carried out.

If Terminal B does not receive, in S503, the incoming call made by using the hidden identifier, the process proceeds to S504. In S504, the control device 4 judges whether or not Terminal B has received the incoming call made by using the known identifier. Then, if Terminal B has received the incoming call made by using the known identifier, the process proceeds to S509. If Terminal B has not received the incoming call made by using the know identifier, the process proceeds to S505.

When judging in S503 and S504 whether the Terminal B has received the incoming call made by using the hidden identifier or the incoming call made by using the known identifier, it is necessary to check whether or not the message of the incoming call contains the hidden identifier of Terminal B. In this way, it is possible to find out whether Terminal B has received the call made by using the known identifier or the call made by using the hidden identifier. That is, if the message of the call contains the hidden identifier of Terminal B, the call Terminal B has received is the call made by using the hidden identifier, and if the message of the call does not contain the hidden identifier of Terminal B, the call Terminal B has received is the call made by using the known identifier.

In S509, the control device 4 refers to the value of the variable recallow so as to judge whether or not the incoming call using the known identifier is permitted. If the variable recallow is set to “Permit”, that is, if the incoming call using the known identifier is permitted, the process proceeds to S511. In S511, to prohibit the following incoming call made by using the known identifier, the control device 4 sets the variable recallow to “Prohibit”. Then, the same processes as when Terminal B has received the incoming call made by using the hidden identifier, that is, S512 and S513 are sequentially carried out.

If the incoming call using the known identifier is not permitted in S509, the process proceeds to S510, and the control device 4 transmits an incoming call reject response packet. Then, the process proceeds from S510 to S507. When rejecting the incoming call, the control device 4 usually transmits the incoming call reject response packet. However, the control device 4 may be configured so as not to respond at all.

If Terminal B has not received in S504 the incoming call made by using the known identifier, the process proceeds to S505. Then, in S505, the control device 4 judges whether or not a time elapsed since the incoming call using the known identifier is set to “Permit” has exceeded a certain value (specified value). If the elapsed time has exceeded the certain value, the process proceeds to S508, and the control device 4 sets the variable recallow to “Prohibit”. This prohibits the following incoming call made by using the known identifier. Then, the process proceeds from S508 to S507.

If the control device 4 has judged in S505 that the time elapsed since the incoming call using the known identifier is set to “Permit” has not exceeded the certain value, the process proceeds to S506. If the control device 4 detects in S506 that the user has cancelled the permission of the incoming call made by using the known identifier, the process proceeds to S508. Then, the control device 4 sets the variable recallow to “Prohibit”. This prohibits the following incoming call made by using the known identifier. Meanwhile, if the control device 4 does not detect that the user has cancelled the permission of the incoming call made by using the known identifier, the process proceeds to S507. Then, the process returns from S507 to S501, and the process explained above is carried out again.

It is possible to further reduce the possibility of receiving an improper incoming call by, in the incoming call waiting process, (i) limiting a period of accepting the incoming call made by using the known identifier, and (ii) after the incoming call using the known identifier is once received, prohibiting the incoming call made by using the known identifier, as described above. Further, the communication terminal of the present embodiment may be configured so that the incoming call is prohibited in the case in which a certain time has elapsed since the known identifier of a communication terminal is changed to a new known identifier.

The foregoing has explained the incoming call waiting process using modes of permitting or prohibiting the incoming call made by using the known identifier. In the case of the communication terminal of the present invention, the same process as when receiving a call can be carried out when making a call. That is, by using the modes of permitting or prohibiting the outgoing call made by using the known identifier, it is possible to carry out a control of making a call. In this case, as with the incoming call waiting process shown in FIG. 40, when the outgoing call using the known identifier is permitted by the operation of the user, and the outgoing call using the known identifier is once made, the following outgoing call using the known identifier may be prohibited. Moreover, when the outgoing call using the known identifier is permitted by the operation of the user, and a certain time is elapsed, the following outgoing call using the known identifier may be prohibited.

As explained above about FIG. 29(a), when carrying out the input check of the known identifier in the calling terminal, the authentication number may or may not be checked by the check digit. When checking the authentication number, the ability of authentication by the authentication number slightly decreases. However, especially in the present embodiment, this decrease of the authentication ability hardly affects the security since the incoming call using the known identifier is limited.

The following will explain another format of the known identifier. FIG. 29(a) has explained the known identifier constituted by the category number, the check digit, the connection target number, and the authentication number. Instead of using the check digit obtained by Formula (1), the authentication number may have a check function. This is realized by, for example, obtaining the authentication number by Formula (3) below.
[(n₁+n₅+n₉)×1357+(n₂+n₆+n₁₀)×3571+(n₃+n₇)×5713+(n₄+n₈)×7135]mod10000 (3)
Note that nₐ denotes a numeral of an a^{th} digit.

For example, regarding the known identifier “53-1234-5678-abcd” whose last four digits “abcd” is the authentication number, the authentication number “abcd” can be obtained by Formula (3). Formula (4) below shows that the authentication number “abcd” is 5278. Therefore, the known identifier is 53-1234-5678-5278.
[(5+3+7)×1357+(3+4+8)×3571+(1+5)×5713+(2+6)×7135]mod10000=5278 (4)

If the known identifier is input incorrectly, (i) the authentication number of the input known identifier does not correspond to the value obtained by Formula (3), and (ii) the authentication number appears to be random. Therefore, the authentication number also functions as authentication (password). Note that a formula for calculating the authentication number is not limited to Formula (3), and it is possible to use an algorithm whose regularity is not easily discovered. By using the known identifier including the authentication number calculated as above, an ability of detecting the improper outgoing call in a terminal can be improved as long as the secrecy of the algorithm is preserved. This prevents the generation of the calling message by the improper outgoing call, so that it is possible to reduce the load of (i) a server which converts the known identifier into the address identifier, and (ii) the other terminal(s).

Moreover, Embodiment 4 shows an example in which, if the calling message which should be rejected (for example, the calling message whose authentication portion is incorrect) is received, for example, three times in ten seconds from one terminal, the incoming call from this terminal is reject thereafter. Moreover, after a certain period (for example, ten minutes, one day, etc.) has passed since the setting of rejecting the incoming call is carried out, the setting of rejecting the incoming call may be cancelled automatically. With this, even if a user have made the outgoing call using a wrong number several times, and the setting of rejecting the incoming call from this user is once activated, the setting is canceled automatically.

According to the above explanation, whether or not Terminal B receives the incoming call made by using the known identifier is judged. However, the present embodiment is not limited to this.

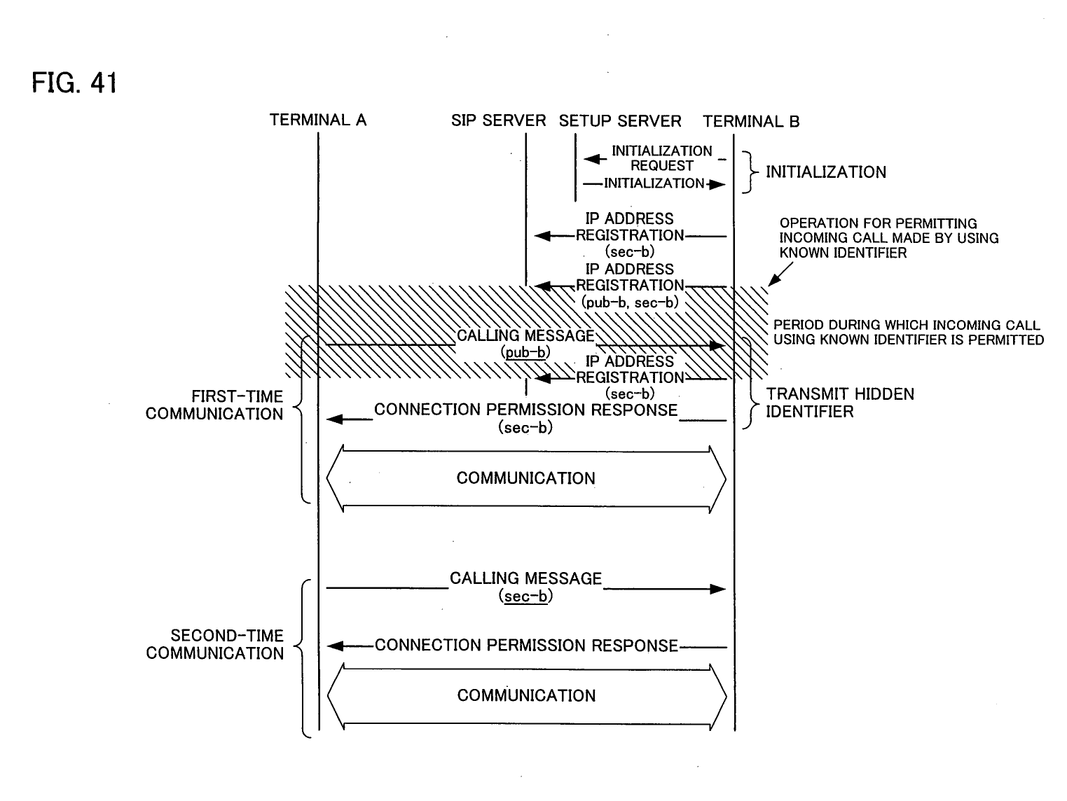

FIG. 41 is a sequence diagram showing another communication process in the communication system according to Embodiment 5. The communication process shown in FIG. 41 is the same as the communication process shown in FIG. 39 except for a step of registering the IP address.

As with the communication process shown in FIG. 39, in the communication process shown in FIG. 41, Terminal B registers the IP address of Terminal B in the SIP server after Terminal B is initialized. At this time, only the hidden identifier (sec-b) associated with the IP address is registered in the SIP server, and the known identifier (pub-b) is not registered. In this case, the other terminal(s) cannot make the outgoing call to Terminal B by using the known identifier. Then, if the incoming call using the known identifier to Terminal B is permitted by the operation of the user, Terminal B again registers the IP address in the SIP server. At this time, in addition to the hidden identifier (sec-b), the known identifier (pub-b) associated with the IP address of Terminal B is registered in the SIP server. Therefore, from this moment, Terminal B can receive the incoming call made by using the known identifier.

When prohibiting the incoming call made by using the known identifier, only the hidden identifier (sec-b) associated with the IP address is again registered in the SIP server. That is, in response to a request by Terminal B, the SIP server stores only the hidden identifier (sec-b) associated with the IP address of Terminal B.

The following describes the other features of the present invention.

Further, in the foregoing structure, the receiving apparatus according to the present invention is arranged such that: the extracting means has a function of extracting a known identifier of the receiving apparatus among known identifiers, which are for use in respectively specifying communication apparatuses and the receiving apparatus, and which are known to the user, and in cases where no hidden identifier identical to the extracted hidden identifier is found in the table as a result of the search and where the known identifier of the receiving apparatus is not extracted from the connection request data, the writing control means writes, in the table, information indicating that the receiving apparatus rejects the connection with the one of the communication apparatuses, the information being so written in the table as to be correlated with the extracted hidden identifier.

According to the structure above, the case where the known identifier of the receiving apparatus is not extracted from the connection request data is assumed as a case where the communication apparatus having the hidden identifier wrongly requests the connection with the receiving apparatus.

Therefore, information indicating that the connection is to be rejected is written in the table by the writing control means such that the information is correlated with the extracted hidden identifier. This allows the user of the receiving apparatus to select an appropriate communication apparatus having a hidden identifier. Accordingly, it is possible to carry out setting such that the permission for the connection is given to such an appropriate communication apparatus as required.

In cases where no hidden identifier identical to the extracted hidden identifier is stored in the address storage section and where the known identifier of the receiving apparatus is extracted from the connection request data, it is or it is assumed that the communication apparatus having the hidden identifier makes more appropriate request for the first time for connection with the receiving apparatus with the use of the known identifier of the receiving apparatus.

According to the above structure, when receiving the connection request data from one of the communication apparatuses for the first time, the extracting means extracts the hidden identifier of the communication apparatus and the known identifier of the receiving apparatus from the connection request data. In cases where the extracting means extracts the hidden identifier, the searching means searches, by using the extracted hidden identifier, the table stored in the address storage section.

In cases where the search clarifies that no hidden identifier identical to the extracted hidden identifier is stored in the address storage section and where the extracting means extracts the known identifier of the receiving apparatus, it is or it is assumed that the communication apparatus having the hidden identifier makes a request for an appropriate connection with the receiving apparatus with the use of the known identifier for the first time. Therefore, the writing control means writes the extracted hidden identifier and the specifying information of the communication apparatus in the table of the address storage section such that the extracted hidden identifier and the specifying information of the communication apparatus are correlated with each other. Thus, the communication apparatus is registered.

On the other hand, in cases where the known identifier of the receiving apparatus is not extracted from the connection request data, it is or it is assumed that the communication apparatus having the hidden identifier wrongly request the connection with the receiving apparatus. Therefore, information indicating that the connection is to be rejected is written in the table by the writing control means such that the information is correlated with the extracted hidden identifier. This allows the user of the receiving apparatus to select an appropriate communication apparatus having a hidden identifier. Accordingly, it is possible to carry out setting such that the permission for the connection is given to such an appropriate communication apparatus as required.

Further, in the foregoing structure, it is preferable that the receiving apparatus according to the present invention further include: data generating means for generating reply data including information indicating whether or not the connection with the one of the communication apparatuses is permitted, wherein: in cases where the permission judging means judges that the connection is permitted, the data generating means generates reply data including at least (i) information indicating that the connection is permitted, and (ii) the hidden identifier assigned to the receiving apparatus.

With this, the hidden identifier assigned to the receiving apparatus is notified to the communication apparatus which is permitted to be connected with the receiving apparatus, so that the hidden identifiers are exchanged between the communication apparatus and the receiving apparatus. In other words, this makes it possible to prevent the hidden identifier of the receiving apparatus from being given to a communication apparatus which is not permitted to be connected with the receiving apparatus. Further, as is the case with the receiving apparatus, in the communication apparatus, the hidden identifier of the receiving apparatus is correlated with the information indicating that the connection with the receiving apparatus is permitted. With this, the communication is allowed between the receiving apparatus and the communication apparatus with the use of the hidden identifiers, even when each of the known identifiers is changed.

Further, in the foregoing structure, it is preferable that the receiving apparatus of the present invention further include: data generating means for generating reply data including information indicating whether or not the connection with the one of the communication apparatuses is permitted, wherein: the extracting means has a function of extracting a known identifier of the receiving apparatus among known identifiers, which are for use in respectively specifying communication apparatuses and the receiving apparatus, and which are known to the user, and in cases where no hidden identifier identical to the extracted hidden identifier is stored in the table and where the extracting means extracts the known identifier of the receiving apparatus, the data generating means generates reply data including at least (i) information indicating that the connection is permitted, and (ii) the hidden identifier assigned to the receiving apparatus.

With this, the hidden identifier assigned to the receiving apparatus is notified to such an appropriate communication apparatus having the hidden identifier, and the receiving apparatus and the communication apparatus can exchange their hidden identifiers with each other. In other words, this makes it possible to prevent the hidden identifier of the receiving apparatus from being given to an inappropriate communication apparatus that has made a request for the first time for the connection with the receiving apparatus, and that has sent the connection request data which does not include the known identifier of the receiving apparatus. Also, as is the case with the receiving apparatus, the communication apparatus can correlate (i) the hidden identifier of the receiving apparatus with (ii) the information indicating that the connection with the receiving apparatus is permitted. With this, the communication is allowed between the receiving apparatus and the communication apparatus with the use of the hidden identifiers, even when each of the known identifiers is changed.

The transmitting apparatus of the present invention is preferably arranged such that: the address storage section is detachable.

According to the above structure, the address storage section is detachable from the transmitting apparatus, or is attachable to the transmitting apparatus.

This makes it possible that an address storage section used in a certain transmitting apparatus can be used in another transmitting apparatus. In other words, the connection request data addressed to the hidden identifier of the receiving apparatus connected to the aforementioned connection path can be transmitted from any communication apparatus to which the address storage section is attachable. This allows improvement of convenience for the user.

The receiving apparatus of the present invention is arranged so as to further include: an address storage section for storing one or more of (i) a hidden identifier of each of the communication apparatuses, (ii) connection permission information indicating whether or not the connection is permitted, (iii) a first identifier which is assigned to each of the communication apparatuses such that the communication apparatuses are distinguishable from one another, and which is hidden from the user, and (iv) a second identifier which is assigned to each of the communication apparatuses such that the communication apparatuses are distinguishable from one another, and which is given from the receiving apparatus to a communication apparatus that is permitted to communicate with the receiving apparatus, the one or more of the hidden identifier, the connection permission information, the first identifier, and the second identifier being stored such that the hidden identifier, the connection permission information, the first identifier, and the second identifier are correlated with at least either one of (a) specifying information known to the user such that the hidden identifier assigned to the communication apparatus is distinguishable from the other communication apparatuses, and (b) a known identifier of the communication apparatus.

According to the above structure, the address storage section stores one or more of the hidden identifier, the connection permission information, the first identifier, and the second identifier such that each of the hidden identifier, the connection permission information, the first identifier, and the second identifier is correlated with either the specifying information or the known identifier.

The specifying information is information known to the user, and the user can freely make reference to the specifying information stored in the address storage section. A specific example of the specifying information includes a name or nickname of the user of the communication apparatus. The connection permission information is information indicating whether or not the connection with the communication apparatus connected to the communication path is permitted.

On the other hand, the first identifier is assigned to the communication apparatus so that the communication apparatus is distinguishable from the other communication apparatuses connected to the communication path, and is hidden from the user. Further, the first identifier is used by the receiving apparatus such that the receiving apparatus identifies the communication apparatus having sent the connection request data. Moreover, the first identifier is not used as an address for specifying the target destination to which the communication apparatus is to be connected.

In the meanwhile, the second identifier is an identifier by which the receiving apparatus confirms that the receiving apparatus has ever communicated with the communication apparatus having sent the connection request data. Further, the second identifier is so generated as to correspond to the hidden identifier of the communication apparatus, the specifying information thereof, the first identifier, or the like. The second identifier is given to a communication apparatus that is permitted to be communicated with the receiving apparatus.

With this, in response to the connection request from the communication apparatus connected to the communication path, the receiving apparatus according to the present invention reads out, from the address storage section, the connection permission information, the first identifier, or the second identifier, each of which concerns the communication terminal having sent the connection request data including (i) the specifying information of the communication apparatus, (ii) the known identifier, or (iii) the hidden identifier. The readout is carried out in accordance with (i) the specifying information of the communication apparatus, (ii) the known identifier, or (iii) the hidden identifier. In accordance with the readout connection permission information, the readout first identifier, or the readout second identifier, judgment can be carried out whether or not the communication with the communication apparatus is to be carried out.

The receiving apparatus of the present invention is preferably arranged such that: the extracting means extracts, from the connection request data, (i) a hidden identifier assigned to the communication apparatus having sent the connection request data, (ii) specifying information known to the user such that the hidden identifier is distinguishable from hidden identifiers assigned to the other communication apparatuses, or (iii) a first identifier hidden from the user and assigned to each of the communication apparatuses such that the communication apparatus is distinguishable from the other communication apparatuses, the receiving apparatus, further including: an address storage section for storing (i) connection permission information indicating whether or not the communication apparatus having made the request for connection with the receiving apparatus is permitted to be connected with the receiving apparatus, and (ii) the first identifier, the connection permission information and the first identifier being stored such that the connection permission information and the first identifier are correlated with at least either one of the specifying information and the hidden identifier of the communication apparatus; and searching means for searching the address storage section for connection permission information corresponding to the extracted hidden identifier, the extracted specifying information, or the extracted first identifier, wherein: the permission judging means instructs the reply data generating means to transmit the reply data, in cases where the connection permission information found as a result of the search indicate that the connection is permitted.

According to the above structure, the connection request data includes the hidden identifier, the specifying information, or the first identifier of the communication apparatus having sent the connection request data. The extracting means extracts the hidden identifier, the specifying information, and the first identifier of the communication apparatus therefrom. Note that the specifying information is information by which the user specifies the communication apparatus, and is known to the user. Further, the first identifier is provided such that the communication apparatus is distinguishable from the other communication apparatuses connected to the communication path, and is hidden from the user. Note that the first identifier cannot be designated as an address of the receiving apparatus, to which address the communication apparatus transmits data. The first identifier is used by the receiving apparatus so as to identify the communication apparatus having sent the connection request data.

Further, according to the above structure, the connection permission information indicating whether or not the request for the connection with the communication apparatus is permitted, and the first identifier are so stored in the address storage section as to be correlated with at least either one of (i) the specifying information for specifying the plurality of communication apparatuses each transmitting the connection request data to the receiving apparatus, and (ii) the hidden identifier of the communication apparatus. The searching means searches the address storage section for the connection permission information that is so stored as to be correlated with the extracted hidden identifier, the specifying information, or the first identifier. When the connection permission information found as a result of the search indicates that the connection is permitted, the permission judging means instructs the reply data generating means to transmit the reply data.

This makes it possible that: the receiving apparatus according to the present invention communicates only with a communication apparatus which is correlated with connection permission information indicating that connection with the communication apparatus is permitted, and rejects communication with a communication apparatus which is correlated with connection permission information indicating that connection with the communication apparatus is not permitted.

The receiving apparatus of the present invention is arranged such that: the extracting means further extracts, from the connection request data, (i) a hidden identifier of the communication apparatus having sent the connection request data, (ii) specifying information known to the user such that the hidden identifier is distinguishable from the other hidden identifier, (iii) a first identifier hidden from the user and assigned to each of the communication apparatuses such that the communication apparatuses are distinguishable from one another, or (iv) a second identifier which is assigned to each of the communication apparatuses such that the communication apparatuses are distinguishable from one another, and which is given from the receiving apparatus to a communication apparatus that is permitted to communicate with the receiving apparatus, the receiving apparatus, further comprising: an address storage section for storing the second identifier such that the second identifier is correlated with at least one of the specifying information, the hidden identifier, and the first identifier; and searching means for searching the address storage section for the second identifier corresponding to the extracted hidden identifier, the extracted specifying information, or the extracted first identifier, wherein: the permission judging means judges whether or not the second identifier found as a result of the search coincides with the extracted second identifier, and in cases where the permission judging means judges that the second identifiers coincide with each other or where the extracted address information is the known identifier, the permission judging means instructs the reply data generating means to transmit the reply data.

According to the above structure, the connection request data includes the hidden identifier, the specifying information, the first identifier, and the second identifier of the communication apparatus having sent the connection request data. The hidden identifier, the specifying information, the first identifier, and the second identifier of the communication apparatus are extracted by the extracting means. Further, according to the above structure, the second identifier of each of the communication apparatuses transmitting the connection request data to the receiving apparatus is so stored in the address storage section as to be correlated with the specifying information, the hidden identifier, or the first identifier of the communication apparatus.

Further, according to the above structure, the searching means searches the address storage section for the second identifier corresponding to the hidden identifier, the specifying information, or the first identifier, each of which is extracted by the extracting means. When the second identifier thus found as a result of the search coincides with the second identifier extracted by the extracting means, the permission judging means instructs the reply data generating means to transmit the reply data. Further, the permission judging means also instructs the reply data generating means to transmits the reply data, when the known identifier of the receiving apparatus is designated as the address information extracted by the extracting means.

This makes it possible to realize a structure in which: the receiving apparatus according to the present invention makes response upon receiving the connection request data, including the second identifier, from the communication terminal whose second identifier is appropriately correlated with at least one of the specifying information, the hidden identifier, and the first identifier thereof.

The receiving apparatus of the present invention is preferably arranged such that: the data generating means generates reply data including the hidden identifier assigned to the receiving apparatus.

According to the above structure, the reply data generated by the data generating means includes the hidden identifier assigned to the receiving apparatus.

With this, the reply data including the hidden identifier assigned to the receiving apparatus is transmitted to the communication apparatuses, which is permitted to be connected with the receiving apparatus, among communication apparatuses each of which transmits connection request data to the receiving apparatus. That is, the communication apparatus permitted to be connected with the receiving apparatus can acquire the hidden identifier of the receiving apparatus. Thereafter, even when the known identifier of the receiving apparatus is changed, the connection request data can be transmitted to the receiving apparatus with the hidden identifier of the receiving apparatus set as a target address.

The receiving apparatus of the present invention is preferably arranged such that: the permission judging means judges whether or not the hidden identifier of the receiving apparatus is to be transmitted, and in cases where the permission judging means judges that the transmission is permitted, the permission judging means instructs the data generating means to transmit the reply data including the hidden identifier of the receiving apparatus.

According to the above structure, the permission judging means judges whether or not the hidden identifier of the receiving apparatus is to be transmitted. For example, the permission judging means possibly makes such a judgment that the transmission of the hidden identifier is permitted in cases where a certain time has passed since the start of the communication with the communication apparatus. Alternatively, the permission judging means possibly makes such a judgment that the transmission of the hidden identifier is permitted in cases where the receiving apparatus receives the hidden identifier of the communication apparatus. Further, the permission judging means possibly makes such a judgment that the transmission of the hidden identifier is permitted upon reception of a user's instruction. That is, the judgment on the permission for the transmission of the hidden identifier is not particularly limited.

With this, even when the receiving apparatus according to the present invention does not give the hidden identifier of the receiving apparatus to the communication apparatus, the receiving apparatus can start the communication with the communication apparatus. Moreover, only when the person using the communication apparatus is judged to be trustable, the receiving apparatus sends the hidden identifier to the communication apparatus. This makes it possible to prevent the hidden identifier of the receiving apparatus from being known to an unwanted person.

The receiving apparatus of the present invention is preferably arranged such that: the extracting means extracts, from the connection request data, a hidden identifier assigned to the communication apparatus having sent the connection request data, and the permission judging means judges to permit the transmission of the hidden identifier of the receiving apparatus, in cases where the extracting means extracts the hidden identifier of the communication apparatus.

According to the above structure, the extracting means extracts, from the connection request data, the hidden identifier assigned to the communication apparatus having sent the connection request data. When the extracting means extracts the hidden identifier of the communication apparatus, i.e., when the hidden identifier for specifying the communication terminal of the sending end is acquired, the permission judging means makes a judgment so as to permit the transmission of the hidden identifier of the receiving apparatus to the communication apparatus.

This makes it possible that the receiving apparatus according to the present invention does not send the hidden identifier of the receiving apparatus to the communication apparatus which never sends the hidden identifier of the communication apparatus. Accordingly, such unfairness can be prevented that the hidden identifier of the receiving apparatus is given to the communication apparatus but the hidden identifier of the communication apparatus is not given to the receiving apparatus.

The receiving apparatus of the present invention is preferably arranged such that: the permission judging means judges to permit the transmission of the hidden identifier of the receiving apparatus, in cases where a certain time has passed since start of communication with the communication apparatus.

According to the above structure, in cases where a certain time has passed since the start of the communication with the communication apparatus, the permission judging means makes a judgment so as to permit the transmission of the hidden identifier of the receiving apparatus to the communication apparatus. Here, the wording “certain time” refers to a period of time required for the user to judge whether or not the user continues communicating with the one with whom the user is communicating. In other words, a fact that the communication continues after the passage of the time indicates that the one who is communicating with the user is a trustable person, so that no problem occurs even if the hidden identifier of the receiving apparatus is transmitted to the communication terminal.

This makes it possible to prevent the hidden identifier of the receiving apparatus according to the present invention from being known to the one whom the user terminates the communication before the passage of the time from the start of the communication, i.e., prevent the hidden identifier from being known to either (i) a person who accidentally connected his/her communication apparatus to the receiving apparatus, or (ii) a malicious person.

The receiving apparatus of the present invention is preferably arranged such that: the extracting means extracts, from the connection request data, (i) a hidden identifier assigned to the communication apparatus having sent the connection request data, and (ii) specifying information known to the user such that the user distinguishes the hidden identifier from the other hidden identifiers, the receiving apparatus, further including: an address storage section for storing the specifying information and the hidden identifier such that the specifying information and the hidden identifier are correlated with each other; and writing control means for writing, in the address storage section, the hidden identifier, which is extracted by the extracting means, such that the hidden identifier is correlated with either (i) specifying information acquired from an input and output apparatus manipulated by the user, or (ii) the specifying information extracted by the extracting means.

According to the above structure, the extracting means extracts, from the connection request data, the hidden identifier and the specifying information, each of which is assigned to the communication apparatus having sent the connection request data. Further, the user is allowed to input the specifying information via the input and output apparatus. Further, either the extracted specifying information or the specifying information inputted by the user is written in the address storage section by the writing control means so as to be correlated with the extracted hidden identifier. On this occasion, the hidden identifier is kept hidden from the user, and is stored in the address storage section. On the other hand, the specifying information can be inputted by the user, so that the specifying information is information known to the user. Therefore, the user can freely make reference to the specifying information stored in the address storage section. A specific example of the specifying information includes either (i) a name or nickname of the user of the receiving apparatus, or (ii) the known identifier assigned to the receiving apparatus.

With this, the user can make reference to the specifying information of the communication terminal whose hidden identifier is stored in the address storage section of the receiving apparatus. In other words, the hidden identifier of the communication terminal is kept hidden from the user, but the user can identify, in accordance with the specifying information, the communication terminal whose hidden identifier is stored in the receiving apparatus. Further, the user can input the specifying information of the communication terminal, so that specifying information allowing the user to easily distinguish the communication terminal can be registered.

It is preferable that the transmitting apparatus of the present invention further include: searching means for (i) acquiring a part of or whole specifying information from an input and output apparatus manipulated by the user, and (ii) searching the address storage section for specifying information corresponding to the acquired specifying information, wherein: the data generating means generates connection request data addressed to a hidden identifier that is so stored in the address storage section as to be correlated with the specifying information found as a result of the search.

According to the above structure, the user manipulates the input and output apparatus so as to input a part of or whole specifying information. The searching section searches the address storage section for specifying information partially or entirely coinciding with the specifying information thus inputted. Then, the connection request data is generated which includes, as the address data, the hidden identifier stored so as to be correlated with the specifying information that was found as a result of the search, and that partially or entirely coincides the specifying information inputted by the user. On this occasion, the hidden identifier is included in the connection request data as a target address, and is kept hidden from the user. Note that the specifying information is known to the user, and is information in accordance with which the user specifies the target receiving apparatus.

With this, when transmitting the connection request data from the transmitting apparatus according to the present invention to the target receiving apparatus connected to the communication path, the receiving apparatus can be specified by the user in accordance with the specifying information easily distinguishable for the user.

It is preferable that the transmitting apparatus of the present invention further include: outgoing call permission memory means for storing a setting whether or not an outgoing call using the known identifier is permitted, wherein: the data generating means generates connection request data addressed to the known identifier, in cases where the outgoing call permission memory means indicates that the outgoing call using the known identifier is permitted.

According to the above structure, the outgoing call permission memory means stores a setting whether or not an outgoing call using, as a target address, the known identifier assigned to the receiving apparatus connected to the connection path is permitted for the transmission of the connection request data to the receiving apparatus. Further, in cases where the setting in the outgoing call permission memory means indicates that the outgoing call is permitted, the data generating means generates the connection request data addressed to the known identifier of the receiving apparatus, in response to a user's transmission operation in which the known identifier of the receiving apparatus is set as a target address.

This makes it possible to restrain the user from transmitting, with the known identifier of the receiving apparatus set as a target address, the connection request data from the transmitting apparatus according to the present invention to the receiving apparatus.

It is preferable that the receiving apparatus of the present invention further include: incoming call permission memory means for storing setting whether or not incoming call using the known identifier is permitted, wherein: the permission judging means instructs the reply data generating means to transmit the reply data, in cases where the incoming call permission memory means indicates that the incoming call using the known identifier is permitted.

According to the above structure, the incoming call memory means stores a setting whether or not the receiving apparatus permits reception of the connection request data, which is transmitted from (i) the communication apparatus connected to the communication path, to (ii) the receiving apparatus, and which is addressed to the known identifier of the receiving apparatus. In cases where the setting in the incoming call permission memory means indicates that the incoming call is permitted, the permission judging means instructs the data generating means to generate the reply data indicating that the connection with the receiving apparatus is permitted. The instruction is made upon reception of the connection request data addressed to the known identifier of the receiving apparatus.

With this, the receiving apparatus according to the present invention can reject the connection request data addressed to the known identifier of the receiving apparatus. In other words, the call using the known identifier known to the user is restricted, with the result that inappropriate incoming calls can be reduced.

The receiving apparatus of the present invention is preferably arranged so as to further includes: registration information generating means for generating registration information, which is registered in a server apparatus intermediating the connection and which indicates a correlation between (i) each of the known identifier of the receiving apparatus and the hidden identifier of the receiving apparatus, and (ii) an network address of the receiving apparatus.

According to the above structure, the registration information generating means generates the registration information indicating the correlation among (i) the known identifier of the receiving apparatus, (ii) the hidden identifier thereof, (iii) the network address thereof. The registration information thus generated is registered in the server apparatus intermediating the communication connection with the communication apparatus connected to the communication path.

With this, when the communication apparatus connected to the communication path transmits data to either the known identifier or the hidden identifier of the receiving apparatus, the server apparatus relays the transmitted data to the receiving apparatus in accordance with the network address of the receiving apparatus, which network address is correlated with the known identifier and the hidden identifier of the receiving apparatus by the registration information.

It is preferable that the receiving apparatus of the present invention further include: incoming call permission memory means for storing a setting whether or not incoming call using the known identifier is permitted, wherein: the registration information generating means generates registration information which does not include the known identifier, in cases where the incoming call permission memory means indicates the incoming call using the known identifier is not permitted.

According to the above structure, the incoming call permission memory means stores a setting whether or not the receiving apparatus permits reception of the connection request data, which is transmitted from (i) the communication apparatus connected to the communication path, to (ii) the receiving apparatus, and which is addressed to the known identifier of the receiving apparatus. In cases where the setting in the incoming call permission memory means indicates that the incoming call is not permitted, the data generating means generates the registration data that does not include the known identifier of the receiving apparatus. That is, the registration information to be registered in the server apparatus intermediating the connection merely includes a correlation between the hidden identifier of the receiving apparatus and the network address thereof.

With this, in cases where the receiving apparatus is so set as to reject a call using the known identifier of the receiving apparatus as a target address, the server apparatus does not relay, to the receiving apparatus, the data which is transmitted from the communication apparatus connected to the communication path, and which is addressed to the known identifier of the receiving apparatus. In other words, the call using the known identifier known to the user is restricted, with the result that inappropriate calls can be reduced.

The receiving apparatus of the present invention is preferably arranged such that: in cases where a certain time has passed since the setting in the incoming call permission memory means was changed by a user's operation to a setting in which the incoming call using the known identifier is permitted, the setting in the incoming call permission memory means is changed from (i) a setting in which the incoming call using the known identifier is permitted, to (ii) a setting in which the incoming call using the known identifier is not permitted.

According to the above structure, in cases where a certain time has passed since the user carried out a setting such that an incoming call using the known identifier was permitted, the setting in the incoming call permission memory means is changed to the setting in which the incoming call using the known identifier is not permitted.

This makes it possible to limit the period during which the incoming call using the known identifier known to the user is permitted, with the result that the inappropriate incoming calls can be further reduced.

The receiving apparatus of the present invention is preferably arranged such that: when the receiving apparatus receives the connection request data, the setting in the incoming call permission memory means is changed from (i) a setting in which the incoming call using the known identifier is permitted, to (ii) a setting in which the incoming call using the known identifier is not permitted.

According to the above structure, when the receiving apparatus receives the connection request data, the setting in the incoming call permission memory means is changed to the setting in which the incoming call using the known identifier will not be permitted thereafter.

This makes it possible to restrict the incoming call using the known identifier known to the user, with the result that the inappropriate incoming calls can be further reduced.

The receiving apparatus of the present invention is preferably arranged such that: when the receiving apparatus receives connection request data addressed to the known identifier, the setting in the incoming call permission memory means is changed from (i) a setting in which the incoming call using the known identifier is permitted, to (ii) a setting in which the incoming call using the known identifier is not permitted.

According to the above structure, when the receiving apparatus receives the connection request data addressed to the known identifier of the receiving apparatus, the setting in the incoming call permission memory means is changed to the setting in which the incoming call using the known identifier will not be permitted thereafter.

This makes it possible to restrict the incoming call using the known identifier known to the user, with the result that the inappropriate incoming calls can be further reduced.

The receiving apparatus of the present invention is preferably arranged such that: in cases where a certain time has passed since a new known identifier was assigned to the receiving apparatus, the setting in the incoming call permission memory means is changed from (i) a setting in which the incoming call using the known identifier is permitted, to (ii) a setting in which the incoming call using the known identifier is not permitted.

According to the above structure, in cases where a certain time has passed since the new known identifier is assigned to the receiving apparatus, the setting in the incoming call permission memory means is changed to the setting in which the incoming call using the known identifier is not permitted.

This makes it possible to limit the period during which the incoming call using the known identifier known to the user is permitted, with the result that the inappropriate incoming calls can be further reduced.

The receiving apparatus of the present invention is preferably arranged so as to further include: encrypting means for encrypting data to be transmitted via the communication path; and decrypting means for decrypting encrypted data received via the communication path.

According to the above structure, the encrypting means encrypts the data to be transmitted to the communication path. Further, the decrypting means decrypts the encrypted data received via the communication path.

With this, the receiving apparatus according to the present invention makes it possible to prevent the identifiers from being known to the user, even when communication packets are intercepted.

The transmitting apparatus of the present invention is preferably arranged so as to further include: encrypting means for encrypting data to be transmitted via the communication path; and decrypting means for decrypting encrypted data received via the communication path.

According to the above structure, the encrypting means encrypts the data to be transmitted to the communication path. Further, the decrypting means decrypts the encrypted data received via the communication path.

With this, the receiving apparatus according to the present invention makes it possible to prevent the identifiers from being known to the user, even when communication packets are intercepted.

Further, in the above structure, the receiving apparatus according to the present invention may further include: data generating means for generating reply data including information indicating whether or not the communication apparatus is permitted to be connected to the receiving apparatus, wherein: the extracting means has a function of extracting, from the connection request data, a first identifier that is hidden from the user, and that is assigned to each of the communication apparatuses such that the communication apparatuses are distinguished from one another; and in cases where the extracting means extracts the first identifier from the connection request data in confirmation that the communication request data does not include the hidden identifier but includes a known identifier of the receiving apparatus, the permission judging means permits the connection with the communication apparatus and the data generating means generates reply data including at least (i) information indicating that the connection is permitted, and (ii) a first identifier assigned to the receiving apparatus.

In the above structure, the first identifier is hidden from the user as is the case with the hidden identifier, but is an identifier different from the hidden identifier. The hidden identifier is extracted by the extracting means, e.g., in the following manner. That is, the extracting means executes a program which judges that the hidden identifier is extracted when each of the communication apparatus and the receiving apparatus detects specifying data generated in accordance with a certain rule and provided in the data of the hidden identifier.

According to the above structure, when the connection request data does not include the hidden identifier of the communication apparatus but includes the first identifier of the communication apparatus and the known identifier of the receiving apparatus, the reply data including the first identifier of the receiving apparatus is sent to the communication apparatus, with the result that the communication apparatus is permitted to be connected with the receiving apparatus. As such, instead of the hidden identifier of the receiving apparatus, for the meanwhile, the first identifier is used to give, to the communication apparatus having made the connection request, the permission for the connection with the receiving apparatus. Therefore, the following risk can be avoided: the permission for the connection is given, by way of the reply data including the hidden identifier of the receiving apparatus, to a communication apparatus which wrongly generated the hidden identifier of the communication apparatus or which wrongly acquired the known identifier of the receiving apparatus, with the result that the hidden identifier of the receiving apparatus is given to the unwanted person.

Further, in the above structure, the receiving apparatus according to the present invention may further include: writing control means for writing, in the table, a second identifier which is assigned to each of the communication apparatuses such that the communication apparatuses are distinguished from one another, and which is given from the receiving apparatus to a communication apparatus that is permitted to communicate with the receiving apparatus, the second identifier being so stored as to be correlated with the hidden identifier, wherein: the extracting means has a function of extracting the second identifier from the connection request data received from the communication apparatus; and in cases where the permission judging means searches the table and find that the hidden identifier and the second identifier, which are extracted by the extracting means from the connection request data, of the communication apparatus are so stored in the table as to be correlated with each other, the permission judging means judges that the extracted hidden identifier is appropriate, and judges, in accordance with the connection permission information, whether or not the connection with the communication apparatus is to be permitted.

In the above structure, the second identifier is assigned to each of the communication apparatuses such that the communication apparatuses are distinguished from one another. Further, the second identifier is recorded in the table of the receiving apparatus so as to be correlated with the hidden identifier assigned to each of the communication apparatuses. In cases where the second identifier is included in the connection reply data received from the communication apparatus, the second identifier is used for such a process that the permission judging means checks whether or not the hidden identifier is so stored in the table as to be correlated with the hidden identifier.

In cases where the receiving apparatus receives only the hidden identifier from the communication apparatus, the receiving apparatus cannot distinguish whether (i) a communication apparatus permitted to communicate with the receiving apparatus is making an appropriate communication request, or (ii) a communication apparatus which wrongly acquired the hidden identifier is making an inappropriate connection request. In contrast, the above structure makes it possible to confirm that the hidden identifier was received from the appropriate communication apparatus permitted to communicate with the receiving apparatus, because the second identifier is given to the communication apparatus together with the permission for the communication.

Further, in cases where the extracted hidden identifier and second identifier of the communication apparatus are not so stored in the table as to be correlated with each other, a communication apparatus from which the hidden identifier of the receiving apparatus was leaked can be specified among communication apparatuses each permitted to communicate with the receiving apparatus, as long as the unique second identifier correlated with the extracted hidden identifier is found in the table.

Note that the second identifier does not need to be hidden form the user, because the second identifier is merely used to allow the receiving apparatus to check whether or not the communication apparatus having sent the connection request data including the hidden identifier is an appropriate communication apparatus permitted to be communicated with the receiving apparatus.

Further, it is convenient that the receiving apparatus generates the second identifier as required; however, it is not an essential matter for the present invention whether or not the receiving apparatus generates the second identifier.

Further, in the above structure, the transmitting apparatus according to the present invention may be arranged such that: the judging means has a function of judging whether or not the response data includes a first identifier, which is hidden from the user and which is uniquely assigned to each of the communication apparatus and the transmitting apparatus such that the communication apparatus and the transmitting apparatus are distinguished; and in cases where the judging means confirms that no hidden identifier is included in the response data sent from the transmitting apparatus in reply to the connection request data transmitted to the communication apparatus and including (i) the first identifier assigned to the transmitting apparatus and (ii) the data requesting the connection and where the judging means judges that the response data includes an first identifier which is different from the first identifier of the transmitting apparatus but which has a data format identical to that of the first identifier of the transmitting apparatus, the data generating means generates reply data which includes at least (a) information indicating that the connection is permitted and (b) the hidden identifier of the transmitting apparatus, and which is to be sent to the communication apparatus.

According to the above structure, the communication apparatus is judged as an appropriate communication apparatus, when the judging means judges that the response data includes the first identifier which is different from the first identifier of the transmitting apparatus but which has the data format identical to that of the first identifier of the transmitting apparatus. Therefore, in cases where it is judged that the communication apparatus is an appropriate one, the hidden identifier of the transmitting apparatus can be sent to the communication apparatus.

With this, communication using the hidden identifiers can be carried out only with the communication apparatus with which the transmitting apparatus appropriately exchanges the first identifiers. This allows reduction of such a risk that the hidden identifier of the transmitting apparatus is given to an inappropriate communication apparatus.

Further, the transmitting apparatus according to the present invention may be arranged such that: the judging means judges whether or not a certain time has passed since the transmitting apparatus received the response data sent from the communication apparatus; and in cases where the judging means judges that the time has passed, the judging means instructs the data generating means to transmit the generated reply data.

According to the above structure, after the judging means judges that the time has passed since the transmitting apparatus received the response data from the communication apparatus, the data generating means transmit the reply data including each hidden identifier of the transmitting apparatus and the communication apparatus. In other words, the transmitting apparatus does not send the reply data immediately after receiving the response data from the communication apparatus. This allows the user to use the time so as to determine whether or not the reply data is to be sent to the communication apparatus.

Note that, in cases where the time has passed, the process of sending the reply data to the communication apparatus is executed irrespective of user's intention. For this reason, it is more preferable that the transmitting apparatus be provided with an input apparatus for either (i) permitting, before the passage of the time, the process of sending the reply data to the communication apparatus, or (ii) aborting the process of sending the reply data thereto.

Further, the transmitting apparatus according to the present invention may be arranged such that: the data generating means has a function of generating a second identifier to be uniquely assigned to a communication apparatus that is to be permitted to be connected with the communication apparatus, and generates, in a first-time and later outgoing calls to the communication apparatus, connection request data including at least the second identifier.

According to the above structure, the transmitting apparatus presents the second identifier unique to the communication apparatus, when the transmitting apparatus requests the connection with the communication apparatus for the first time. Therefore, the communication apparatus can store the second identifier such that the second identifier is correlated with the transmitting apparatus. Moreover, in the second or later call to the communication apparatus, the transmitting apparatus surely transmits, to the communication apparatus, the reply data including (i) the respective hidden identifiers of the transmitting apparatus and the communication apparatus, and (ii) the second identifier of the communication apparatus. As such, the combination of the hidden identifier and the second identifier is always used for the communication.

The second identifier is unique to the communication apparatus, and apparently indicates, for the communication apparatus, which transmitting apparatus generated the second identifier. This makes it possible for the transmitting apparatus to further assure that the transmitting apparatus is a transmitting apparatus appropriate for the communication apparatus.

The transmitting apparatus according to the present invention may be arranged such that: in cases where the judging means judges that a second identifier, which is different from the second identifier but has a data format identical to that of the second identifier, is included in the response data sent, in response to the first-time outgoing call to the communication apparatus permitted to communicate with the transmitting apparatus, from the communication apparatus, the data generating means generates connection request data including at least the second identifier.

This makes it possible to carry out such communication that the hidden identifiers are exchanged between (i) the transmitting apparatus having assured the communication apparatus that the transmitting apparatus is an appropriate one, and (ii) the communication apparatus having assured the transmitting apparatus that the communication apparatus is an appropriate one.

A transmission/reception system of the present invention may include (i) the receiving apparatus, (ii) the transmitting apparatus, and (iii) a server which relays connection request data and reply data for responding connection request data both of which are transmitted and received between the receiving apparatus and the transmitting apparatus.

With this, it is possible to provide a communication system which has the above-described effects of the receiving apparatus and the transmitting apparatus.

Note that the communication system may include a server which produces the hidden identifier for the receiving apparatus and the hidden identifier for the transmitting apparatus.

Moreover, a receiving method of the present invention is carried out by the receiving apparatus which receives data from a communication apparatus connected to the receiving apparatus via a communication path and includes (a) an address storage section for storing a table in which each of specifying information of a plurality of communication apparatuses, each of hidden identifiers of the communication apparatuses, and each of connection permission information of the communication apparatuses are correlated with one another, which specifying information is for use in specifying the communication apparatuses respectively, and which hidden identifiers are uniquely and fixedly assigned to the communication apparatuses respectively and are hidden from a user, and each of which connection permission information indicates whether or not connection for making a reply to each of the communication apparatuses is permitted, (b) extracting means, (c) searching means, and (d) permission judging means, and the receiving method may include the steps of (I), by the extracting means, (i) receiving, from one of the communication apparatuses, connection request data including data requesting the connection, and (ii) extracting a hidden identifier of the one of the communication apparatuses from the connection request data, (II) by the searching means, searching, by using the extracted hidden identifier, the table stored in address storage section, and (III) by the permission judging means, (i) reading out, in cases where the extracted hidden identifier is found in the table as a result of the search, connection permission information that is so stored in the table as to be correlated with the extracted hidden identifier, and (ii) judging, in accordance with the connection permission information, whether or not the connection with the one of the communication apparatuses is permitted.

Moreover, to solve the above problems, a receiving method of the present invention is carried out by the receiving apparatus which receives data from a communication apparatus connected to the receiving apparatus via a communication path and includes (a) an address storage section for storing a table in which each of specifying information of a plurality of communication apparatuses and each of hidden identifiers of the communication apparatuses are correlated with each other, which specifying information is for use in specifying the communication apparatuses respectively, and which hidden identifiers are uniquely and fixedly assigned to the communication apparatuses respectively and are hidden from a user, (b) extracting means, (c) searching means and (d) writing control means, and the receiving method may include the steps of (I), by the extracting means, (i) receiving for the first time, from one of the communication apparatuses, connection request data including data requesting the connection, and (ii) extracting a hidden identifier of the one of the communication apparatuses from the connection request data, (II) by the searching means, searching, by using the hidden identifier extracted by the extracting means, the table stored in the address storage section, and (III) by the writing control means, writing, in cases where a hidden identifier identical to the extracted hidden identifier is not found in the table as a result of the search, the extracted hidden identifier and specifying information of the one of the communication apparatuses in the table such that the extracted hidden identifier and the specifying information are correlated with each other.

Moreover, a receiving method of the present invention is carried out by a receiving apparatus which receives data from a communication apparatus connected to the receiving apparatus via a communication path and includes (a) an address storage section for storing a table in which each of specifying information of a plurality of communication apparatuses and each of hidden identifiers of the communication apparatuses are correlated with each other, which specifying information is for use in specifying the communication apparatuses respectively, and which hidden identifiers are uniquely and fixedly assigned to the communication apparatuses respectively and are hidden from a user, (b) extracting means, (c) searching means and (d) writing control means, and the receiving method may include the steps of (I), by the extracting means, (i) receiving for the first time, from one of the communication apparatuses, connection request data including data requesting the connection, (ii) extracting a hidden identifier of the one of the communication apparatuses from the connection request data, and (iii) extracting a known identifier of the receiving apparatus among known identifiers, which are for use in respectively specifying communication apparatuses and the receiving apparatus, and which are known to the user, (II) by searching means, searching, by using the hidden identifier extracted by the extracting means, the table stored in the address storage section, (III) by the writing control means, (i) writing, in cases where no hidden identifier identical to the extracted hidden identifier is stored in the table and where the extracting means extracts the known identifier of the receiving apparatus, the extracted hidden identifier and the specifying information which are correlated with one another, and (ii) writing in the table, in cases where the known identifier of the receiving apparatus is not extracted from the connection request data, information indicating that the receiving apparatus rejects the connection with the communication apparatus, the information being so written in the table as to be correlated with the extracted hidden identifier.

Moreover, a transmitting method of the present invention is carried out by a transmitting apparatus which (a) includes judging means and data generating means and (b) transmits data to communication apparatus via communication path, and the transmitting method may include the steps of (I) by the judging means, judging whether or not response data sent from the communication apparatus in response to transmission of connection request data including data requesting connection with the communication apparatus includes a hidden identifier, which is uniquely and fixedly assigned to the communication apparatus and which is hidden from the user, and (II) by the data generating means, generating, in later calls to the communication apparatus in cases where it is judged that the response data includes the hidden identifier, reply data which includes (i) a hidden identifier assigned to the transmitting apparatus and (ii) the hidden identifier received from the communication apparatus.

Incidentally, the receiving apparatus may be realized by hardware, or may be realized by causing a computer to execute a program. Specifically, a program of the present invention is a program causing a computer to function as at least the extracting means, a detecting means, the permission judging means and the writing control means. In addition, a storage medium of the present invention records this program.

In the case of causing a computer to execute the program, the computer functions as the receiving apparatus. Therefore, as with the receiving apparatus described above, this computer can carry out communication using the hidden identifier which is hidden from both the user of the communication apparatus and the user of the receiving apparatus and can carry out communication only with a user who is allowed to carry out communication by the user of the receiving apparatus. Moreover, the hidden identifier remains unchanged, so that the user can communicate with a specific user by the hidden identifier regardless of the known identifier. Further, the user can communicate with the specific user only by the hidden identifier thereafter.

Moreover, the transmitting apparatus may be realized by hardware, or may be realized by causing a computer to execute a program. Specifically, a program of the present invention is a program causing a computer to function as at least the judging means and the data generating means. In addition, a storage medium of the present invention records this program.

In the case of causing a computer to execute the program, the computer functions as the transmitting apparatus. Therefore, as with the transmitting apparatus described above, if the reply data contains the hidden identifier, the user of the transmitting apparatus can communicate with a specific user, who has presented his/her hidden identifier, regardless of the known identifiers of the user and the specific user.

A communication terminal of the present invention (i) uses a packet-switched network, (ii) makes a call to a destination communication terminal by using an identifier specifying the destination communication terminal, and (iii) transmits and receives data to and from the destination communication terminal or a server device for relaying the data to the destination communication terminal, the communication terminal including (I) a storage area for storing (i) a known identifier which specifies the destination communication terminal and which is disclosed to a user of the destination communication terminal and (ii) a hidden identifier which specifies the destination communication terminal and which is hidden from the user of the destination communication terminal, (II) a hidden identifier transmitting section for, when another communication terminal makes a connection to the communication terminal of the present invention, transmitting the hidden identifier of the communication terminal of the present invention, (III) a telephone directory section for (i) recording the above-described another communication terminal's hidden identifier which is transmitted from the above-described another communication terminal while (ii) hiding, from the user of the communication terminal of the present invention, the hidden identifier thus recorded, (IV) and a call control section for making the call (i) by using the known identifier disclosed to the user of the destination communication terminal or (ii) by using the hidden identifier recorded in the telephone directory section.

With this, the communication terminal can have the hidden identifier in addition to the known identifier which is disclosed to the user. Accordingly, the communication terminal can make a call by using any one of the known identifier and the hidden identifier.

The hidden identifiers are automatically exchanged only between the communication terminals each of which has permitted connection to the other. Therefore, it is possible to solve such a problem that the hidden identifier is revealed to an unspecified number of people. Further, the communication terminal makes a second-time or subsequent call by using connection request data containing the hidden identifier. Therefore, it is possible to solve such a problem that, since the destination communication terminal has changed its known identifier, the communication terminal cannot communicate with the destination terminal although the communication terminal has communicated with the destination terminal before.

Furthermore, since the hidden identifier is automatically transmitted, the hidden identifier can be managed so as not to be seen by a calling user or a called user. Further, it becomes possible to solve such a problem that the user makes a wrong call by incorrectly inputting the known identifier.

Further, the communication terminal of the present invention may include a call judgment section for (i) carrying out a search of the telephone directory section by using the hidden identifier transmitted from the above-described another communication terminal and (ii) judging, in accordance with a result of the searching, whether to permit the incoming call.

With this, the communication terminal of the present invention can avoid an improper incoming call made by using the hidden identifier from a communication terminal with which the communication terminal of the present invention has never communicated before.

Further, the communication terminal of the present invention may (I) include a terminal fingerprint transmitting section for, when the above-described another communication terminal makes the communication to the communication terminal of the present invention, transmitting a terminal fingerprint for certifying the communication terminal of the present invention, and (II) be configured such that (i) the storage area stores the terminal fingerprint for certifying the communication terminal of the present invention and (ii) the telephone directory section records the terminal fingerprint while hiding the terminal fingerprint from the user of the communication terminal of the present invention.

With this terminal fingerprint which corresponds to the hidden identifier and is not used for making a call, the sending end can provide, to the receiving end, information for specifying the sending end without disclosing the hidden identifier of the sending end. Therefore, even if the sending end has made communication unintentionally (e.g., even if the sending end has made a call by mistake), it is possible to prevent the hidden identifier of the sending end from being leaked to an unwanted person.

Further, the communication terminal of the present invention may include a call judgment section for (i) carrying out a search of the telephone directory section by using the terminal fingerprint transmitted from the above-described another communication terminal and (ii) judging, in accordance with a result of the searching, whether to permit the incoming call.

With this, the communication terminal of the present invention can avoid an improper incoming call made by using the hidden identifier from a communication terminal with which the communication terminal of the present invention has never communicated before.

Further, the communication terminal of the present invention may be configured such that the hidden identifier transmitting section transmits the hidden identifier (i) in a period from the start of communication by the communication terminal of the present invention until a particular period of time having been elapsed, or (ii) in a case where the user of the communication terminal of the present invention has permitted to transmit the hidden identifier.

With this, the user can transmit the hidden identifier anytime the user wants. Then, the user can judge whether to transmit the hidden identifier.

Further, the communication terminal of the present invention may include (a) a certificate identifier generating section for generating a certificate identifier for confirming that the communication terminal of the present invention has already communicated with the destination communication terminal corresponding to the hidden identifier, and (b) an identifier correspondence judging section for, when the communication terminal has received a call made by using the hidden identifier from a calling communication terminal, (I) judging whether or not a correspondence between (i) the hidden identifier presented by the calling communication terminal and (ii) the certificate identifier is correct, and (II) determining whether to permit the call.

With this, in case where the hidden identifier has leaked, it is possible to easily find out which communication terminal has leaked the hidden identifier. Therefore, a security problem can be solved easily.

Further, the foregoing embodiments are explained on the assumption that each of the members constituting the receiving apparatus and the transmitting apparatus is a “functional block realized by causing computing means (ex. CPU) to execute a program code stored in a storage medium (ex. ROM, RAM). However, each member may be realized by hardware which can carry out the same process. Further, the member can be realized by a combination of (I) hardware which carries out part of the process and (II) computing means for executing a program code for (i) controlling the hardware and (ii) carrying out the rest of the process. Furthermore, among the members, there is a member described as hardware. Even such a member can be realized by a combination of (I) hardware which carries out part of the process and (II) the computing means for a program code for (i) controlling the hardware and (ii) carrying out the rest of the process. The computing means may be a single unit. Alternatively, a plurality of computing means connected to one another via a bus provided in a device and via various communication paths may work together to execute the program code. Further, among the members, the telephone directory storage section 7 may be a storage device such as a memory.

A program such as (i) the program code which can be executed directly by the computing means or (ii) a program that is data from which the program code can be generated by carrying out a process such as decompression (will be described later) is (a) distributed by storing this program (the program code or the data) in a storage medium, or (b) distributed by transmitting the program using communication means for transmitting the program via a wired or wireless communication path. Then, the program is executed by the computing means.

In the case of transmitting the program via the communication path, a signal string indicating the program is transmitted via transmission media constituting the communication path, that is, the signal string is transmitted from one transmission medium to another. In this way, the program is transmitted via the communication path. Further, when transmitting the signal string indicating the program, the signal string may be superimposed on a carrier wave by causing the transmitting apparatus to modulate the carrier wave with the use of the signal string. In this case, the receiving apparatus demodulates the carrier wave so as to restore the signal string. On the other hand, when transmitting the signal string, the transmitting apparatus may (i) divide the signal string, which is a digital data string, into packets and (ii) transmit the packets. In this case, the receiving apparatus combines received group of packets with each other so as to restore the signal string. Further, when transmitting the signal string, the transmitting apparatus may (i) combine the signal string with another signal string using a method such as time division, frequency division, or code division, and (ii) transmit the combined signal string. In this case, the receiving apparatus extracts the individual signal strings from the combined signal string so as to restore the signal strings. In any case, similar effects can be obtained as long as the program is transmitted via the communication path.

Here, the storage medium for the distribution of a program is preferable removable. After the distribution of the program, the storage medium may or may not be removable. In addition, the storage medium may or may not be rewritable (writable) or volatile, be recordable by any method, and come in any shape at all, provided that the medium can hold the program. Examples of such a storage medium include tapes, such as magnetism tapes and cassette tapes; magnetic disks, such as floppy (registered trademark) disks and hard disks; and other discs, such as CD-ROMs, magneto-optical discs (MOs), mini discs (MDs), and digital video discs (DVDs). In addition, the storage medium may be a card, such as an IC card or an optical card; a semiconductor memory, such as a mask ROM, an EPROM, an EEPROM, or a flash ROM; or a memory provided inside a CPU or other computing means.

The program code may be such that it instructs the computing means regarding all the procedures of the processes. If there is already a basic computer program (for example, an operating system or library) which can be retrieved by a predetermined procedure to execute all or some of the processes, code or a pointer which instructs the computing means to retrieve that basic computer program can replace all or some of the processes.

In addition, the program storage format of the storage medium may be, for example, such that: the computing means can access the program for an execution as in an actual memory having loaded the program; the program is not loaded into an actual memory, but installed in a local storage medium (for example, an actual memory or hard disk) always accessible to the computing means; or the program is stored before installing in a local storage medium from a network or a mobile storage medium. In addition, the program is not limited to compiled object code. The program may be stored as source code or intermediate code generated in the course of interpretation or compilation. In any case, similar effects are obtained regardless of the format in which the storage medium stores the program, provided that decompression of compressed information, decoding of encoded information, interpretation, compilation, links, or loading to a memory or combinations of these processes can convert into a format executable by the computing means.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A receiving apparatus for receiving data from a communication apparatus connected to the receiving apparatus via a communication path,
said receiving apparatus, comprising:
an address storage section for storing a table in which each of specifying information of a plurality of communication apparatuses, each of hidden identifiers of the communication apparatuses, and each of connection permission information of the communication apparatuses are correlated with one another, which specifying information is for use in specifying the communication apparatuses respectively, and which hidden identifiers are uniquely and fixedly assigned to the communication apparatuses respectively and are hidden from a user, and each of which connection permission information indicates whether or not connection for making a reply to each of the communication apparatuses is permitted;
extracting means for (i) receiving, from one of the communication apparatuses, connection request data including data requesting the connection, and (ii) extracting a hidden identifier of said one of the communication apparatuses from the connection request data;
searching means for searching, by using the extracted hidden identifier, the table stored in the address storage section; and
permission judging means for (i) reading out, in cases where the extracted hidden identifier is found in the table as a result of the search, connection permission information that is so stored in the table as to be correlated with the extracted hidden identifier, and (ii) judging, in accordance with the connection permission information, whether or not the connection with said one of the communication apparatuses is permitted.

2. A receiving apparatus for receiving data from a communication apparatus connected to the receiving apparatus via a communication path,
said receiving apparatus, comprising:
an address storage section for storing a table in which each of specifying information of a plurality of communication apparatuses, each of hidden identifiers of the communication apparatuses are correlated with each other, which specifying information is for use in specifying the communication apparatuses respectively, and which hidden identifiers are uniquely and fixedly assigned to the communication apparatuses respectively and are hidden from a user;
extracting means for (i) receiving, from one of the communication apparatuses, connection request data including data requesting the connection, and (ii) extracting a hidden identifier of said one of the communication apparatuses from the connection request data;
searching means for searching, by using the hidden identifier extracted by the extracting means, the table stored in the address storage section; and
writing control means for writing, in cases where a hidden identifier identical to the extracted hidden identifier is not found in the table as a result of the search, the extracted hidden identifier and specifying information of said one of the communication apparatuses in the table such that the extracted hidden identifier and the specifying information are correlated with each other.

3. The receiving apparatus as set forth in claim 2, wherein:
the extracting means has a function of extracting a known identifier of the receiving apparatus among known identifiers, which are for use in respectively specifying communication apparatuses and the receiving apparatus, and which are known to the user, and
in cases where no hidden identifier identical to the extracted hidden identifier is found in the table as a result of the search and where the known identifier of the receiving apparatus is not extracted from the connection request data, the writing control means writes, in the table, information indicating that the receiving apparatus rejects the connection with said one of the communication apparatuses, the information being so written in the table as to be correlated with the extracted hidden identifier.

4. The receiving apparatus as set forth in claim 1, further comprising:
data generating means for generating reply data including information indicating whether or not the connection with said one of the communication apparatuses is permitted, wherein:
in cases where the permission judging means judges that the connection is permitted, the data generating means generates reply data including at least (i) information indicating that the connection is permitted, and (ii) the hidden identifier assigned to the receiving apparatus.

5. The receiving apparatus as set forth in claim 2, further comprising:
data generating means for generating reply data including information indicating whether or not the connection with said one of the communication apparatuses is permitted, wherein:
the extracting means has a function of extracting a known identifier of the receiving apparatus among known identifiers, which are for use in respectively specifying communication apparatuses and the receiving apparatus, and which are known to the user, and
in cases where no hidden identifier identical to the extracted hidden identifier is stored in the table and where the extracting means extracts the known identifier of the receiving apparatus, the data generating means generates reply data including at least (i) information indicating that the connection is permitted, and (ii) the hidden identifier assigned to the receiving apparatus.

6. A transmitting apparatus for transmitting data to a communication apparatus connected to the transmitting apparatus via a communication path,
said transmitting apparatus, comprising:
judging means for judging whether or not response data sent from the communication apparatus in response to transmission of connection request data including data requesting connection with the communication apparatus includes a hidden identifier, which is uniquely and fixedly assigned to the communication apparatus and which is hidden from the user; and
data generating means for generating, in later calls to the communication apparatus in cases where it is judged that the response data includes the hidden identifier, either connection request data or reply data, each of which includes (i) a hidden identifier assigned to the transmitting apparatus and (ii) the hidden identifier received from the communication apparatus.

7. A receiving apparatus, which is assigned a hidden identifier that is hidden from a user and that is able to be used as an address for receiving a request for connection with the receiving apparatus, and which is connected to a communication path that allows the receiving apparatus to be specified in accordance with either (i) a known identifier that is known to the user and that is able to be used as an address for receiving the request for the connection with the receiving apparatus or (ii) the hidden identifier, and which receives data from communication apparatuses connected to the communication path,
said receiving apparatus, comprising:
extracting means for extracting, from connection request data sent from one of the communication apparatuses and requesting the connection with the receiving apparatus, address information including (i) one of the known identifier of the receiving apparatus and the hidden identifier of the receiving apparatus, or (ii) both the known identifier and the hidden identifier;
permission judging means for judging, in accordance with the extracted address information, whether or not the connection with the communication apparatus having sent the connection request data is permitted; and
reply data generating means for generating the reply data representing connection permission, in cases where the connection is permitted.

8. A transmitting apparatus, which is connected to a communication path that allows a receiving apparatus to be specified in accordance with either (i) a known identifier that is known to a user and that is able to be used as an address for receiving the request for the connection with the receiving apparatus or (ii) a hidden identifier that is hidden from the user and that is able to be used as the address for receiving the request for the connection with the receiving apparatus, and which transmits data to receiving apparatuses connected to the communication path,
said transmitting apparatus, comprising:
an address storage section for storing (i) each specifying information known to the user such that the hidden identifiers are distinguished from one another and (ii) each of hidden identifiers of the receiving apparatuses such that the specifying information and the hidden identifier are correlated with each other; and
data generating means for generating connection request data including the hidden identifier specified by the specifying information.

9. The transmitting apparatus as set forth in claim 8, wherein:
the address storage section is detachable.

10. The receiving apparatus as set forth in claim 7, further comprising:
an address storage section for storing one or more of (i) a hidden identifier of each of the communication apparatuses, (ii) connection permission information indicating whether or not the connection is permitted, (iii) a first identifier which is assigned to each of the communication apparatuses such that the communication apparatuses are distinguishable from one another, and which is hidden from the user, and (iv) a second identifier which is assigned to each of the communication apparatuses such that the communication apparatuses are distinguishable from one another, and which is given from the receiving apparatus to a communication apparatus that is permitted to communicate with the receiving apparatus, said one or more of the hidden identifier, the connection permission information, the first identifier, and the second identifier being stored such that the hidden identifier, the connection permission information, the first identifier, and the second identifier are correlated with at least either one of (a) specifying information known to the user such that the hidden identifier assigned to the communication apparatus is distinguishable from the other communication apparatuses, and (b) a known identifier of the communication apparatus.

11. The receiving apparatus as set forth in claim 7, in which the extracting means extracts, from the connection request data, (i) a hidden identifier assigned to the communication apparatus having sent the connection request data, (ii) specifying information known to the user such that the hidden identifier is distinguishable from hidden identifiers assigned to the other communication apparatuses, or (iii) a first identifier hidden from the user and assigned to each of the communication apparatuses such that the communication apparatus is distinguishable from the other communication apparatuses,
said receiving apparatus, further comprising:
an address storage section for storing (i) connection permission information indicating whether or not the communication apparatus having made the request for connection with the receiving apparatus is permitted to be connected with the receiving apparatus, and (ii) the first identifier, the connection permission information and the first identifier being stored such that the connection permission information and the first identifier are correlated with at least either one of the specifying information and the hidden identifier of the communication apparatus; and
searching means for searching the address storage section for connection permission information corresponding to the extracted hidden identifier, the extracted specifying information, or the extracted first identifier, wherein:
the permission judging means instructs the reply data generating means to transmit the reply data, in cases where the connection permission information found as a result of the search indicate that the connection is permitted.

12. The receiving apparatus as set forth in claim 7, in which the extracting means further extracts, from the connection request data, (i) a hidden identifier of the communication apparatus having sent the connection request data, (ii) specifying information known to the user such that the hidden identifier is distinguishable from the other hidden identifier, (iii) a first identifier hidden from the user and assigned to each of the communication apparatuses such that the communication apparatuses are distinguishable from one another, or (iv) a second identifier which is assigned to each of the communication apparatuses such that the communication apparatuses are distinguishable from one another, and which is given from the receiving apparatus to a communication apparatus that is permitted to communicate with the receiving apparatus,
said receiving apparatus, further comprising:
an address storage section for storing the second identifier such that the second identifier is correlated with at least one of the specifying information, the hidden identifier, and the first identifier; and
searching means for searching the address storage section for the second identifier corresponding to the extracted hidden identifier, the extracted specifying information, or the extracted first identifier, wherein:
the permission judging means judges whether or not the second identifier found as a result of the search coincides with the extracted second identifier, and
in cases where the permission judging means judges that the second identifiers coincide with each other or where the extracted address information is the known identifier, the permission judging means instructs the reply data generating means to transmit the reply data.

13. The receiving apparatus as set forth in claim 7, wherein:
the data generating means generates reply data including the hidden identifier assigned to the receiving apparatus.

14. The receiving apparatus as set forth in claim 13, wherein:
the permission judging means judges whether or not the hidden identifier of the receiving apparatus is to be transmitted, and
in cases where the permission judging means judges that the transmission is permitted, the permission judging means instructs the data generating means to transmit the reply data including the hidden identifier of the receiving apparatus.

15. The receiving apparatus as set forth in claim 14, wherein:
the extracting means extracts, from the connection request data, a hidden identifier assigned to the communication apparatus having sent the connection request data, and
the permission judging means judges to permit the transmission of the hidden identifier of the receiving apparatus, in cases where the extracting means extracts the hidden identifier of the communication apparatus.

16. The receiving apparatus as set forth in claim 14, wherein:
the permission judging means judges to permit the transmission of the hidden identifier of the receiving apparatus, in cases where a certain time has passed since start of communication with the communication apparatus.

17. The receiving apparatus as set forth in claim 7, in which the extracting means extracts, from the connection request data, (i) a hidden identifier assigned to the communication apparatus having sent the connection request data, and (ii) specifying information known to the user such that the user distinguishes the hidden identifier from the other hidden identifiers,
said receiving apparatus, further comprising:
an address storage section for storing the specifying information and the hidden identifier such that the specifying information and the hidden identifier are correlated with each other; and
writing control means for writing, in the address storage section, the hidden identifier, which is extracted by the extracting means, such that the hidden identifier is correlated with either (i) specifying information acquired from an input and output apparatus manipulated by the user, or (ii) the specifying information extracted by the extracting means.

18. The transmitting apparatus as set forth in claim 8, further comprising:
searching means for (i) acquiring a part of or whole specifying information from an input and output apparatus manipulated by the user, and (ii) searching the address storage section for specifying information corresponding to the acquired specifying information, wherein:
the data generating means generates connection request data addressed to a hidden identifier that is so stored in the address storage section as to be correlated with the specifying information found as a result of the search.

19. The transmitting apparatus as set forth in claim 8, further comprising:
outgoing call permission memory means for storing a setting whether or not an outgoing call using the known identifier is permitted, wherein:
the data generating means generates connection request data addressed to the known identifier, in cases where the outgoing call permission memory means indicates that the outgoing call using the known identifier is permitted.

20. The receiving apparatus as set forth in claim 7, further comprising:
incoming call permission memory means for storing setting whether or not incoming call using the known identifier is permitted, wherein:
the permission judging means instructs the reply data generating means to transmit the reply data, in cases where the incoming call permission memory means indicates that the incoming call using the known identifier is permitted.

21. The receiving apparatus as set forth in claim 7, further comprising:
registration information generating means for generating registration information, which is registered in a server apparatus intermediating the connection and which indicates a correlation between (i) each of the known identifier of the receiving apparatus and the hidden identifier of the receiving apparatus, and (ii) an network address of the receiving apparatus.

22. The receiving apparatus as set forth in claim 21, further comprising:
incoming call permission memory means for storing a setting whether or not incoming call using the known identifier is permitted, wherein:
the registration information generating means generates registration information which does not include the known identifier, in cases where the incoming call permission memory means indicates the incoming call using the known identifier is not permitted.

23. The receiving apparatus as set forth in claim 20, wherein:
in cases where a certain time has passed since the setting in the incoming call permission memory means was changed by a user's operation to a setting in which the incoming call using the known identifier is permitted, the setting in the incoming call permission memory means is changed from (i) a setting in which the incoming call using the known identifier is permitted, to (ii) a setting in which the incoming call using the known identifier is not permitted.

24. The receiving apparatus as set forth in claim 22, wherein:
in cases where a certain time has passed since the setting in the incoming call permission memory means was changed by a user's operation to a setting in which the incoming call using the known identifier is permitted, the setting in the incoming call permission memory means is changed from (i) a setting in which the incoming call using the known identifier is permitted, to (ii) a setting in which the incoming call using the known identifier is not permitted.

25. The receiving apparatus as set forth in claim 20, wherein:
when the receiving apparatus receives the connection request data, the setting in the incoming call permission memory means is changed from (i) a setting in which the incoming call using the known identifier is permitted, to (ii) a setting in which the incoming call using the known identifier is not permitted.

26. The receiving apparatus as set forth in claim 22, wherein:
when the receiving apparatus receives the connection request data, the setting in the incoming call permission memory means is changed from (i) a setting in which the incoming call using the known identifier is permitted, to (ii) a setting in which the incoming call using the known identifier is not permitted.

27. The receiving apparatus as set forth in claim 20, wherein:
when the receiving apparatus receives connection request data addressed to the known identifier, the setting in the incoming call permission memory means is changed from (i) a setting in which the incoming call using the known identifier is permitted, to (ii) a setting in which the incoming call using the known identifier is not permitted.

28. The receiving apparatus as set forth in claim 22, wherein:
when the receiving apparatus receives connection request data addressed to the known identifier, the setting in the incoming call permission memory means is changed from (i) a setting in which the incoming call using the known identifier is permitted, to (ii) a setting in which the incoming call using the known identifier is not permitted.

29. The receiving apparatus as set forth in claim 20, wherein:
in cases where a certain time has passed since a new known identifier was assigned to the receiving apparatus, the setting in the incoming call permission memory means is changed from (i) a setting in which the incoming call using the known identifier is permitted, to (ii) a setting in which the incoming call using the known identifier is not permitted.

30. The receiving apparatus as set forth in claim 22, wherein:
in cases where a certain time has passed since a new known identifier was assigned to the receiving apparatus, the setting in the incoming call permission memory means is changed from (i) a setting in which the incoming call using the known identifier is permitted, to (ii) a setting in which the incoming call using the known identifier is not permitted.

31. The receiving apparatus as set forth in claim 7, further comprising:
encrypting means for encrypting data to be transmitted via the communication path; and
decrypting means for decrypting encrypted data received via the communication path.

32. The transmitting apparatus as set forth in claim 8, further comprising:
encrypting means for encrypting data to be transmitted via the communication path; and
decrypting means for decrypting encrypted data received via the communication path.
